(19) United States
(12) Patent Application Publication
(10) Pub. No.: US 2025/0304292 A1
(43) Pub. Date: Oct. 2, 2025

(54) MOBILE BODY CONTROL DEVICE, MOBILE BODY CONTROL METHOD, AND PROGRAM

(71) Applicant: SONY GROUP CORPORATION, TOKYO (JP)

(72) Inventors: KENICHIRO OI, TOKYO (JP); MASAHIKO TOYOSHI, TOKYO (JP); TAKUTO MOTOYAMA, TOKYO (JP)

(21) Appl. No.: 18/862,968

(22) PCT Filed: Apr. 7, 2023
(86) PCT No.: PCT/JP2023/014447

§ 371 Date: Nov. 5, 2024

(30) Foreign Application Priority Data
May 13, 2022 (JP) 2022-079233

(51) Int. Cl. B64U 10/13; G06T 7/20

(52) U.S. Cl. CPC B64U 10/13; G06T 7/20; B64U 2201/10

(57) ABSTRACT

Provided are a device and method which realize movement according to a predefined path even when absolute position information from the exterior, such as a GPS signal, cannot be input. Using a keyframe database that associates, and registers, a feature of a keyframe selected from images shot by a camera of a movement space for a mobile body such as a drone and a position and attitude of the keyframe in a coordinate system defining the movement space, verifies a feature of an image captured by a camera of the mobile body is verified against a keyframe feature. The position and attitude of the mobile body are then calculated on the basis of the position and attitude of the keyframe in the coordinate system defining the movement space, registered in the database in association with the keyframe for which the verification is successful. Then, the movement of the mobile body is controlled on the basis of the position and attitude calculated.

### TECHNICAL FIELD

The present disclosure relates to a mobile body control device, a mobile body control method, and a program. In particular, the present disclosure relates to a mobile body control device, a mobile body control method, and a program that enable a mobile body such as a drone to be moved according to a predefined movement path.

### BACKGROUND ART

Recent years have seen a rapid increase in the use of drones, which are compact aircraft. For example, a camera is mounted on a drone and the drone is then used for processing such as shooting images of landscape scenes from above. Drones are also being used to deliver packages.

As modes for controlling the flight of a drone, there is a control mode in which a person operates a controller to fly the drone within a range visible to that person, and an autonomous flight control mode which does not require visual monitoring by a person, an external controller, or the like.

An autonomously-flying drone is also capable of flying to destinations far from the point of departure, for example, and the use of such autonomously-flying drones is expected to increase in the future.

An autonomously-flying drone flies while performing control such that during flight, the drone continuously checks its self position so as not to deviate from a predefined flight path.

One method of self position estimation processing is, for example, Simultaneous Localization and Mapping (SLAM) processing.

SLAM processing is processing in which, for example, images captured by a camera mounted on a drone are analyzed, the movement of the drone itself is analyzed from the movement of objects present in the captured images, and the movement direction, movement distance, and the like are analyzed to estimate the drone's self position.

However, SLAM processing analyzes the movement of objects within a plurality of image frames captured by the camera, and analyzes the movement amount, movement direction, and the like of a relative self position according to the results of the analysis, leading to a problem in that errors gradually accumulate.

To solve this problem of error accumulation, processing is performed in which absolute position information is obtained periodically from the exterior and errors in the self position calculated on the basis of SLAM are corrected.

For example, position information from a GPS can be used as the position information from the exterior.

A method for using GPS position information to correct position information calculated on the basis of SLAM is described in PTL 1 (JP 2020-067439 A).

However, GPS signals cannot be received indoors, such as in buildings and the like, and there is thus a problem in that when flying a drone in such a location, self position information calculated on the basis of SLAM cannot be corrected using GPS position information.

### CITATION LIST

### Patent Literature

[PTL 1] JP 2020-067439 A

### SUMMARY

### Technical Problem

Having been achieved in view of the problems described above, an object of the present disclosure is to provide a mobile body control device, a mobile body control method, and a program that realize movement along a planned movement path even in areas where a GPS signal cannot be received, such as indoors.

### Solution to Problem

A first aspect of the present disclosure is a mobile body control device including:
a keyframe database that associates, and registers, a feature of a keyframe selected from images of a movement space shot by a camera and a position and attitude of the keyframe in a coordinate system defining the movement space;
an image feature verification unit that verifies a feature of an image captured by a camera of a mobile body against a feature of a keyframe registered in the keyframe database;
a mobile body position and attitude calculation unit that calculates a position and attitude of the mobile body based on the position and attitude of the keyframe in the coordinate system defining the movement space, registered in the keyframe database in association with a keyframe for which the verification is successful; and
a movement control unit that controls movement of the mobile body based on the position and attitude calculated by the mobile body position and attitude calculation unit.

Furthermore, a second aspect of the present disclosure is a mobile body control method performed by a mobile body control device,
the mobile body control device including a keyframe database that associates, and registers, a feature of a keyframe selected from images of a movement space shot by a camera and a position and attitude of the keyframe in a coordinate system defining the movement space, and the mobile body control method including:
verifying, by an image feature verification unit, a feature of an image captured by a camera of a mobile body against a feature of a keyframe registered in the keyframe database;
calculating, by a mobile body position and attitude calculation unit, a position and attitude of the mobile body based on the position and attitude of the keyframe in the coordinate system defining the movement space, registered in the keyframe database in association with a keyframe for which the verification is successful; and
controlling, by a movement control unit, movement of the mobile body based on the position and attitude calculated in the calculating.

Furthermore, a third aspect of the present disclosure is a program that causes a mobile body control device to perform mobile body control processing,
the mobile body control device including a keyframe database that associates, and registers, a feature of a keyframe selected from images of a movement space shot by a camera and a position and attitude of the keyframe in a coordinate system defining the movement space;,
the program causing:
an image feature verification unit to verify a feature of an image captured by a camera of a mobile body against a feature of a keyframe registered in the keyframe database;
a mobile body position and attitude calculation unit to calculate a position and attitude of the mobile body based on the position and attitude of the keyframe in the coordinate system defining the movement space, registered in the keyframe database in association with a keyframe for which the verification is successful; and
a movement control unit to control movement of the mobile body based on the position and attitude calculated by the mobile body position and attitude calculation unit.

The program of the present disclosure is, for example, a storage medium provided in a computer-readable form or a program that can be provided by a communication medium, the storage medium or the program being provided to an information processing device or a computer system that can execute various types of program code, for example. By providing such a program in a computer-readable form, processing according to the program can be realized on an information processing device or a computer system.

Still other objects, features and advantages of the present disclosure will become apparent by more detailed description on the basis of the embodiments of the present disclosure and the accompanying drawings described below. In the present specification, the system is a logical set of configurations of a plurality of devices, and the devices having each configuration are not limited to those in the same housing.

According to the configuration of one embodiment of the present disclosure, a device and method are provided which realize movement according to a predefined path even when absolute position information from the exterior, such as a GPS signal, cannot be input.

Specifically, for example, using a keyframe database that associates, and registers, a feature of a keyframe selected from images of a movement space shot by a camera and a position and attitude of the keyframe in a coordinate system defining the movement space, a feature of an image captured by a camera of the mobile body is verified against a keyframe feature. The position and attitude of the mobile body are then calculated on the basis of the position and attitude of the keyframe in the coordinate system defining the movement space, registered in the database in association with the keyframe for which the verification is successful. Then, the movement of the mobile body is controlled on the basis of the position and attitude calculated.

According to this configuration, a device and method are provided which realize movement according to a predefined path even when absolute position information from the exterior, such as a GPS signal, cannot be input.

Note that the effects described in the present specification are merely exemplary and not limited, and additional effects may be provided.

### BRIEF DESCRIPTION OF DRAWINGS

FIG. 1 is a diagram illustrating an overview of processing of the present disclosure.

FIG. 2 is a diagram illustrating a specific example of a CG model (a three-dimensional CG model) of a drone flight area.

FIG. 3 is a diagram illustrating a CAD coordinate system (Wc) and a SLAM coordinate system (Ws).

FIG. 4 is a diagram illustrating a camera coordinate system (C).

FIG. 5 is a diagram illustrating a coordinate transformation matrix for transforming coordinates between different coordinate systems.

FIG. 6 is a diagram illustrating a coordinate transformation matrix for transforming coordinates between different coordinate systems.

FIG. 7 is a diagram illustrating a keyframe coordinate system (kx) and a marker coordinate system (mx) used in the processing of the present disclosure.

FIG. 8 is a diagram illustrating a relationship between coordinate systems and a specific example of a coordinate transformation matrix.

FIG. 9 is a diagram illustrating a coordinate transformation matrix used between a plurality of different keyframe coordinate systems.

FIG. 10 is a diagram illustrating an example of drone flight path registration CG model generation processing.

FIG. 11 is a diagram illustrating an object DB.

FIG. 12 is a diagram illustrating a keyframe DB.

FIG. 13 is a diagram illustrating an example of registering an image, in which a marker substitution object has not been captured, as a keyframe in a DB.

FIG. 14 is a diagram illustrating a specific example of DB registration data when an image, in which a marker substitution object has not been captured, is registered as a keyframe in a keyframe DB.

FIG. 15 is a diagram illustrating a flowchart of a processing sequence executed by a mobile body control device, an information processing device, and the like of the present disclosure.

FIG. 16 is a diagram illustrating a flowchart of a sequence that is processing performed by the information processing device of the present disclosure (Processing 1).

FIG. 17 is a diagram illustrating a specific example of the processing performed by the information processing device of the present disclosure (Processing 1).

FIG. 18 is a diagram illustrating a specific example of the processing performed by the information processing device of the present disclosure (Processing 1).

FIG. 19 is a diagram illustrating a flowchart of a sequence that is processing performed by the mobile body control device of the present disclosure (Processing 2).

FIG. 20 is a diagram illustrating a specific example of the processing performed by the mobile body control device of the present disclosure (Processing 2).

FIG. 21 is a diagram illustrating a specific example of the processing performed by the mobile body control device of the present disclosure (Processing 2).

FIG. 22 is a diagram illustrating a flowchart of a keyframe registration determination processing sequence in processing performed by the mobile body control device of the present disclosure (Processing 2).

FIG. 23 is a diagram illustrating a flowchart of the keyframe registration determination processing sequence in processing performed by the mobile body control device of the present disclosure (Processing 2).

FIG. 24 is a diagram illustrating a flowchart of the keyframe registration determination processing sequence in processing performed by the mobile body control device of the present disclosure (Processing 2).

FIG. 25 is a diagram illustrating a flowchart of the keyframe registration determination processing sequence in processing performed by the mobile body control device of the present disclosure (Processing 2).

FIG. 26 is a diagram illustrating a flowchart of the keyframe registration determination processing sequence in processing performed by the mobile body control device of the present disclosure (Processing 2).

FIG. 27 is a diagram illustrating a flowchart of the keyframe registration determination processing sequence in processing performed by the mobile body control device of the present disclosure (Processing 2).

FIG. 28 is a diagram illustrating a keyframe DB.

FIG. 29 is a diagram illustrating a flowchart of a sequence that is processing performed by the mobile body control device of the present disclosure (Processing 3).

FIG. 30 is a diagram illustrating record data in a keyframe DB generated through processing performed by the mobile body control device of the present disclosure (Processing 3).

FIG. 31 is a diagram illustrating processing for generating a coordinate transformation matrix (w_{c}Tₖₓ) corresponding to a keyframe kx in which a marker substitution object has been captured.

FIG. 32 is a diagram illustrating processing for generating a coordinate transformation matrix (w_{c}Tₖₓ) corresponding to a keyframe kx in which a marker substitution object has not been captured.

FIG. 33 is a diagram illustrating processing for generating a coordinate transformation matrix (w_{c}Tₖₓ) corresponding to a keyframe kx in which a marker substitution object has not been captured.

FIG. 34 is a diagram illustrating an example of a reason for registering a keyframe in which a marker substitution object has not been captured in a keyframe DB.

FIG. 35 is a diagram illustrating an example of a reason for registering a keyframe in which a marker substitution object has not been captured in a keyframe DB.

FIG. 36 is a diagram illustrating a specific example of processing for removing an excess keyframe from keyframes registered in a keyframe DB.

FIG. 37 is a diagram illustrating a flowchart of a sequence that is processing performed by the mobile body control device of the present disclosure (Processing 4).

FIG. 38 is a diagram illustrating a flowchart of a sequence that is processing performed by the mobile body control device of the present disclosure (Processing 4).

FIG. 39 is a diagram illustrating a specific example of the processing performed by the mobile body control device of the present disclosure (Processing 4).

FIG. 40 is a diagram illustrating a second embodiment using real markers.

FIG. 41 is a diagram illustrating the second embodiment using real markers.

FIG. 42 is a diagram illustrating a relationship between coordinate systems and a specific example of a coordinate transformation matrix, in the second embodiment.

FIG. 43 is a diagram illustrating an example of drone flight path registration CG model generation processing, in the second embodiment.

FIG. 44 is a diagram illustrating an object DB generated and used in the second embodiment.

FIG. 45 is a diagram illustrating a keyframe DB generated and used in the second embodiment.

FIG. 46 is a diagram illustrating an example of drone flight path registration CG model generation processing, in the second embodiment.

FIG. 47 is a diagram illustrating an example of drone flight path registration CG model generation processing, in the second embodiment.

FIG. 48 is a diagram illustrating an example of the configuration of an information processing device such as a PC serving as an example of a device for performing (Processing 1).

FIG. 49 is a diagram illustrating an example of the configuration of a mobile body control device in a drone serving as an example of a device for performing (Processing 2) and (Processing 3).

FIG. 50 is a diagram illustrating an example of the configuration of a mobile body control device in a drone serving as an example of a device for performing (Processing 4).

FIG. 51 is a diagram illustrating an example of the hardware configurations of an information processing device, a mobile body control device, and the like of the present disclosure.

### DESCRIPTION OF EMBODIMENTS

A mobile body control device, a mobile body control method, and a program of the present disclosure will be described in detail hereinafter with reference to the drawings. The descriptions will be given in the following order.
1. Overview of Processing of Present Disclosure
2. Coordinate Systems and Coordinate Transformation Processing Applied in Processing of Present Disclosure
3. Specific Examples of Data Generated or Used in Processing of Present Disclosure
4. Sequence of Processing Performed by Mobile Body Control Device of Present Disclosure
4-A. Overall Sequence (Processing 1)-(Processing 4)
4-B1. (Processing 1) Processing for Generating Drone Flight Path Registration CG Model 71 and Object DB 72
4-B2. (Processing 2) Processing for Obtaining Data for Enabling Transformation Processing from Keyframe Coordinate System to SLAM Coordinate System, and Constructing Keyframe DB
4-B2-a. (Registration Condition a) Determination Processing Sequence
4-B2-b. (Registration Condition b) Determination Processing Sequence
4-B2-c. (Registration Condition c) Determination Processing Sequence
4-B2-d. (Registration Condition d) Determination Processing Sequence
4-B3. (Processing 3) Optimization Processing for Minimizing Absolute Position Error of Keyframes Registered in Keyframe DB 73
4-B4. (Processing 4) Processing for Performing Autonomous Flight in Accordance with Prescribed Flight Path (Referring to Post-Optimization Processing Keyframe DB, and Performing Autonomous Flight While Correcting Self Position Estimated in SLAM Coordinate System Based on Self Position in CAD Coordinate System)
5. Embodiment Using Real Markers (Second Embodiment)
6. Examples of Configurations of Information Processing Device and Mobile Body Control Device of Present Disclosure
7. Example of Hardware Configurations of Information Processing Device and Mobile Body Control Device of Present Disclosure
8. Summary of Configuration of Present Disclosure

### 1. Overview of Processing of Present Disclosure

An overview of the processing of the present disclosure will be given first.

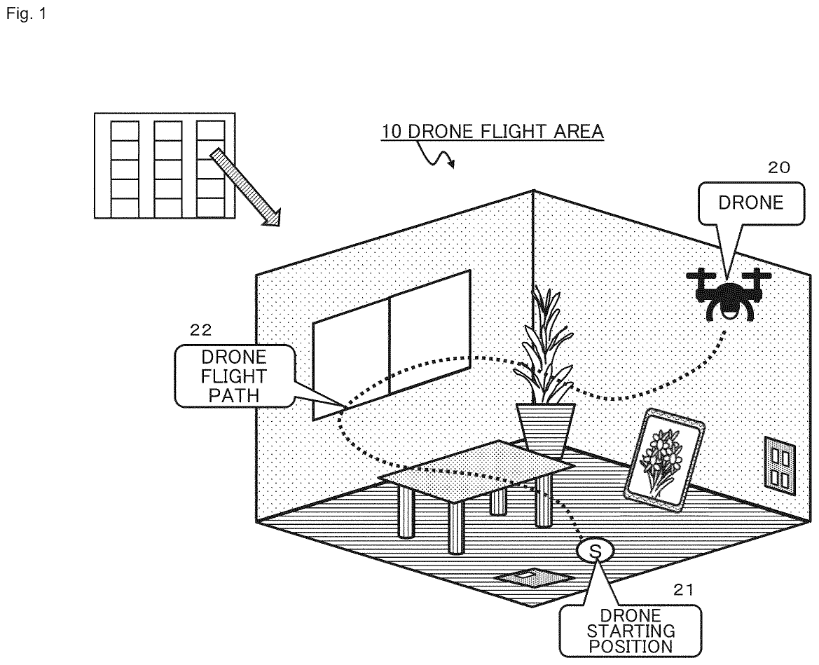

An overview of the processing of the present disclosure will be described with reference to FIG. 1.

As mentioned earlier, an autonomously-flying drone flies while performing control such that during flight, the drone continuously checks its self position so as not to deviate from a predefined flight path.

One method of self position estimation processing is, for example, Simultaneous Localization and Mapping (SLAM) processing.

In SLAM processing, for example, images captured by a camera mounted on a drone are analyzed, the movement of the drone itself is analyzed from the movement of objects present in the captured images, and the movement direction, movement distance, and the like are analyzed to estimate the drone's self position.

However, SLAM processing analyzes the movement of objects within a plurality of image frames captured by the camera, and analyzes the movement amount, movement direction, and the like of a relative self position according to the results of the analysis, leading to a problem in that errors gradually accumulate.

To solve this problem of error accumulation, processing is performed such as, for example, periodically receiving position information (absolute position information) from a GPS and, based on the received absolute position information, correcting errors in the self position calculated on the basis of SLAM.

However, GPS signals cannot be received indoors, such as in buildings and the like, and thus when flying a drone in such a location, self position information calculated on the basis of SLAM cannot be corrected using GPS position information.

For example, a drone flight area 10 illustrated in FIG. 1 is a room in a building, and is an area where GPS position information cannot be received.

By applying the processing of the present disclosure described below, a drone 20 can be flown according to a predefined drone flight path 22 from a predefined drone starting position 21, even in areas where absolute position information from the exterior, such as GPS position information, cannot be received.

In the processing of the present disclosure, a CG model (a three-dimensional CG model) of the drone flight area 10 is generated and used.

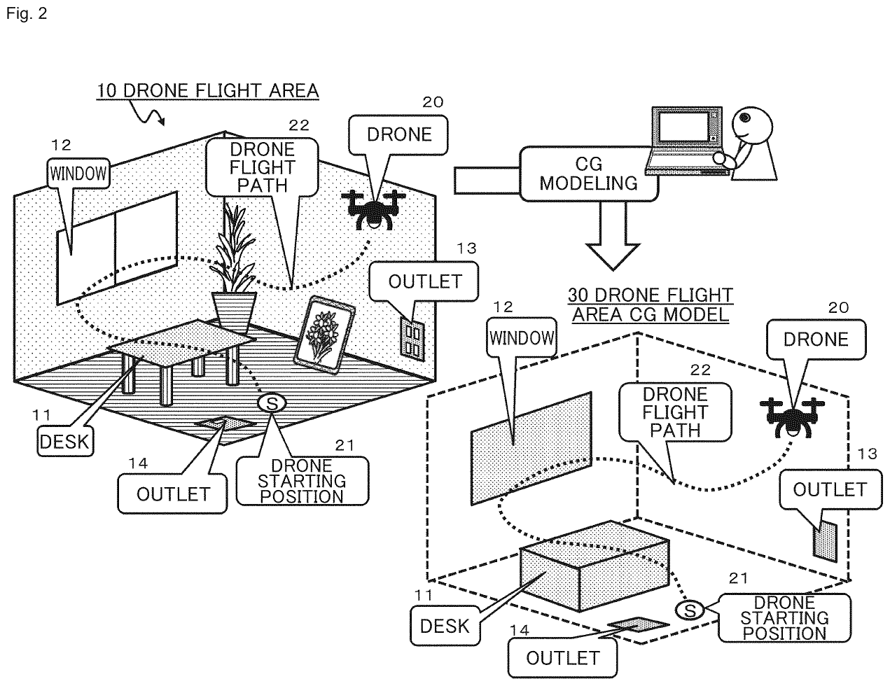

A specific example of the CG model (the three-dimensional CG model) of the drone flight area 10 will be described with reference to FIG. 2.

Objects such as a desk 11, a window 12, outlets 13 and 14, and the like are present in the drone flight area 10 on the left side of FIG. 2.

When generating a CG model (a three-dimensional CG model) of the drone flight area (indoors) 10, these objects are also recorded in the CG model.

An example of a drone flight area CG model 30 is illustrated on the right side of FIG. 2.

This CG model is generated using an information processing device such as a PC, for example.

The drone flight area CG model 30 illustrated on the lower-right of FIG. 2 is a three-dimensional model indicating the three-dimensional space of the drone flight area 10 illustrated in the upper-left of FIG. 2, and is a CG model in which three-dimensional data of each of specific objects (marker substitution objects) within the drone flight area 10 indicated in the upper-left of FIG. 2 is also recorded.

An object recorded in the drone flight area CG model 30 is a “marker substitution object” having a role as a marker which serves as a landmark when the drone 20 flies autonomously, and is used when the drone 20 flies according to the predefined drone flight path 22.

An object which does not move or deform is selected as the marker substitution object. In other words, an object whose position in the drone flight area 10 is fixed is selected as the marker substitution object.

The drone starting position 21, the drone flight path 22, and the like are also recorded in the drone flight area CG model 30.

Note that the drone starting position 21, the drone flight path 22, and the like can be set as desired by a user (operator).

The processing of the present disclosure, i.e., flight control processing which causes the drone 20 to fly according to the predefined drone flight path 22, is performed using the drone flight area CG model 30 illustrated in FIG. 2, i.e., the CG model in which marker substitution objects, a drone flight path, and the like are recorded. The specific processing will be described later.

### 2. Coordinate Systems and Coordinate Transformation Processing Applied in Processing of Present Disclosure

Coordinate systems and coordinate transformation processing applied in the processing of the present disclosure will be described next.

A plurality of different coordinate systems is used in the processing of the present disclosure. The plurality of coordinate systems and coordinate transformation processing performed between the coordinate systems will be described hereinafter.

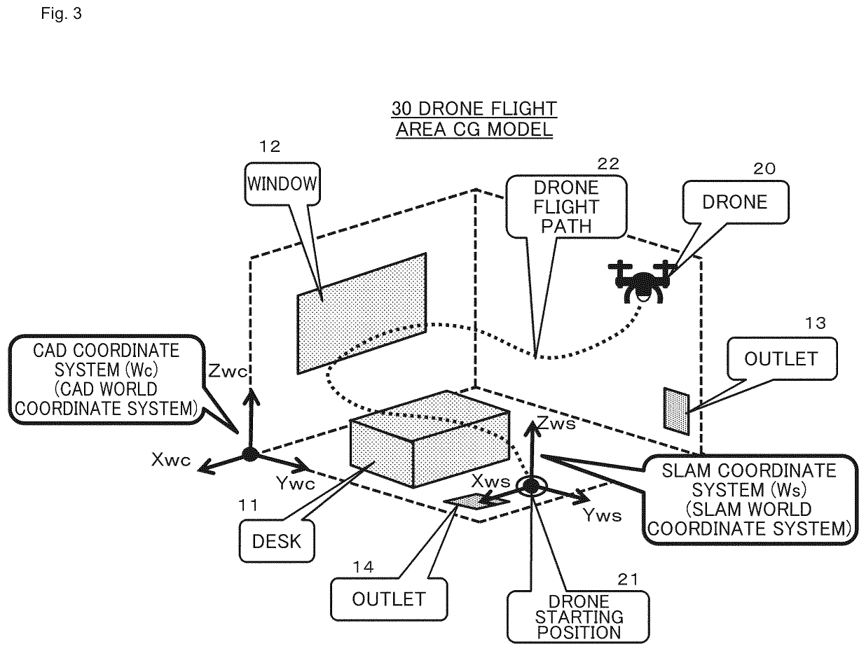

FIG. 3 is a diagram illustrating a CAD coordinate system (Wc) and a SLAM coordinate system (Ws).

The CAD coordinate system (Wc) is a coordinate system corresponding to a drone flight area CG model such as that illustrated in FIG. 3, and is a coordinate system that defines the three-dimensional space of the CG model.

Note that “CAD coordinate system (Wc)” is an abbreviation of “CAD world coordinate system”.

The origin and x, y, and z coordinate axes are defined when the CG model is generated. The example in FIG. 3 illustrates a CAD coordinate system in which the x axis and y axis are set to directions orthogonal to each other in a horizontal plane, and the z axis is set to the upward direction, with the lower-left end of the indoor space as the origin. These settings are merely an example, and the origin and coordinate axes can be set as desired when the CG model is generated.

The three-dimensional positions and three-dimensional shapes of marker substitution objects such as the desk 11, the window 12, the outlets 13 and 14, and the like recorded in the drone flight area CG model 30 are specified in the CAD coordinate system (Wc). The drone starting position 21, the drone flight path 22, and the like recorded in the drone flight area CG model 30 are also specified in the CAD coordinate system (Wc).

The SLAM coordinate system (Ws) is a coordinate system used in SLAM processing performed by the drone 20 when estimating its self position, attitude, and the like during flight.

Note that “SLAM coordinate system (Ws)” is an abbreviation of “SLAM world coordinate system”.

For example, the SLAM coordinate system is defined when the drone 20 starts flying, i.e., when self position and attitude estimation processing is started. For example, as illustrated in FIG. 3, a SLAM coordinate system in which the x axis and y axis are set to directions orthogonal to each other in a horizontal plane, and the upward direction is the z axis, with the drone starting position 21 as the origin is illustrated. These settings are merely an example, and the origin and coordinate axes can be set as desired.

However, the CAD coordinate system (Wc) and the SLAM coordinate system (Ws) are specified as different independent coordinate systems that do not normally match.

Furthermore, a camera coordinate system (C) corresponding to a camera mounted on the drone 20 is also used in the processing of the present disclosure.

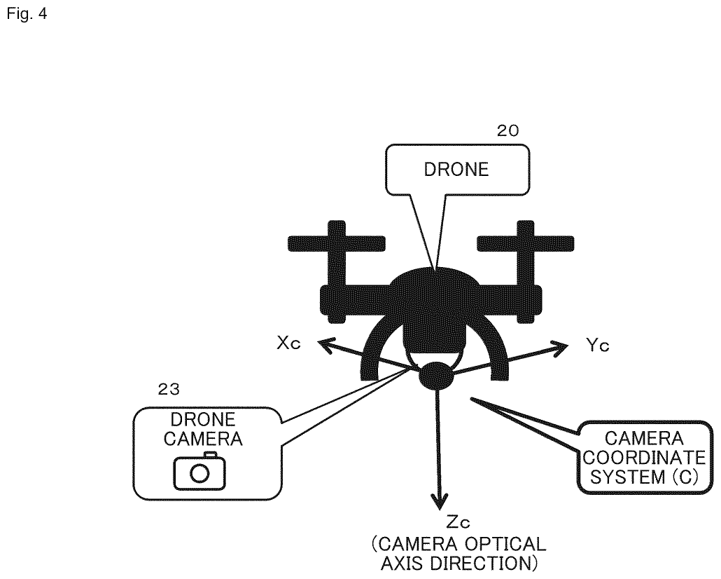

The camera coordinate system (C) will be described with reference to FIG. 4.

A drone camera 23 is mounted on the drone 20, and captures image continually while the drone 20 is flying.

The images captured by the drone camera 23 are used when performing SLAM processing, which is the self position and attitude estimation processing by the drone 20.

The camera coordinate system (C) is a coordinate system unique to the drone camera 23.

The camera coordinate system (C) is defined as a coordinate system in which, for example, a focal point one of the drone camera 23 is set as the origin, the camera optical axis direction is set as the z axis, and the two axes orthogonal to the camera optical axis direction are set as the x and y axes, as illustrated in FIG. 4.

In this manner, at least three independent coordinate systems, namely the CAD coordinate system (Wc), the SLAM coordinate system (Ws), and the camera coordinate system (C), are used in the processing of the present disclosure. In the processing of the present disclosure, a keyframe coordinate system and a marker coordinate system are used in addition to the three coordinate systems, but these will be described later.

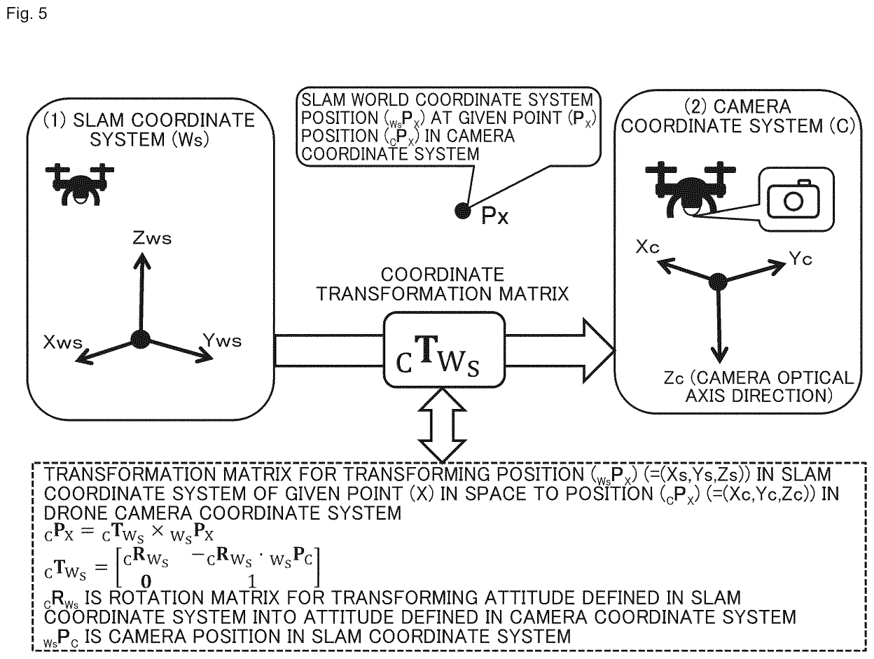

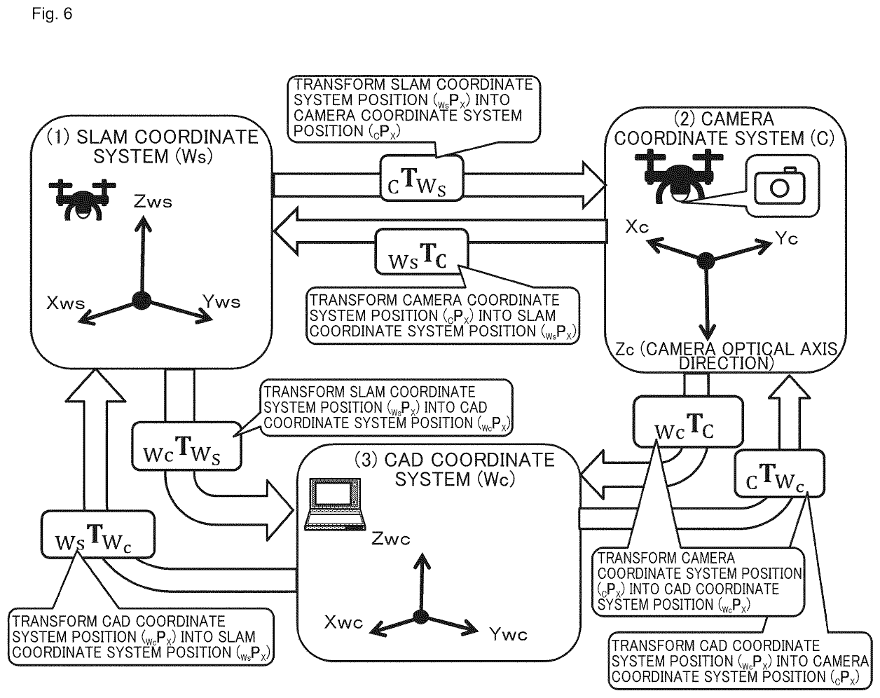

A coordinate transformation matrix for transforming coordinates between different coordinate systems will be described next with reference to FIGS. 5 and 6.

FIG. 5 is a diagram illustrating an example of processing when transforming one coordinate system into another coordinate system.

Note that the matrix to be used for transforming one coordinate system into another coordinate system is called a coordinate transformation matrix (T).

A coordinate transformation matrix (_{b}Tₐ) transforms positions (xa, ya, za) defined in one coordinate system a into positions (xb, yb, zb) in a different coordinate system b. Note that the coordinate transformation matrix (_{b}Tₐ) not only transforms coordinate positions in the coordinate system a into coordinate positions in the coordinate system b, but also transforms attitudes in the coordinate system a and attitudes in the coordinate system b. The “attitude in the coordinate system” refers to a direction, tilt, and the like along the x, y, and z axes that define the coordinate system.

FIG. 5 is a diagram illustrating a coordinate transformation matrix (_{C}Twₛ) for transforming a position and attitude in the SLAM coordinate system (Ws) into a position and attitude in the camera coordinate system (C).

Specifically, for example, applying this coordinate transformation matrix ((Tw's) makes it possible to transform a position (wₛPx) in the SLAM coordinate system (Ws) into a position (_{C}Px) in the camera coordinate system (C) for a single point (Px) in the three-dimensional space indicated in the upper-central part of FIG. 5. Note that the single point (Px) (=(xa, ya, za)) in the three-dimensional space represented by a given coordinate system A is indicated as (_{A}Px).

The positions of the single point (Px) in the three-dimensional space indicated in the upper-central part of FIG. 5, in the SLAM coordinate system (Ws) and in the camera coordinate system (C), are represented as follows.
Position in SLAM coordinate system (Ws): wₛP_{X}
Position in camera coordinate system (C): _{C}P_{X}

A coordinate transformation matrix for transforming a position (wₛPx), in the SLAM coordinate system (Ws), of the single point (Px) in the three-dimensional space, into a position (_{C}P_{X}) in the camera coordinate system (C), is represented by: _{C}Twₛ

As indicated in the lower part of FIG. 5, a formula for transforming the position (wₛP_{X}), in the SLAM coordinate system (Ws), of the point (Px), into the position (_{C}P_{X}) in the camera coordinate system (C), can be expressed by the following (Formula 1).

$${}_{C} {P}_{X} = {}_{C} {T}_{Ws} \times {}_{Ws} {P}_{X} \qquad ( Formula 1 )$$

In (Formula 1),

_{C}Twₛ is the coordinate transformation matrix for transforming the position and attitude in the SLAM coordinate system (Ws) into the position and attitude in the camera coordinate system (C).

The coordinate transformation matrix (_{C}Twₛ) can be expressed as the following determinant (Formula 2).

$$\begin{matrix}[ Math . 1 ] & \\ {}_{C} {T}_{Ws} = [ \begin{matrix}{}_{C} {R}_{Ws} & - {}_{C} {T}_{Ws} \cdot {}_{Ws} {O}_{C} \\ 0 & 1\end{matrix} ] & ( Formula 2 )\end{matrix}$$

In (Formula 2),

_{C}Rwₛ is a rotation matrix for transforming an attitude defined in the SLAM coordinate system (Ws) into an attitude defined in the camera coordinate system, and

wₛP_{C} is the position of the camera in the SLAM coordinate system (Ws).

In this example, the position of the camera corresponds to the focal position of the drone camera 23 mounted on the drone 20.

The coordinate transformation matrix _{C}Twₛ indicated in (Formula 2) is a coordinate transformation matrix that transforms a coordinate position (wₛP_{X}), in the SLAM coordinate system (Ws), corresponding to a single point (Px) in the three-dimensional space, into a coordinate position (_{C}P_{X}) in the camera coordinate system (C).

As described earlier, in the processing of the present disclosure, there are three different coordinate systems, which are:
(1) the SLAM coordinate system (Ws)
(2) the camera coordinate system (C)
(3) the CAD coordinate system (Wc)

The processing is performed using these coordinate systems.

FIG. 6 illustrates an example of coordinate transformation matrices for these three coordinate systems.

FIG. 6 illustrates the following six coordinate transformation matrices:
_{C}Twₛ: a coordinate transformation matrix for transforming a position and attitude in the SLAM coordinate system (Ws) into a position and attitude in the camera coordinate system (C);
wₛT_{C}: a coordinate transformation matrix for transforming a position and attitude in the camera coordinate system (C) into a position and attitude in the SLAM coordinate system (Ws);
w_{c}Twₛ: a coordinate transformation matrix for transforming a position and attitude in the SLAM coordinate system (Ws) into a position and attitude in the CAD coordinate system (Wc);
wₛTw_{c}: a coordinate transformation matrix for transforming a position and attitude in the CAD coordinate system (Wc) into a position and attitude in the SLAM coordinate system (Ws);
w_{c}T_{C}: a coordinate transformation matrix for transforming a position and attitude in the camera coordinate system (C) into a position and attitude in the CAD coordinate system (Wc); and
_{C}Tw_{c}: a coordinate transformation matrix for transforming a position and attitude in the CAD coordinate system (Wc) into a position and attitude in the camera coordinate system (C).

For example, the two coordinate transformation matrices _{C}Twₛ and wₛT_{C} between the SLAM coordinate system (Ws) and the camera coordinate system (C) are inverse matrices of each other. In other words,

$${}_{C} {T}_{Ws} = {}_{Ws} {T}_{C}^{- 1} ,$$

$$and$$

$${}_{Ws} {T}_{C} = {}_{C} {T}_{Ws}^{- 1} .$$

In other words, based on one coordinate transformation matrix, the other coordinate transformation matrix can be calculated as the inverse matrix.

Likewise, the two coordinate transformation matrices w_{c}Twₛ and wₛTw_{c} between the SLAM coordinate system (Ws) and the CAD coordinate system (Wc) are also inverse matrices of each other.

Furthermore, the two coordinate transformation matrices _{C}Twₛ and wₛT_{C} between the camera coordinate system (C) and the CAD coordinate system (Wc) are inverse matrices of each other.

Also, for example, as illustrated in FIG. 6,
the coordinate transformation matrix (w_{c}T_{C}) for transforming a position and attitude in the camera coordinate system (C) into a position and attitude in the CAD coordinate system (Wc), can be calculated from the following two coordinate transformation matrices:
wₛT_{C}: a coordinate transformation matrix for transforming a position and attitude in the camera coordinate system (C) into a position and attitude in the SLAM coordinate system (Ws); and
w_{c}Twₛ: a coordinate transformation matrix for transforming a position and attitude in the SLAM coordinate system (Ws) into a position and attitude in the CAD coordinate system (Wc).

In other words, these can be calculated as:

$${}_{Wc} {T}_{C} = {}_{Wc} {T}_{Ws} \times {}_{Ws} {T}_{C}$$

In this manner, the coordinate transformation matrix between the two different coordinate systems A and B can be calculated from the coordinate transformation matrix between coordinate systems A and C and the coordinate transformation matrix between coordinate systems B and C.

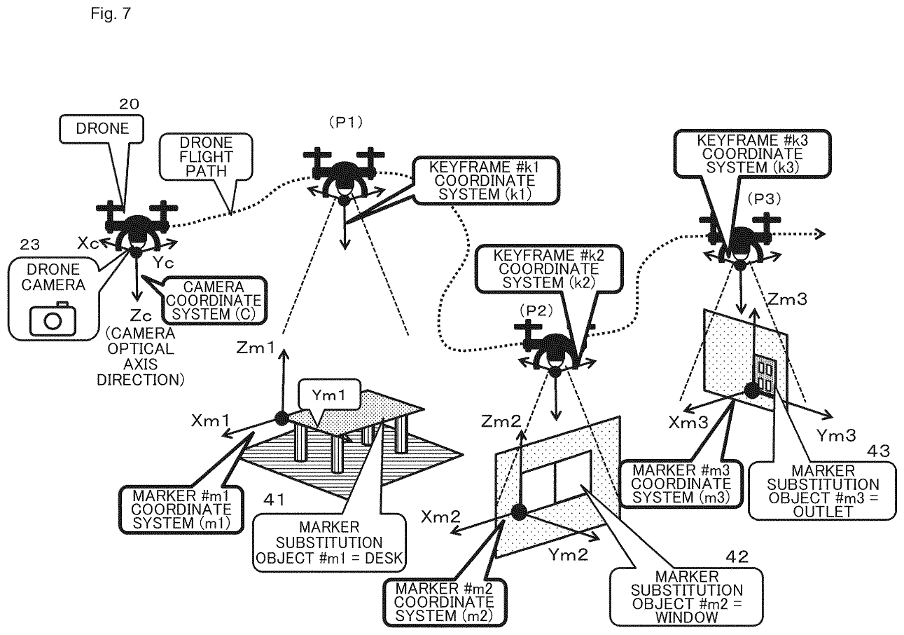

A keyframe coordinate system (kx) and a marker coordinate system (mx) used in the processing of the present disclosure will be described next with reference to FIG. 7.

The keyframe coordinate system (kx) is a coordinate system belonging to the camera coordinate system (C) described with reference to FIG. 4, and corresponds to the camera coordinate system (C) at the time when a single image is captured. In other words, the camera coordinate system (C) at the time when the drone camera 23 captures a single image (keyframe #kx) is called the “keyframe coordinate system (kx)”.

As illustrated in FIG. 7, the drone 20 flies according to a given single drone flight path.

The drone camera 23 mounted on the drone 20 continuously captures images (a moving image).

When a “marker substitution object #m1=desk” is captured in the image captured by the drone camera 23 when the drone 20 is at a given position (P1) along the flight path, the camera coordinate system (C) at the time when the image is captured is defined as a keyframe #k1 coordinate system k1.

Likewise, when a “marker substitution object #m2=window” is captured in the image captured by the drone camera 23 when the drone 20 is at a given position (P2) along the flight path, the camera coordinate system (C) at the time when the image is captured is defined as a keyframe #k2 coordinate system k2.

Furthermore, when a “marker substitution object #m3=outlet” is captured in the image captured by the drone camera 23 when the drone 20 is at a given position (P3) along the flight path, the camera coordinate system (C) at the time when the image is captured is defined as a keyframe #k3 coordinate system k3.

Note that a “keyframe” is a captured image corresponding to data registered in a keyframe DB (database).

The processing for registering a “keyframe” in the keyframe DB is performed at the stage of preliminary preparation processing. In other words, the drone 20 is manually flown in the drone flight area 10, and images that meet specific conditions among the images captured at each of points in the drone flight path 22 are registered as keyframes in the DB.

The “keyframes” registered in the keyframe DB are not limited to images captured of marker substitution objects, but also include images in which marker substitution objects have not been captured.

The processing for registering keyframes in the keyframe DB will be described in detail later.

As described with reference to FIG. 7, the camera coordinate system (C) at the time when the drone camera 23 captures a single image (keyframe #kx) is called the “keyframe coordinate system (kx)”.

The marker coordinate system (mx) will be described next. As illustrated in FIG. 7, various objects (a desk, windows, outlets, and the like) are present in the area in which the drone 20 flies.

As previously described with reference to FIG. 2, three-dimensional data of specific objects (=marker substitution objects) in the drone flight area 10 illustrated on the left side of FIG. 2 is recorded in the drone flight area CG model 30 used in the processing of the present disclosure.

An object recorded in the drone flight area CG model 30 is a marker substitution object, and is used when the drone 20 flies according to the predefined drone flight path 22.

Note that the marker substitution objects recorded in the drone flight area CG model 30 are further recorded in an object DB as well.

The object DB will be described later.

The marker coordinate system (mx) is a coordinate system unique to each marker substitution object recorded in the object DB.

For example, for the “marker substitution object #m1=desk” indicated in FIG. 7, a marker #m1 coordinate system (m1), which is a coordinate system unique to that object, is defined.

Likewise, for the “marker substitution object #m2=window”, a marker #m2 coordinate system (m2), which is a coordinate system unique to that object, is defined.

Likewise, for the “marker substitution object #m3=outlet”, a marker #m3 coordinate system (m3), which is a coordinate system unique to that object, is defined.

In this manner, the marker coordinate system (mx) is a coordinate system unique to the marker substitution object associated with the “marker substitution object #mx”.

Note that the origin of the coordinate system and the x, y, and z axes can be set freely by the user (operator), for example. For example, the coordinate system can be set by using one end point of that corresponding object as the origin.

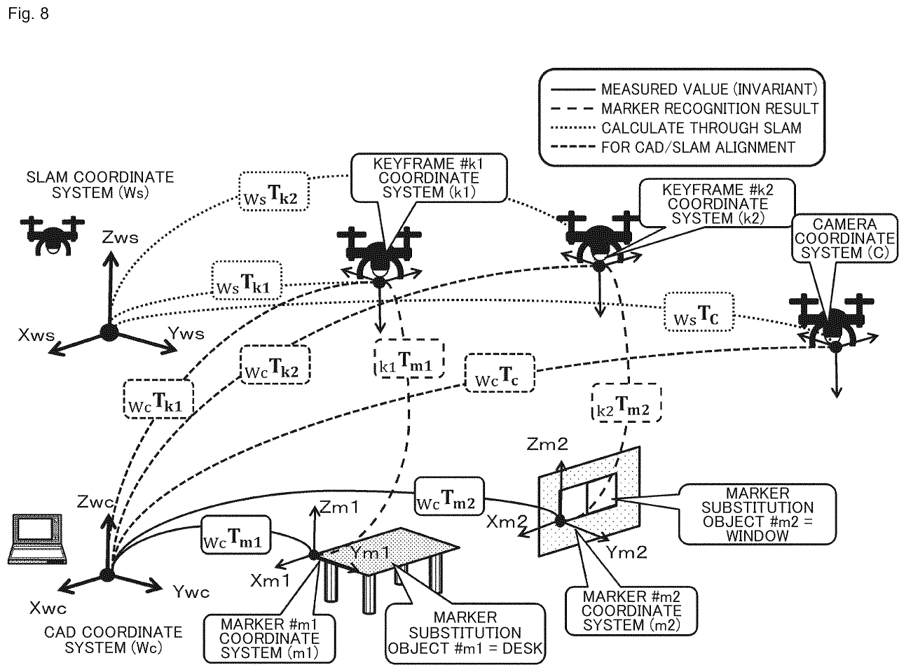

Next, for the five coordinate systems described above, namely,
(1) the SLAM coordinate system (Ws)
(2) the camera coordinate system (C)
(3) the CAD coordinate system (Wc)
(4) the keyframe coordinate system (kx); and
(5) the marker coordinate system (mx),
the relationships between these coordinate systems, and specific examples of coordinate transformation matrices, will be described with reference to FIG. 8.

FIG. 8 illustrates the five types of coordinate systems described above, and coordinate transformation matrices between the coordinate systems.

For example,
the coordinate transformation matrix (w_{c}Tₘ₁) is a coordinate transformation matrix for transforming the marker #m1 coordinate system (m1) of the “marker substitution object #m1=desk” into the CAD coordinate system (Wc); and the coordinate transformation matrix (w_{c}Tₘ₂) is a coordinate transformation matrix for transforming the marker #m2 coordinate system (m2) of the “marker substitution object #m2=window” into the CAD coordinate system (Wc).

As described earlier, the marker substitution objects are fixed objects in the drone flight area, and these coordinate transformation matrices (w_{c}Tₘ₁) and (w_{c}Tₘ₂) are invariant transformation matrices determined when the CG model is generated through CAD.

The coordinate transformation matrix (w_{c}Tₖ₁) is a coordinate transformation matrix for transforming the “keyframe #k1 coordinate system (k1)” into the CAD coordinate system (Wc).

The coordinate transformation matrix (w_{c}Tₖ₂) is a coordinate transformation matrix for transforming the “keyframe #k2 coordinate system (k2)” into the CAD coordinate system (Wc).

The coordinate transformation matrix (w_{c}T_{C}) is a coordinate transformation matrix for transforming the camera coordinate system (C) at the current drone position into the CAD coordinate system (Wc).

Additionally, the coordinate transformation matrix (wₛTₖ₁) is a coordinate transformation matrix for transforming the “keyframe #k1 coordinate system (k1)” into the SLAM coordinate system (Ws).

The coordinate transformation matrix (wₛTₖ₂) is a coordinate transformation matrix for transforming the “keyframe #k2 coordinate system (k2)” into the SLAM coordinate system (Ws).

The coordinate transformation matrix (wₛT_{C}) is a coordinate transformation matrix for transforming the camera coordinate system (C) at the current drone position into the SLAM coordinate system (Ws).

Furthermore, the coordinate transformation matrix (ₖ₁Tₘ₁) is a coordinate transformation matrix for transforming the marker #m1 coordinate system (m1) of the “marker substitution object #m1=desk” into the “keyframe #k1 coordinate system (k1)”.

The coordinate transformation matrix (ₖ₂Tₘ₂) is a coordinate transformation matrix for transforming the marker #m2 coordinate system (m2) of the “marker substitution object #m2=window” into the “keyframe #k2 coordinate system (k2)”.

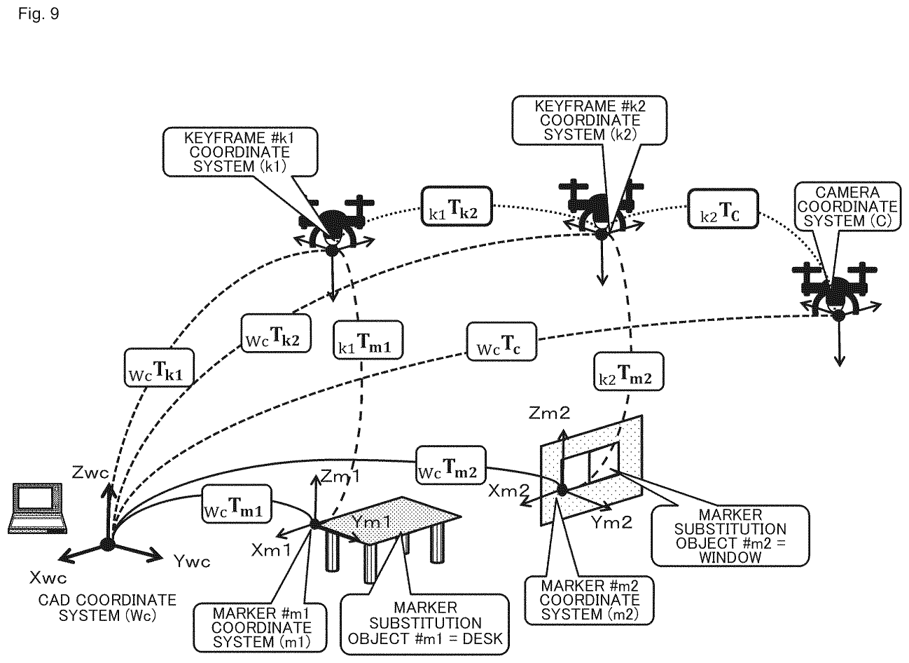

Furthermore, as illustrated in FIG. 9, the coordinate transformation matrices between the plurality of different keyframe coordinate systems are defined as follows.

The coordinate transformation matrix (ₖ₁Tₖ₂) is a coordinate transformation matrix for transforming the “keyframe #k2 coordinate system (k2)” into the “keyframe #k1 coordinate system (k1)”.

Additionally, the coordinate transformation matrix (ₖ₂T_{C}) is a coordinate transformation matrix for transforming the camera coordinate system (C) at the current drone position into the “keyframe #k2 coordinate system (k2)”.

### 3. Specific Examples of Data Generated or Used in Processing of Present Disclosure

Specific examples of data generated or used in the processing of the present disclosure will be described next.

The following three types of data generated or used in the processing of the present disclosure will be described hereinafter:
(A) a drone flight path registration CG model 71;
(B) an object DB (database) 72; and
(C) a keyframe DB 73.

Each type of data will be described.

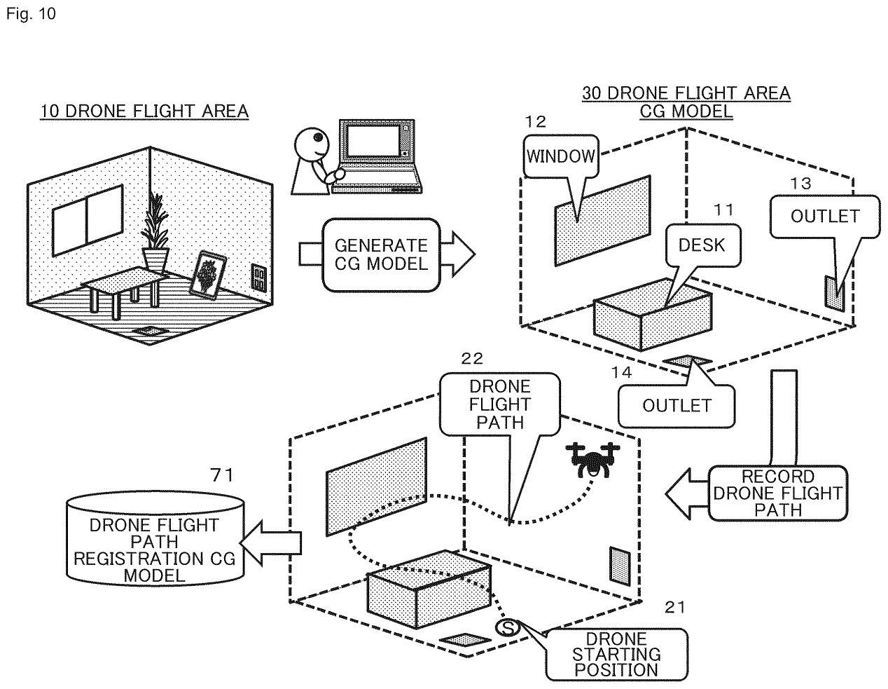

First, “(A) drone flight path registration CG model 71” will be described with reference to FIG. 10.

As described earlier with reference to FIG. 2 and the like, the CG model of the drone flight area (indoors) 10 (a three-dimensional CG model) is used in the processing of the present disclosure.

As illustrated in FIG. 10, the user (operator) generates the drone flight area CG model 30, which represents a three-dimensional space of the drone flight area 10, using an information processing device such as a PC.

Three-dimensional data of the marker substitution objects (the desk 11, the window 12, and the outlets 13 and 14) in the drone flight area 10, the drone starting position 21, and the drone flight path 22 are also recorded in the drone flight area CG model 30.

As described earlier, objects recorded in the drone flight area CG model 30 are marker substitution objects, and are used when the drone 20 flies according to the predefined drone flight path 22.

Note that the marker substitution objects are objects that do not move or deform, i.e., objects whose positions are fixed in the drone flight area 10.

The CG model of the drone flight area in which the marker substitution objects and the drone flight path are recorded is stored in the drone flight path registration CG model 71 illustrated in FIG. 10, and processing is performed using the drone flight path registration CG model 71 in the processing of the present disclosure.

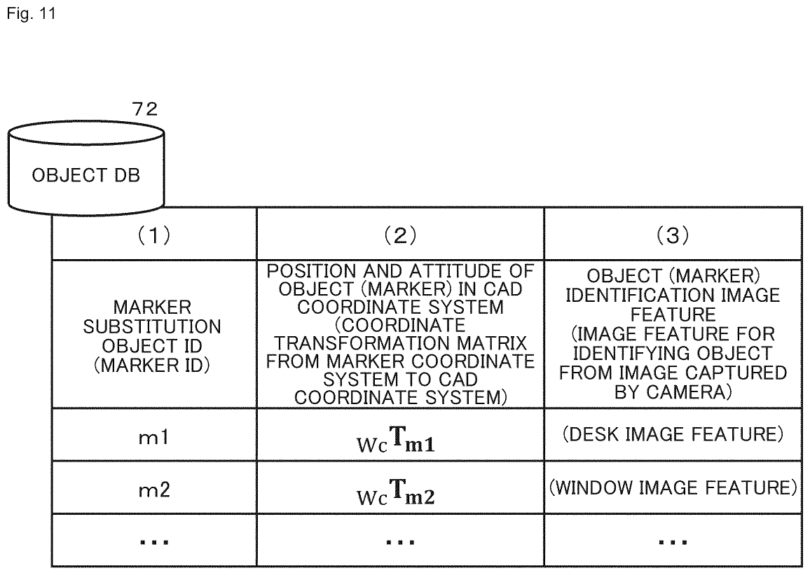

Next, “(B) object DB 72” will be described with reference to FIG. 11.

The object DB 72 is a database in which data corresponding to each of the marker substitution objects is recorded, and is a database in which each of the following pieces of data are recorded in association with each other.
(1) Marker substitution object ID (marker ID)
(2) Position and attitude of the object (marker) in the CAD coordinate system (a coordinate transformation matrix from the marker coordinate system to the CAD coordinate system)
(3) Object (marker) identification image feature (an image feature for identifying the object from an image captured by the camera)

The marker substitution object is an object used as a marker when the drone 20 flies according to the predefined drone flight path 22.

For example, information of each of (1) to (3) above is recorded in association with each other for each of the marker substitution objects indicated in FIG. 10 (the desk 11, the window 12, and the outlets 13 and 14).

A first entry (ID=m1) in the object DB 72 illustrated in FIG. 11 is data corresponding to the desk 11 illustrated in FIG. 10, and each of the following pieces of data is recorded in the entry.

Data=m1 is recorded as (1) marker substitution object ID (marker ID).

The coordinate transformation matrix (w_{c}Tₘ₁) is recorded as (2) position and attitude of the object (marker) in the CAD coordinate system (the coordinate transformation matrix from the marker coordinate system to the CAD coordinate system).

As described earlier with reference to FIG. 8, the coordinate transformation matrix (w_{c}Tₘ₁) is a coordinate transformation matrix for transforming the marker #m1 coordinate system (m1) of the “marker substitution object #m1=desk” into the CAD coordinate system (Wc).

Furthermore, an image feature of “marker substitution object #m1=desk” is recorded as (3) object (marker) identification image feature (the image feature for identifying the object from the image captured by the camera).

This image feature is image feature data for identifying the “marker substitution object #m1=desk” from an image captured by the drone camera 23.

Additionally, a second entry (ID=m2) in the object DB 72 illustrated in FIG. 11 is data corresponding to the window 12 illustrated in FIG. 10, and each of the following pieces of data is recorded in the entry.

Data=m2 is recorded as (1) marker substitution object ID (marker ID).

The coordinate transformation matrix (w&Tₘ₂) is recorded as (2) position and attitude of the object (marker) in the CAD coordinate system (the coordinate transformation matrix from the marker coordinate system to the CAD coordinate system).

As described earlier with reference to FIG. 8, the coordinate transformation matrix (w_{c}Tₘ₂) is a coordinate transformation matrix for transforming the marker #m2 coordinate system (m2) of the “marker substitution object #m2=window” into the CAD coordinate system (Wc).

Furthermore, an image feature of “marker substitution object #m2=window” is recorded as (3) the object (marker) identification image feature (the image feature for identifying the object from the image captured by the camera).

This image feature is image feature data for identifying the “marker substitution object #m2=window” from an image captured by the drone camera 23.

Thereafter, object information for all the marker substitution objects registered in the drone flight path registration CG model 71 is recorded in the object DB 72 illustrated in FIG. 11.

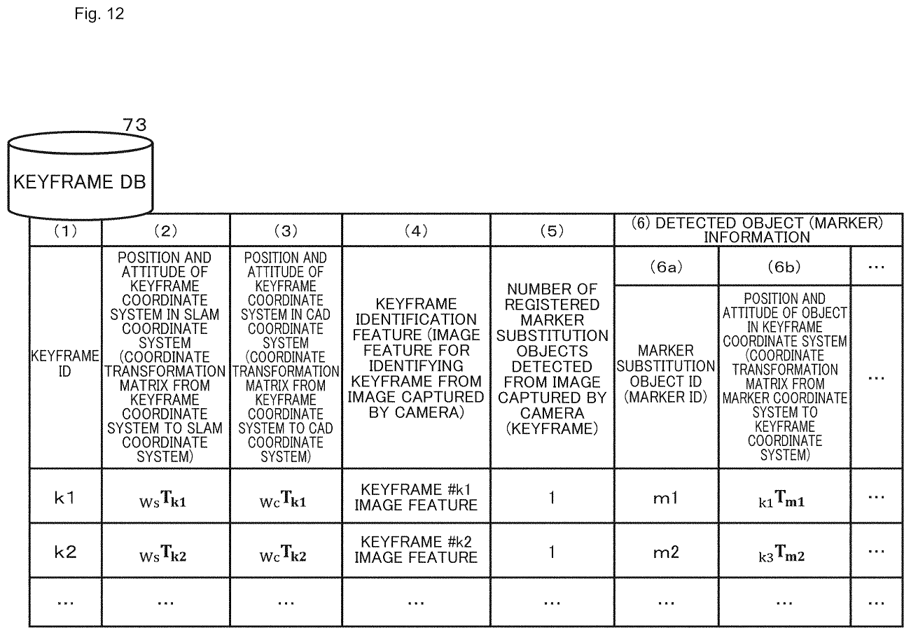

Next, “(C) keyframe DB 73” will be described with reference to FIG. 12.

The keyframe DB 73 is a database in which data corresponding to each of the keyframes is recorded, and is a database in which each of the following pieces of data are recorded in association with each other.
(1) Keyframe ID
(2) Position and attitude of the keyframe coordinate system in the SLAM coordinate system (a coordinate transformation matrix from the keyframe coordinate system to the SLAM coordinate system)
(3) Position and attitude of the keyframe coordinate system in the CAD coordinate system (a coordinate transformation matrix from the keyframe coordinate system to the CAD coordinate system)
(4) Keyframe identification feature (an image feature for identifying the keyframe from the image captured by the camera)
(5) Number of registered marker substitution objects detected from the image captured by the camera (keyframe)
(6) Detected object (marker) information
(6a) Marker substitution object ID (marker ID)
(6b) Position and attitude of the object in the keyframe coordinate system (a coordinate transformation matrix from the marker coordinate system to the keyframe coordinate system)

As described earlier with reference to FIG. 7 and the like, a “keyframe” is a captured image corresponding to the data registered in the keyframe DB 73, and information registration processing related to the keyframe for the keyframe DB 73 is performed at the stage of preliminary preparation processing. In other words, the drone 20 is manually flown in the drone flight area 10, images that meet specific conditions among the images captured at each of points in the drone flight path 22 are selected as keyframes, and information corresponding to the selected images (keyframes) is registered in the keyframe DB.

The keyframes registered in the keyframe DB 73 are not limited to images captured of marker substitution objects. In other words, even images in which a marker substitution object has not been captured are also selected as keyframes, if predefined conditions are met.

The keyframe selection processing will be described in detail later.

A specific example of the data registered in the keyframe DB 73 illustrated in FIG. 12 will be described here.

A first entry (keyframe ID=k1) in the keyframe DB 73 illustrated in FIG. 12 is, for example, an entry in which an image of the “marker substitution object #m1=desk” captured by the drone 20 at the position (P1) indicated in FIG. 7 is registered as a keyframe, and the following data is recorded.

The keyframe ID=k1 is recorded as (1) keyframe ID.

The coordinate transformation matrix (wₛTₖ₁) is recorded as (2) position and attitude of the keyframe coordinate system in the SLAM coordinate system (a coordinate transformation matrix from the keyframe coordinate system to the SLAM coordinate system).

As described earlier with reference to FIG. 8, the coordinate transformation matrix (wₛTₖ₁) is a coordinate transformation matrix for transforming the keyframe #k1 coordinate system (k1) of the “keyframe #k1”, which is an image in which the drone 20 has captured the “marker substitution object #m1=desk”, into the SLAM coordinate system (Ws).

By applying this coordinate transformation matrix (wₛTₖ₁) to perform coordinate transformation on coordinates (x, y, z) of a given point P in the keyframe #k1, which is the image captured by the drone camera 23 (=the keyframe #k1 coordinate system), coordinates (x, y, z) of the point P in the SLAM coordinate system (Ws) can be calculated.

For example, when the drone 20 flies autonomously according to a prescribed drone flight path 22, a data processing unit in the drone 20 (a drone flight control device) performs the coordinate transformation described above, and calculates the coordinates (x, y, z), in the SLAM coordinate system (Ws), of various points in the captured image.

The coordinate transformation matrix (w_{c}Tₖ₁) is recorded as (3) the position and attitude of the keyframe coordinate system in the CAD coordinate system (a coordinate transformation matrix from the keyframe coordinate system to the CAD coordinate system).

As described earlier with reference to FIG. 8, the coordinate transformation matrix (w_{c}Tₖ₁) is a coordinate transformation matrix for transforming the keyframe #k1 coordinate system (k1) of the “keyframe #k1”, which is an image in which the drone 20 has captured the “marker substitution object #m1=desk”, into the CAD coordinate system (Wc).

By applying this coordinate transformation matrix (w_{c}Tₖ₁) to perform coordinate transformation on coordinates (x, y, z) of a given point P in the keyframe #k1, which is the image captured by the drone camera 23 (=the keyframe #k1 coordinate system), coordinates (x, y, z) of the point P in the CAD coordinate system (Wc) can be calculated.

For example, when the drone 20 flies autonomously according to a prescribed drone flight path 22, a data processing unit in the drone 20 (a drone flight control device) performs the coordinate transformation described above, and calculates the coordinates (x, y, z), in the CAD coordinate system (Wc), of various points in the captured image.

An image feature of the “keyframe #k1” is recorded in (4) keyframe identification feature (the image feature for identifying the keyframe from the image captured by the camera).

Specifically, an image in which the “marker substitution object #m1=desk” is captured by the drone 20 at the position (P1) indicated in FIG. 7 is the “keyframe #k1”, and an image feature enabling the three-dimensional shape of the “marker substitution object #m1=desk” to be identified is recorded.

The number of registered marker substitution objects included in the “keyframe #k1” is recorded as (5) number of registered marker substitution objects detected from the image captured by the camera (the keyframe).

In this example, the “keyframe #k1” captured by the drone 20 at the position (P1) indicated in FIG. 7 includes only the “marker substitution object #m1=desk” as a registered marker substitution object, and thus a number=“1” is recorded.

Information related to the “marker substitution object #m1=desk” included in the “keyframe #k1” is recorded as (6) detected object (marker) information.

(6a) Marker substitution object ID (marker ID)=#m1.

The coordinate transformation matrix (ₖ₁Tₘ₁) is recorded as (6b) position and attitude of the object in the keyframe coordinate system (a coordinate transformation matrix from the marker coordinate system to the keyframe coordinate system).

As described earlier with reference to FIG. 8, the coordinate transformation matrix (ₖ₁Tₘ₁) is a coordinate transformation matrix for transforming the marker #m1 coordinate system (m1) of the “marker substitution object #m1=desk” into the “keyframe #k1 coordinate system (k1)”.

Thereafter, the drone 20 is manually flown in the drone flight area 10, and information related to each of the keyframes, which are images that meet specific conditions among the images captured at each of points in the drone flight path 22, is recorded in the keyframe DB 73 illustrated in FIG. 12.

Note that as mentioned earlier, the keyframes registered in the keyframe DB 73 are not limited to images captured of marker substitution objects. In other words, even images in which a marker substitution object has not been captured are also selected as keyframes, if predefined conditions are met.

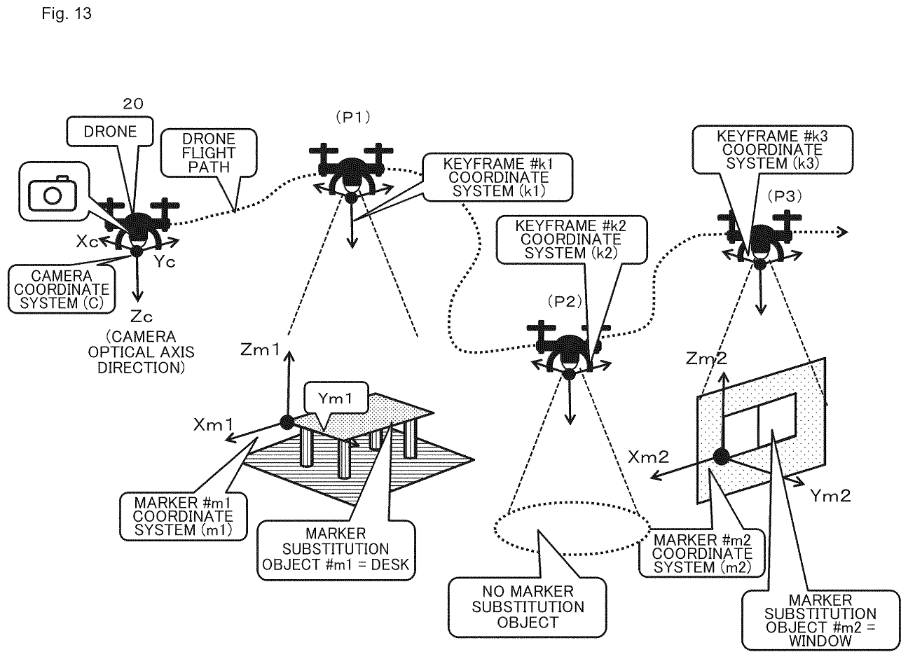

A specific example is illustrated in FIG. 13.

For example, in the example illustrated in FIG. 13, the drone 20 flies according to the drone flight path. A “marker substitution object #m1=desk” is captured in the image captured by the drone camera 23 when the drone 20 is at the position (P1). Whether this captured image meets a predefined keyframe registration condition is determined, and if the captured image is determined to meet the condition, the captured image is selected as a keyframe and registered in the keyframe DB 73.

Next, although a “marker substitution object” has not been captured in the image captured by the drone camera 23 when the drone 20 is at the position (P2), whether this captured image meets a predefined keyframe registration condition is determined as well, and if the captured image is determined to meet the condition, the captured image is selected as a keyframe and registered in the keyframe DB 73.

In this manner, whether to register an image in the keyframe DB 73 is determined not on the basis of whether a “marker substitution object” has been captured, but instead on the basis of a result of determining whether the predefined keyframe registration condition is met.

Specifically, when a keyframe registration determination target image (=a new image captured by the drone 20) meets any of the following registration conditions, that image is registered in the keyframe DB 73.
(Registration condition a) When it is confirmed that the verification between the keyframe registration determination target image (=the new image captured by the drone 20) and an image already registered in the keyframe DB 73 has failed (if the captured image does not match an image already registered in the DB) (Registration condition b) When a difference between the position and attitude at which the camera captured the keyframe registration determination target image (=the new image captured by the drone 20) and the position and attitude of the camera when capturing the keyframe registered in the keyframe DB 73 immediately before is confirmed to be at least a defined threshold
(Registration condition c) When a difference between the position and attitude at which the camera captured the keyframe registration determination target image (=the new image captured by the drone 20) and the position and attitude at which the camera captured an image (keyframe), registered in the keyframe DB 73, that is at a position closest to the position at which the keyframe registration determination target image was captured, is confirmed to be at least a defined threshold (Registration condition d) When a difference between the position and attitude at which the camera captured the keyframe registration determination target image (=the new image captured by the drone 20) and the position and attitude of the “marker substitution object” at a position closest to the position at which the keyframe registration determination target image was captured is confirmed to be no greater than a defined threshold

When a keyframe registration determination target image (=a new image captured by the drone 20) meets any of the registration conditions a to d described above, that image is registered in the keyframe DB 73.

A specific sequence of these registration determination processes will be described later.

In this manner, the keyframes registered in the keyframe DB 73 are not limited to images captured of marker substitution objects. In other words, even images in which a marker substitution object has not been captured are also selected as keyframes, if predefined conditions are met.

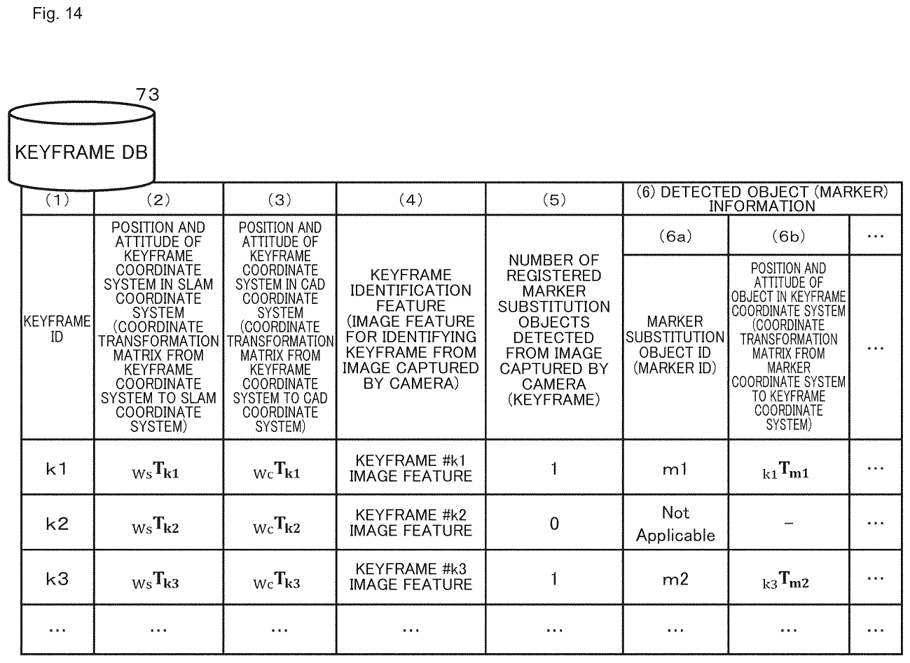

FIG. 14 illustrates an example of DB registration data when an image, in which a “marker substitution object” has not been captured, is selected as a keyframe and registered in the keyframe DB 73.

In the registration data in the keyframe DB 73 illustrated in FIG. 14, the second record data (keyframe ID=k2) is an example of an image in which a “marker substitution object” has not been captured is registered as a keyframe.

In this case, as illustrated in the figure, data similar to the image in which a “marker substitution object” has been captured is recorded up to the registration items (1) to (4).

A number=“0” is recorded in (5) number of registered marker substitution objects detected from the image captured by the camera (the keyframe), as the number of registered marker substitution objects included in the “keyframe #k2”.

Furthermore, no data is recorded in “(6) detected object (marker) information”, in which information related to the “marker substitution object” included in the “keyframe #k2” is recorded. Alternatively, “Not Applicable” is recorded.

### 4. Sequence of Processing Performed by Mobile Body Control Device of Present Disclosure

Next, a sequence of processing performed by the mobile body control device of present disclosure.

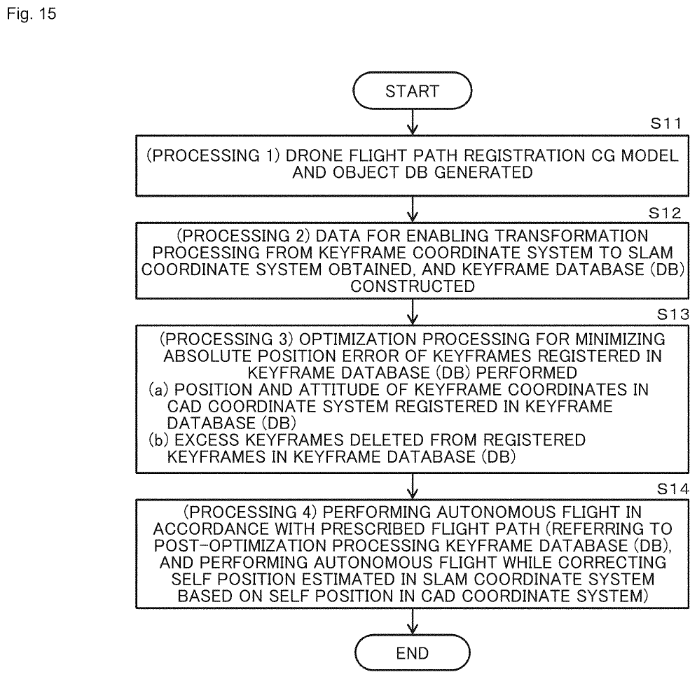

A processing sequence executed by the mobile body control device, the information processing device, and the like of the present disclosure will be described hereinafter with reference to the flowchart indicated in FIG. 15 and on.

Note that the processing sequence executed by the mobile body control device, the information processing device, and the like of the present disclosure will be described hereinafter according to the following order.
(A) Overall sequence (Processing 1)-(Processing 4)
(B1) (Processing 1) Processing for generating drone flight path registration CG model and object DB
(B2) (Processing 2) Processing for obtaining data for enabling transformation processing from keyframe coordinate system to SLAM coordinate system, and constructing keyframe DB
(B3) (Processing 3) Optimization processing for minimizing absolute position error of keyframes registered in keyframe DB
(B4) (Processing 4) Processing for performing autonomous flight in accordance with prescribed flight path (referring to post-optimization processing keyframe DB, and performing autonomous flight while correcting self position estimated in SLAM coordinate system based on self position in CAD coordinate system)

### (4-A. Overall Sequence (Processing 1)-(Processing 4))

The overall sequence of the processing performed in the present disclosure will be described first with reference to the flowchart illustrated in FIG. 15.

The flowchart illustrated in FIG. 15 is a flowchart illustrating the overall sequence of the processing of the present disclosure.

Note that the processing according to the flow illustrated in FIG. 15 and on can be executed under the control of a control unit (a data processing unit) constituted by a CPU and the like having program execution functionality, in accordance with a program stored in a memory inside of the mobile body control device or the like. The processing of each step in the flow illustrated in FIG. 15 and on will be described in order.

FIG. 15 illustrates four steps, namely (Processing 1) to (Processing 4).

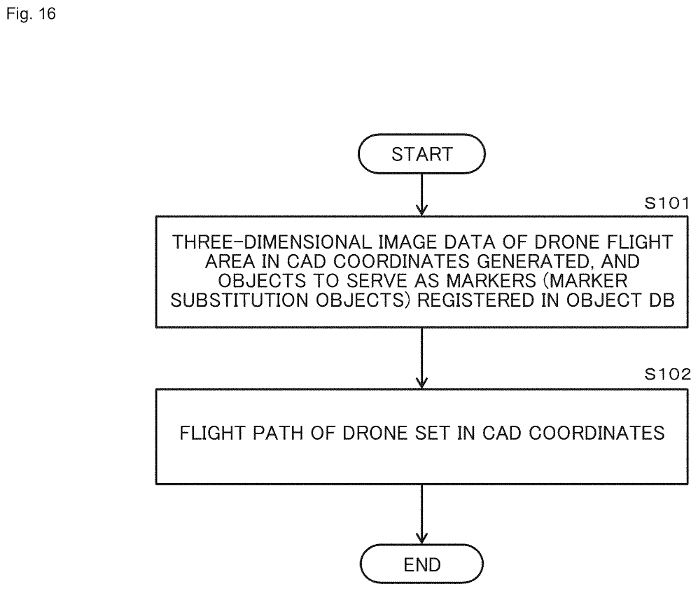

The flow consisting of (Processing 1) to (Processing 4) illustrated in FIG. 15 is a flow illustrating an overview of the overall processing of the present disclosure. Detailed sequences of these four processes, i.e., (Processing 1) to (Processing 4) illustrated in FIG. 15, will be described with reference to FIG. 16 and on.

Processing of each step in the flow illustrated in FIG. 15 will be described first.

### (Step S11)

Step S11 is (Processing 1), and the following processing is performed.

(Processing 1) The drone flight path registration CG model 71 and the object DB 72 are generated.

### (Step S12)

Step S12 is (Processing 2), and the following processing is performed.

(Processing 2) Data for enabling transformation processing from the keyframe coordinate system to the SLAM coordinate system is obtained, and the keyframe DB is constructed.

### (Step S13)

Step S13 is (Processing 3), and the following processing is performed.

(Processing 3) Optimization processing for minimizing absolute position error of the keyframes registered in the keyframe DB 73 is performed.
(a) The position and attitude of the keyframe coordinates in the CAD coordinate system are registered in the keyframe DB 73.
(b) Excess keyframes are removed from the registered keyframes in the keyframe DB 73.

### (Step S14)

Step S14 is (Processing 4), and the following processing is performed.

(Processing 4) Autonomous flight is performed in accordance with a prescribed flight path. (The post-optimization processing keyframe DB 73 is referred to, and the autonomous flight is performed while correcting the self position estimated in the SLAM coordinate system based on the self position in CAD coordinate system.)

As described above, the autonomous flight processing for the drone is only the processing of the final step S14, and the processing of steps S11 to S13 is preparatory processing for performing the autonomous flight processing of the final step S14.

The detailed sequences of each of (Processing 1) to (Processing 4) in the respective steps of the flow in FIG. 15 will be described hereinafter in order, with reference to FIG. 16 and on.

### (4-B1. (Processing 1) Processing for Generating Drone Flight Path Registration CG Model 71 and Object DB 72)

First, (Processing 1) indicated in step S11 of the flow in FIG. 15, i.e., (Processing 1) processing for setting three-dimensional image data of the drone flight area and the flight path of the drone in CAD coordinates, will be described in detail.

Note that the drone flight path registration CG model 71 is a CG model in which three-dimensional image data of the drone flight area and the flight path of the drone are set in CAD coordinates, as described earlier with reference to FIG. 10. The three-dimensional image data of the marker substitution objects is also included in the three-dimensional image data of the drone flight area.

The detailed sequence of this (Processing 1) will be described with reference to the flowchart illustrated in FIG. 16.

The processing of each step in the flow illustrated in FIG. 16 will be described in order.

### (Step S101)

First, in step S101, the following processing is performed.

The three-dimensional image data of the drone flight area in CAD coordinates is generated, and the objects to serve as markers (marker substitution objects) are registered in the object DB 72.

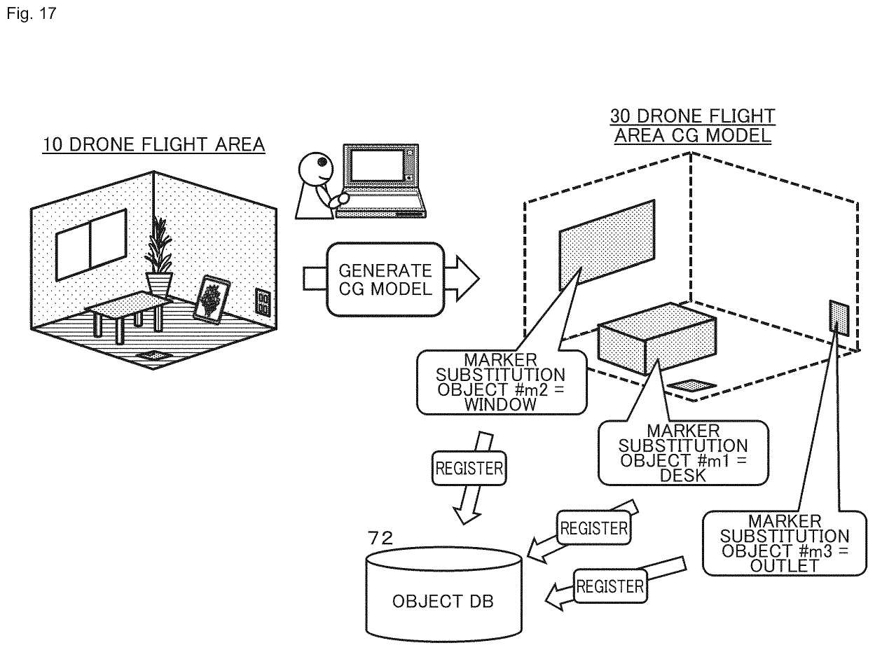

A specific example of the processing of step S101 will be described with reference to FIG. 17.

As described earlier with reference to FIG. 2 and the like, the CG model of the drone flight area (indoors) 10 (a three-dimensional CG model) is generated and used in the processing of the present disclosure.

As illustrated in FIG. 17, the user (operator) generates the drone flight area CG model 30, which represents a three-dimensional space of the drone flight area 10, using an information processing device such as a PC.

Three-dimensional data of the marker substitution objects (the desk, the window, the outlets, and the like) in the drone flight area 10 is recorded in the drone flight area CG model 30.

The marker substitution objects are objects that do not move or deform, i.e., objects whose positions are fixed in the drone flight area 10.

As described earlier, the marker substitution objects recorded in the drone flight area CG model 30 are used when the drone 20 flies according to a predefined drone flight path.

In step S101, each of the marker substitution objects recorded in the drone flight area CG model 30 is registered in the object DB 72 having the data configuration described earlier with reference to FIG. 11.

As described earlier with reference to FIG. 11, the object DB 72 is a database in which data corresponding to each of the marker substitution objects is recorded, and is a database in which each of the following pieces of data are recorded in association with each other.
(1) Marker substitution object ID (marker ID)
(2) Position and attitude of the object (marker) in the CAD coordinate system (a coordinate transformation matrix from the marker coordinate system to the CAD coordinate system)
(3) Object (marker) identification image feature (an image feature for identifying the object from an image captured by the camera)

### (Step S102)

Next, in step S102, the following processing is performed.

The flight path of the drone is set in CAD coordinates.

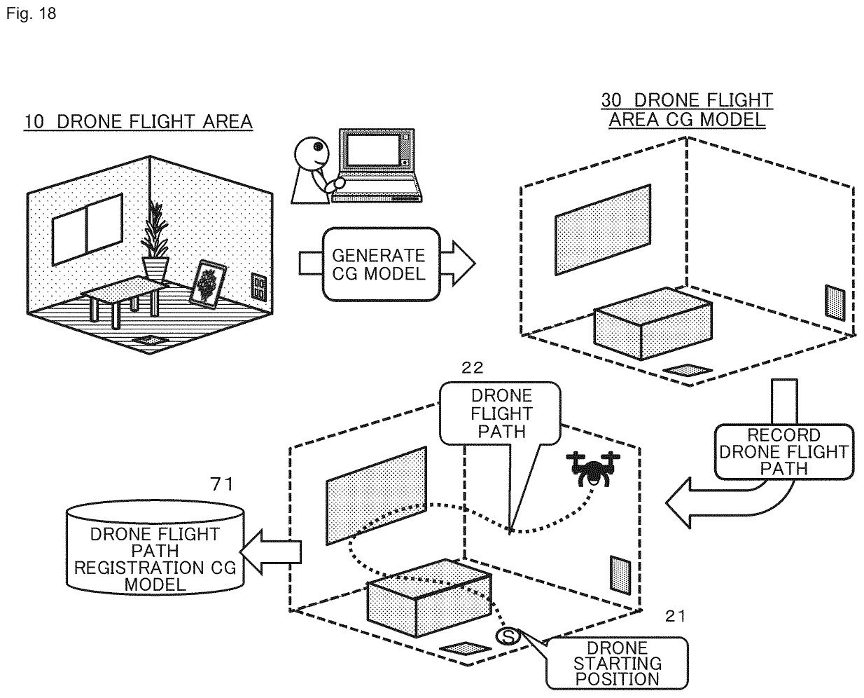

A specific example of this processing will be described with reference to FIG. 18. As illustrated in FIG. 18, the user (operator) generates the drone flight area CG model 30, which represents a three-dimensional space of the drone flight area 10, using an information processing device such as a PC. This processing is the processing of step S101 described above.

Furthermore, the user (operator) records the drone starting position 21, the drone flight path 22, and the like in the generated drone flight area CG model 30 using the information processing device such as a PC.

The drone flight path 22 can be freely set as long as the path is a trajectory in which the drone will not collide with a marker substitution object (a desk, a window, an outlet, or the like) recorded in the drone flight area CG model 30, for example.

The drone flight path registration CG model 71, in which the marker substitution objects (the desk, the window, the outlets, and the like) and the drone flight path 22 are recorded, is generated in this manner. The drone flight path registration CG model 71 is recorded in a storage unit in the information processing device such as a PC operated by the user (operator).

Note that the drone flight path registration CG model 71 generated by the information processing device such as a PC is transferred to the drone 20, stored in a storage unit in the drone 20, and used when the drone 20 flies autonomously according to the drone flight path 22 (when performing the processing in step S14 of the flow in FIG. 15).

(4-B2. (Processing 2) Processing for Obtaining Data for Enabling Transformation Processing from Keyframe Coordinate System to SLAM Coordinate System, and Constructing Keyframe DB)

(Processing 2) indicated in step S12 of the flow in FIG. 15, i.e., (Processing 2) processing for obtaining data for enabling transformation processing from the keyframe coordinate system to the SLAM coordinate system, and constructing keyframe DB, will be described next.

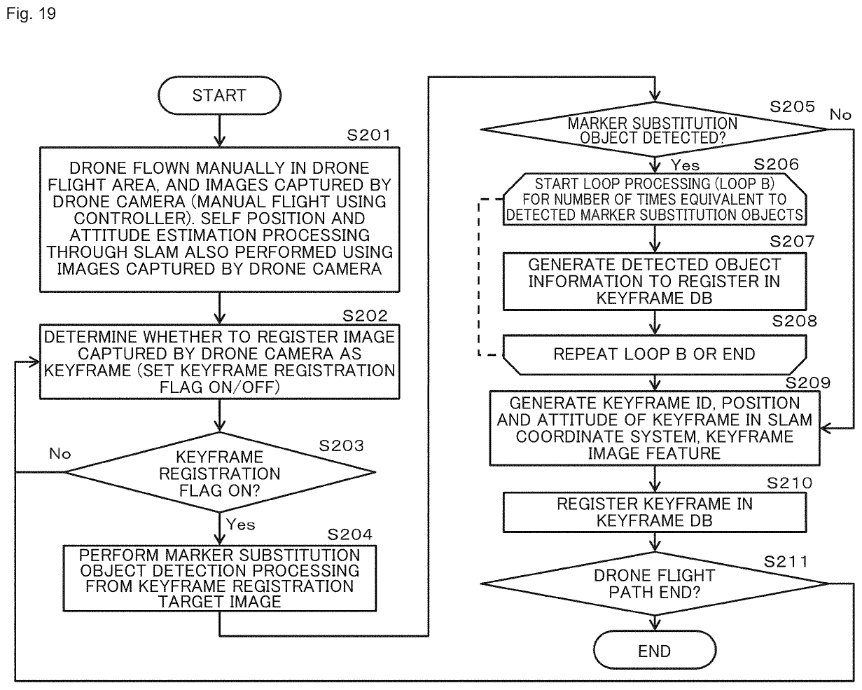

The detailed sequence of this (Processing 2) will be described with reference to the flowchart illustrated in FIG. 19.

The processing of each step in the flow illustrated in FIG. 19 will be described hereinafter in order.

### (Step S201)

First, in step S201, the following processing is performed.

The drone 20 is manually flown in the drone flight area 10, and the drone camera 23 captures images. The manual flight is performed using a controller, for example. At this time, self position and attitude estimation processing is also performed through SLAM (Visual SLAM) using the images captured by the drone camera 23.

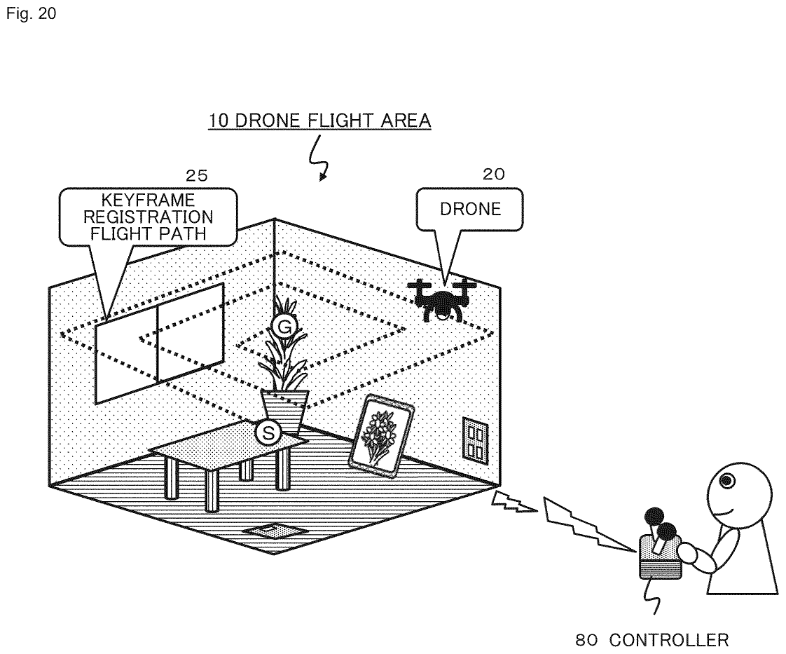

A specific example of the processing of step S201 will be described with reference to FIG. 20.

The user (operator) operates a controller 80 to fly the drone 20 in the drone flight area 10.

For example, the drone is manually flown according to a keyframe registration flight path 25 such as that illustrated in FIG. 20.

Although the keyframe registration flight path 25 does not need to be defined in advance, it is preferable that the drone 20 flies in a flight path that enables a high number of different images in the drone flight area 10 to be captured during flight.

In this manner, in step S201, the drone 20 is flown in the drone flight area 10, and the drone camera 23 captures images from various positions.

Furthermore, in step S201, the self position and attitude estimation processing is performed through SLAM (Visual SLAM) using the images captured by the drone camera 23 while the drone is flown manually.

### (Step S202)

Next, in step S202, the following processing is performed.

Whether to register the images captured by the drone camera 23 as keyframes in the keyframe DB 73 is determined. Specifically, whether a keyframe registration flag associated with each of the images captured by the drone camera 23 is ON (register as a keyframe) or OFF (do not register as a keyframe) is determined.

Note that the processing of steps S202 to S210 is processing performed by a data processing unit in the drone 20, and is processing performed repeatedly for each image captured by the drone camera 23.

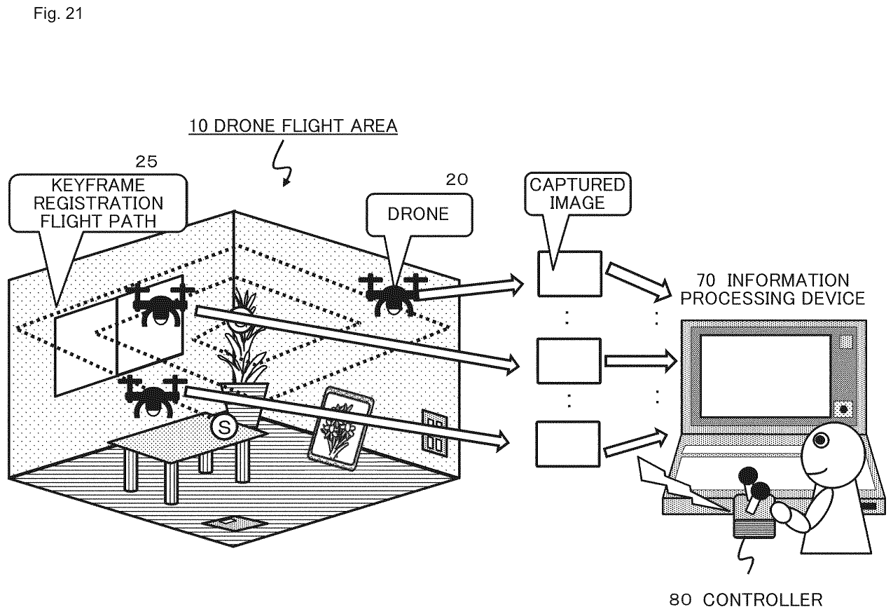

However, a configuration is also possible in which, for example, the images captured by the drone camera 23 are sent to an external information processing device 70, such as a PC, and the information processing device 70 performs the processing of steps S202 to S210, as illustrated in FIG. 21.

As an example, it is assumed here that the data processing unit in the drone 20 performs the processing of steps S202 to S210.

As described earlier with reference to FIG. 13, whether to register an image captured by the drone camera 23 in the keyframe DB 73 is determined not on the basis of whether a “marker substitution object” has been captured, but instead on the basis of a result of determining whether the predefined keyframe registration condition is met.

In other words, an image is registered in the keyframe DB 73 when any of the following registration conditions are met.

(Registration condition a) When it is confirmed that the verification between the keyframe registration determination target image (=the new image captured by the drone 20) and an image already registered in the keyframe DB 73 has failed (if the captured image does not match an image already registered in the DB)

(Registration condition b) When a difference between the position and attitude at which the camera captured the keyframe registration determination target image (=the new image captured by the drone 20) and the position and attitude of the camera when capturing the keyframe registered in the keyframe DB 73 immediately before is confirmed to be at least a defined threshold

(Registration condition c) When a difference between the position and attitude at which the camera captured the keyframe registration determination target image (=the new image captured by the drone 20) and the position and attitude at which the camera captured an image (keyframe), registered in the keyframe DB 73, that is at a position closest to the position at which the keyframe registration determination target image was captured, is confirmed to be at least a defined threshold

(Registration condition d) When a difference between the position and attitude at which the camera captured the keyframe registration determination target image (=the new image captured by the drone 20) and the position and attitude of the “marker substitution object” at a position closest to the position at which the keyframe registration determination target image was captured is confirmed to be no greater than a defined threshold

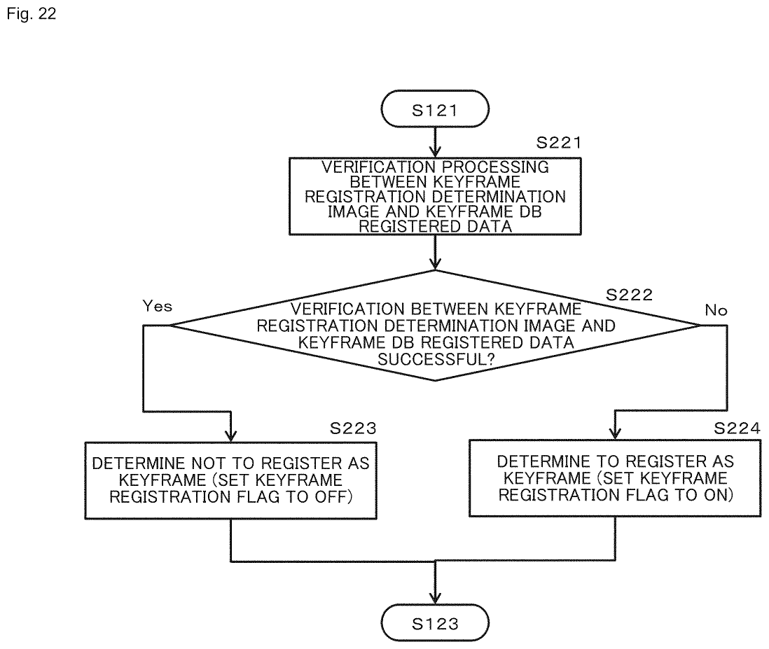

A detailed sequence of the processing for determining whether the four registration conditions a to d are met will be described separately later, with reference to the flow in FIG. 22 and on.

In step S202, the data processing unit in the drone 20 verifies the image captured by the drone camera 23 and determines whether the registration conditions a to d described above are met. The keyframe registration flag is set to ON for an image that meets any of the registration conditions a to d, and the keyframe registration flag is set to OFF for an image that does not meet any of the registration conditions a to d.

### (Step S203)

Next, in step S203, the data processing unit in the drone 20 determines whether the keyframe registration flag set for the image captured by the drone camera 23 is set to ON (register as a keyframe).

If the keyframe registration flag=ON, the processing of steps S204 and on is performed on the captured image for which the flag is set to ON.

On the other hand, if the keyframe registration flag=OFF, the sequence returns to step S202, and the processing is performed for the next captured image.

### (Step S204)

If the keyframe registration flag=ON is determined in step S203, the processing of steps S204 and on is performed on the captured image for which the flag is set to ON (a keyframe registration target image).

First, in step S204, the data processing unit in the drone 20 performs marker substitution object detection processing as to whether a marker substitution object is present in the image captured by the drone camera 23 (the keyframe registration target image).

The marker substitution object to be detected is an object registered in the object DB 72.

The data processing unit in the drone 20 analyzes the image captured by the drone camera 23 (the keyframe registration target image), extracts an image feature, and performs processing of verifying that image feature against the image feature of the marker substitution object registered in the object DB 72. If the verification is successful, the marker substitution object is determined to be present in the captured image (the keyframe registration target image).

### (Step S205)

Step S205 is a step that branches on the basis of the result of determining the marker substitution object detection result in step S204.

If a marker substitution object has been detected from the captured image (the keyframe registration target image), the sequence moves to step S206.

If a marker substitution object has not been detected from the captured image (the keyframe registration target image), the sequence moves to step S209.

### (Steps S206 to S208)

The processing of steps S206 to S208 is a processing loop performed repeatedly for each marker substitution object detected from the captured image (the keyframe registration target image).

In step S207, the following processing is performed for each marker substitution object detected from the captured image (the keyframe registration target image).

Each of the following pieces of data, which is record data for the keyframe DB 73, is generated:
marker substitution object information.

This is the registration data of the keyframe DB 73 described earlier with reference to FIG. 12.

As described earlier with reference to FIG. 12, the keyframe DB 73 is a database in which data corresponding to each of the keyframes is recorded, and is a database in which each of the following pieces of data are recorded in association with each other.
(1) Keyframe ID
(2) Position and attitude of the keyframe coordinate system in the SLAM coordinate system (a coordinate transformation matrix from the keyframe coordinate system to the SLAM coordinate system)
(3) Position and attitude of the keyframe coordinate system in the CAD coordinate system (a coordinate transformation matrix from the keyframe coordinate system to the CAD coordinate system)
(4) Keyframe identification feature (an image feature for identifying the keyframe from the image captured by the camera)
(5) Number of registered marker substitution objects detected from the image captured by the camera (keyframe)
(6) Detected object (marker) information
(6a) Marker substitution object ID (marker ID)
(6b) Position and attitude of the object in the keyframe coordinate system (a coordinate transformation matrix from the marker coordinate system to the keyframe coordinate system)

Of this registration data, the following information is generated for the marker substitution object detected from the captured image (the keyframe registration target image) in step S207.
(5) Number of registered marker substitution objects detected from the image captured by the camera (keyframe)
(6) Detected object (marker) information
(6a) Marker substitution object ID (marker ID)
(6b) Position and attitude of the object in the keyframe coordinate system (a coordinate transformation matrix from the marker coordinate system to the keyframe coordinate system)

In this manner, in steps S206 to S208, processing for generating the data of the marker substitution object information is performed for each marker substitution object detected from the captured image (the keyframe registration target image). When the processing is complete for all marker substitution objects detected from the captured image (the keyframe registration target image), the sequence moves to step S209.

### (Step S209)

Each of the following pieces of data, which is record data for the keyframe DB 73, is generated in step S209:
the keyframe ID;
the keyframe position and attitude in the SLAM coordinate system; and
an image feature of the keyframe.

In other words, processing for generating the record data for the keyframe DB 73 described above, namely,
(1) Keyframe ID;
(2) Position and attitude of the keyframe coordinate system in the SLAM coordinate system (a coordinate transformation matrix from the keyframe coordinate system to the SLAM coordinate system); and
(4) Keyframe identification feature (an image feature for identifying the keyframe from the image captured by the camera), is performed.

Note that of the record data for the keyframe DB 73,
(3) Position and attitude of the keyframe coordinate system in the CAD coordinate system (a coordinate transformation matrix from the keyframe coordinate system to the CAD coordinate system)
is generated and registered in the next step S13 of the overall processing flow illustrated in FIG. 15.

This processing will be described later.

### (Step S210)

The data processing unit of the drone 20 registers the keyframe DB registration data generated in steps S206 to S209 in the keyframe DB 73 in step S210.

### (Step S211)

Finally, in step S211, whether the drone 20 has ended the flight according to the keyframe registration flight path 25 is determined.

If not, the sequence moves to step S202, and the processing is performed for the next captured image.

If the flight has ended, the sequence ends.

By performing the processing according to the flow illustrated in FIG. 19 in this manner, (Processing 2) indicated in step S12 of the flow in FIG. 15, i.e., (Processing 2) processing for obtaining data for enabling transformation processing from the keyframe coordinate system to the SLAM coordinate system, and constructing the keyframe DB, is completed.

Next, the detailed sequence of the processing of step S202 in the flow illustrated in FIG. 19 (Processing 2) described above, i.e., the processing of determining whether to register the image captured by the drone camera 23 as a keyframe in the keyframe DB 73, will be described with reference to the flowchart in FIG. 22 and on.

In step S202 in the flow of (Processing 2) illustrated in FIG. 19, whether the keyframe registration flag associated with the image captured by the drone camera 23 is ON (register as a keyframe) or OFF (do not register as a keyframe) is determined.

Specifically, the keyframe registration flag is set to ON (register as a keyframe) when the captured image meets any of the following registration conditions.

(Registration condition a) When it is confirmed that the verification between the keyframe registration determination target image (=the new image captured by the drone 20) and an image already registered in the keyframe DB 73 has failed (if the captured image does not match an image already registered in the DB)

(Registration condition b) When a difference between the position and attitude at which the camera captured the keyframe registration determination target image (=the new image captured by the drone 20) and the position and attitude of the camera when capturing the keyframe registered in the keyframe DB 73 immediately before is confirmed to be at least a defined threshold

(Registration condition c) When a difference between the position and attitude at which the camera captured the keyframe registration determination target image (=the new image captured by the drone 20) and the position and attitude at which the camera captured an image (keyframe), registered in the keyframe DB 73, that is at a position closest to the position at which the keyframe registration determination target image was captured, is confirmed to be at least a defined threshold

(Registration condition d) When a difference between the position and attitude at which the camera captured the keyframe registration determination target image (=the new image captured by the drone 20) and the position and attitude of the “marker substitution object” at a position closest to the position at which the keyframe registration determination target image was captured is confirmed to be no greater than a defined threshold

A detailed sequence of the processing for determining whether the registration conditions a to d are met will be described hereinafter.

### (4-B2-a. (Registration Condition a) Determination Processing Sequence)

The determination processing sequence for the following (registration condition a) will be described first with reference to the flowchart illustrated in FIG. 22. (Registration condition a) When it is confirmed that the verification between the keyframe registration determination target image (=the new image captured by the drone 20) and an image already registered in the keyframe DB 73 has failed (if the captured image does not match an image already registered in the DB), the keyframe registration flag is set to ON (register as a keyframe).

The processes of each step in the row illustrated in FIG. 22, which is a detailed sequence of the determination processing for the registration condition a, will be described in order.

### (Step S221)

First, in step S221, the data processing unit of the drone 20 performs processing for verifying an image captured by the drone camera 23 (a keyframe registration determination image) against images already registered in the keyframe DB 73.

The data processing unit of the drone 20 obtains an image feature from the keyframe registration determination image and performs processing for comparing and verifying that image feature against the image features of images (=keyframes) already registered in the keyframe DB 73.

### (Step S222)

Step S222 is branching processing based on the result of the image verification processing of step S221.

If the verification processing between the image captured by the drone camera 23 (the keyframe registration determination image) and the images registered in the keyframe DB is successful, the sequence moves to step S223.

On the other hand, if the verification fails, the sequence moves to step S224.

### (Step S223)

If it is determined in step S222 that the verification processing between the image captured by the drone camera 23 (the keyframe registration determination image) and the images registered in the keyframe DB is successful, in step S223, the keyframe registration flag of the image captured by the drone camera 23 (the keyframe registration determination image) is set to OFF. In other words, the image captured by the drone camera 23 (the keyframe registration determination image) is determined not to be registered in the keyframe DB 73.

### (Step S224)

On the other hand, if it is determined in step S222 that the verification processing between the image captured by the drone camera 23 (the keyframe registration determination image) and the images registered in the keyframe DB is not successful, in step S224, the keyframe registration flag of the image captured by the drone camera 23 (the keyframe registration determination image) is set to ON. In other words, the image captured by the drone camera 23 (the keyframe registration determination image) is determined to be registered in the keyframe DB 73.

The flow illustrated in FIG. 22 is a registration determination sequence in which if the processing of verifying the image captured by the drone camera 23 (the keyframe registration determination image) against the images registered in the keyframe DB is successful, the image is not registered in the keyframe DB 73, and is only registered in the keyframe DB 73 if the verification fails.

The processing according to the flow illustrated in FIG. 22 is, in essence, processing in which if an image that almost matches or is highly similar to the image captured by the drone camera 23 (the keyframe registration determination image) is already registered in the keyframe DB 73, that image is not registered in the keyframe DB 73, and the captured image is registered in the keyframe DB 73 only if an image that matches or is highly similar to the captured image is not registered in the keyframe DB 73.

Performing this processing makes it possible to reduce the possibility of registering similar images in duplicate in the keyframe DB 73.

### (4-B2-b. (Registration Condition b) Determination Processing Sequence)

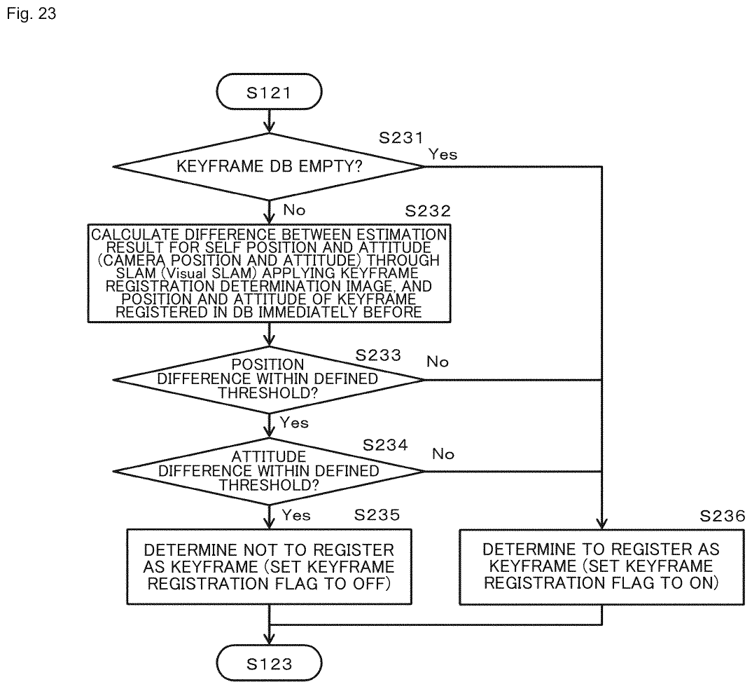

The determination processing sequence for the following (registration condition b) will be described next with reference to the flowchart illustrated in FIG. 23.

(Registration condition b) When a difference between the position and attitude at which the camera captured the keyframe registration determination target image (=the new image captured by the drone 20) and the position and attitude of the camera when capturing the keyframe registered in the keyframe DB 73 immediately before is confirmed to be at least a defined threshold, the keyframe registration flag is set to ON (register as a keyframe).

The processes of each step in the flow illustrated in FIG. 23, which is a detailed sequence of the determination processing for the registration condition b, will be described in order.

### (Step S231)

First, in step S231, the data processing unit of the drone 20 determines whether the keyframe DB 73 is empty.

If the keyframe DB 73 is empty, i.e., if there is no registration data, the sequence moves to step S236, where the keyframe registration flag of the image captured by the drone camera 23 (the keyframe registration determination image) is set to ON. In other words, the captured image is an image that is registered in the keyframe DB 73.

On the other hand, if the keyframe DB 73 is not empty, i.e., if there is registration data, the sequence moves to step S232.

### (Step S232)

If the keyframe DB 73 is not empty, i.e., if there is registration data, the sequence moves to step S232, where the following processing is performed.

A difference between a result of estimating the self position and attitude (the camera position and attitude) by SLAM (Visual SLAM) applying the image captured by the drone camera 23 (the keyframe registration determination image) and the position and attitude of the newest DB-registered keyframe registered in the keyframe DB 73 immediately before is calculated.

### (Step S233)

In step S233, it is determined whether the difference between the position of the image captured by the drone camera 23 (the keyframe registration determination image) and the position of the newest DB-registered keyframe registered in the keyframe DB 73 immediately before is within a predefined threshold.

If the difference is determined to be within the predefined threshold, the sequence moves to step S234.

However, if the difference is determined not to be within the predefined threshold, the sequence moves to step S236.

### (Step S234)

In step S234, it is determined whether the difference between the attitude of the image captured by the drone camera 23 (the keyframe registration determination image) and the attitude of the newest DB-registered keyframe registered in the keyframe DB 73 immediately before is within a predefined threshold.

If the difference is determined to be within the predefined threshold, the sequence moves to step S235.

However, if the difference is determined not to be within the predefined threshold, the sequence moves to step S236.

### (Step S235)

Step S235 is processing performed when the differences between the positions and attitudes of the image captured by the drone camera 23 (the keyframe registration determination image) and the newest DB-registered keyframe registered in the keyframe DB 73 immediately before are both determined to be within the predefined thresholds.

In this case, the keyframe registration flag of the image captured by the drone camera 23 (the keyframe registration determination image) is set to OFF. In other words, it is determined that the image is not to be registered in the keyframe DB 73.

### (Step S236)

Step S236 is processing performed when at least one of the differences between the positions or attitudes of the image captured by the drone camera 23 (the keyframe registration determination image) and the newest DB-registered keyframe registered in the keyframe DB 73 immediately before is determined to be within the predefined threshold.

In this case, the keyframe registration flag of the image captured by the drone camera 23 (the keyframe registration determination image) is set to ON. In other words, it is determined that the image is to be registered in the keyframe DB 73.

The processing according to the flow illustrated in FIG. 23 corresponds to performing processing of registering an image in the keyframe DB 73 only when at least one of the differences between the positions or attitudes of the image captured by the drone camera 23 (the keyframe registration determination image) and the newest DB-registered keyframe registered in the keyframe DB 73 immediately before is not within the predefined threshold.

Performing this processing makes it possible to reduce the possibility of registering similar images, captured at similar positions or attitudes, in duplicate in the keyframe DB 73.

### (4-B2-c. (Registration Condition c) Determination Processing Sequence)

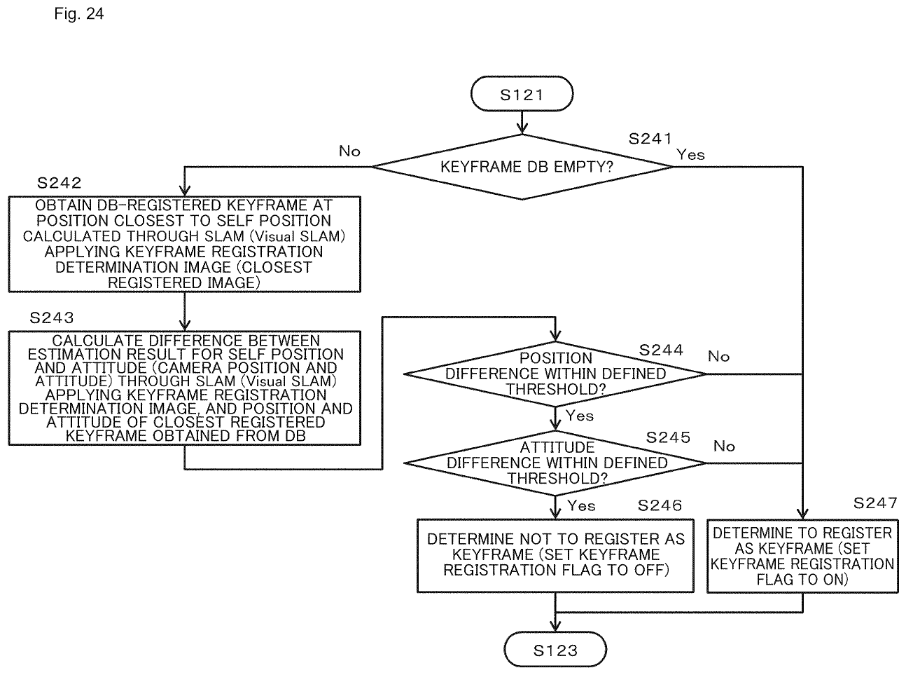

The determination processing sequence for the following (registration condition c) will be described next with reference to the flowchart illustrated in FIG. 24.

(Registration condition c) When a difference between the position and attitude at which the camera captured the keyframe registration determination target image (=the new image captured by the drone 20) and the position and attitude at which the camera captured an image (keyframe), registered in the keyframe DB 73, that is at a position closest to the position at which the keyframe registration determination target image was captured, is confirmed to be at least a defined threshold, the keyframe registration flag is set to ON (register as a keyframe).

The processes of each step in the flow illustrated in FIG. 24, which is a detailed sequence of the determination processing for the registration condition c, will be described in order.

### (Step S241)

First, in step S241, the data processing unit of the drone 20 determines whether the keyframe DB 73 is empty.

If the keyframe DB 73 is empty, i.e., if there is no registration data, the sequence moves to step S247, where the keyframe registration flag of the image captured by the drone camera 23 (the keyframe registration determination image) is set to ON. In other words, the captured image is an image that is registered in the keyframe DB 73.

On the other hand, if the keyframe DB 73 is not empty, i.e., if there is registration data, the sequence moves to step S242.

### (Step S242)

If the keyframe DB 73 is not empty, i.e., if there is registration data, the sequence moves to step S242, where the following processing is performed.

The data, registered in the keyframe DB 73, captured at a position closest to the self position (camera position) calculated through SLAM (Visual SLAM) applying the image captured by the drone camera 23 (the keyframe registration determination image) (that is, the closest registered keyframe) is obtained from the keyframe DB 73.

### (Step S243)

Next, in step S243, the following processing is performed.

A difference between a result of estimating the self position and attitude (the camera position and attitude) by SLAM (Visual SLAM) applying the image captured by the drone camera 23 (the keyframe registration determination image) and the position and attitude of the closest registered keyframe obtained from the keyframe DB 73 in step S242 is calculated.

### (Step S244)

In step S244, it is determined whether the difference between the position of the image captured by the drone camera 23 (the keyframe registration determination image) and the position of the closest registered keyframe obtained from the keyframe DB 73 is within a predefined threshold.

If the difference is determined to be within the predefined threshold, the sequence moves to step S245.

However, if the difference is determined not to be within the predefined threshold, the sequence moves to step S247.

### (Step S245)

In step S245, it is determined whether the difference between the attitude of the image captured by the drone camera 23 (the keyframe registration determination image) and the attitude of the closest registered keyframe obtained from the keyframe DB 73 is within a predefined threshold.

If the difference is determined to be within the predefined threshold, the sequence moves to step S246.

However, if the difference is determined not to be within the predefined threshold, the sequence moves to step S247.

### (Step S246)

Step S246 is processing performed when the differences between the positions and attitudes of the image captured by the drone camera 23 (the keyframe registration determination image) and the closest registered keyframe obtained from the keyframe DB 73 are both determined to be within the predefined thresholds.

In this case, the keyframe registration flag of the image captured by the drone camera 23 (the keyframe registration determination image) is set to OFF. In other words, it is determined that the image is not to be registered in the keyframe DB 73.

### (Step S247)

Step S247 is processing performed when at least one of the differences between the positions or attitudes of the image captured by the drone camera 23 (the keyframe registration determination image) and the closest registered keyframe obtained from the keyframe DB 73 is determined to be within the predefined threshold.

In this case, the keyframe registration flag of the image captured by the drone camera 23 (the keyframe registration determination image) is set to ON. In other words, it is determined that the image is to be registered in the keyframe DB 73.

The processing according to the flow illustrated in FIG. 24 corresponds to performing processing of registering an image in the keyframe DB 73 only when at least one of the differences between the positions or attitudes of the image captured by the drone camera 23 (the keyframe registration determination image) and the closest registered keyframe obtained from the keyframe DB 73 is not within the predefined threshold.

Performing this processing makes it possible to reduce the possibility of registering similar images, captured at positions close to that of the captured image and at similar positions or attitudes, in duplicate in the keyframe DB 73.

### (4-B2-d. (Registration Condition d) Determination Processing Sequence)

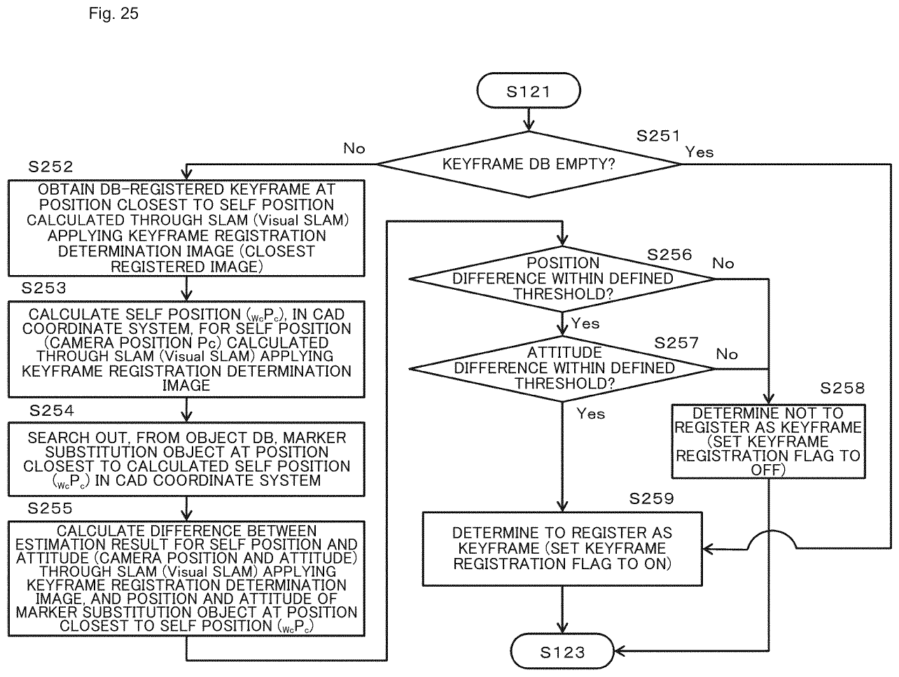

The determination processing sequence for the following (registration condition d) will be described next with reference to the flowchart illustrated in FIG. 25.

(Registration condition d) When a difference between the position and attitude at which the camera captured the keyframe registration determination target image (=the new image captured by the drone 20) and the position and attitude of the “marker substitution object” at a position closest to the position at which the keyframe registration determination target image was captured is confirmed to be no greater than a defined threshold, the keyframe registration flag is set to ON (register as a keyframe).

The processes of each step in the flow illustrated in FIG. 25, which is a detailed sequence of the determination processing for the registration condition d, will be described in order.

### (Step S251)

First, in step S251, the data processing unit of the drone 20 determines whether the keyframe DB 73 is empty.

If the keyframe DB 73 is empty, i.e., if there is no registration data, the sequence moves to step S259, where the keyframe registration flag of the image captured by the drone camera 23 (the keyframe registration determination image) is set to ON. In other words, the captured image is an image that is registered in the keyframe DB 73.

On the other hand, if the keyframe DB 73 is not empty, i.e., if there is registration data, the sequence moves to step S252.

### (Step S252)

If the keyframe DB 73 is not empty, i.e., if there is registration data, the sequence moves to step S252, where the following processing is performed.

The data, registered in the keyframe DB 73, captured at a position closest to the self position (camera position) calculated through SLAM (Visual SLAM) applying the image captured by the drone camera 23 (the keyframe registration determination image) (that is, the closest registered keyframe) is obtained from the keyframe DB 73.

### (Step S253)

Next, in step S253, the following processing is performed.

A self position (_{WC}P_{C}), in the CAD coordinate system, for the self position (a camera position Pc) calculated through SLAM (Visual SLAM) applying the image captured by the drone camera 23 (the keyframe registration determination image), is calculated.

### (Step S254)

Next, in step S254, the following processing is performed.

A marker substitution object at a position closest to the self position (_{WC}P_{C}) in the CAD coordinate system calculated in step S253 (that is, a closest marker substitution object) is searched for and obtained from the object DB 72.

### (Step S255)

Next, in step S255, the following processing is performed.

A difference between a result of estimating the self position and attitude (the camera position and attitude) by SLAM (Visual SLAM) applying the image captured by the drone camera 23 (the keyframe registration determination image) and the position and attitude of the closest marker substitution object obtained from the object DB 72 in step S254 is calculated.

### (Step S256)

In step S256, it is determined whether the difference between the position of the image captured by the drone camera 23 (the keyframe registration determination image) and the position of the closest marker substitution object obtained from the object DB 72 is within a predefined threshold.

If the difference is determined to be within the predefined threshold, the sequence moves to step S257.

However, if the difference is determined not to be within the predefined threshold, the sequence moves to step S258.

### (Step S257)

In step S257, it is determined whether the difference between the attitude of the image captured by the drone camera 23 (the keyframe registration determination image) and the attitude of the closest marker substitution object obtained from the object DB 72 is within a predefined threshold.

If the difference is determined to be within the predefined threshold, the sequence moves to step S259.

However, if the difference is determined not to be within the predefined threshold, the sequence moves to step S258.

### (Step S258)

Step S258 is processing performed when at least one of the differences between the positions or attitudes of the image captured by the drone camera 23 (the keyframe registration determination image) and the closest marker substitution object obtained from the object DB 72 is determined to be within the predefined threshold.

In this case, the keyframe registration flag of the image captured by the drone camera 23 (the keyframe registration determination image) is set to OFF. In other words, it is determined that the image is not to be registered in the keyframe DB 73.

### (Step S259)

Step S259 is processing performed when the differences between the positions or attitudes of the image captured by the drone camera 23 (the keyframe registration determination image) and the closest marker substitution object obtained from the object DB 72 are both determined to be within the predefined thresholds.

In this case, the keyframe registration flag of the image captured by the drone camera 23 (the keyframe registration determination image) is set to ON. In other words, it is determined that the image is to be registered in the keyframe DB 73.

The processing according to the flow illustrated in FIG. 25 corresponds to performing processing of registering an image in the keyframe DB 73 only when both of the differences between the positions or attitudes of the image captured by the drone camera 23 (the keyframe registration determination image) and the closest marker substitution object obtained from the object DB 72 are within the predefined threshold.

Performing such processing makes it possible to register images in the keyframe DB 73 with priority given to images for which the difference between the position or attitude of the image captured by the drone camera 23 (the keyframe registration determination image) and the closest marker substitution object obtained from the object DB 72 is small.

Although determination processing sequences for the four keyframe registration conditions a to d have been described with reference to FIGS. 22 to 25, the four types of determination processing may be executed in parallel or sequentially.

A configuration in which only one of the keyframe registration conditions a to d are applied, or a configuration in which determinations are made for any desired plurality of the registration conditions, may also be used.

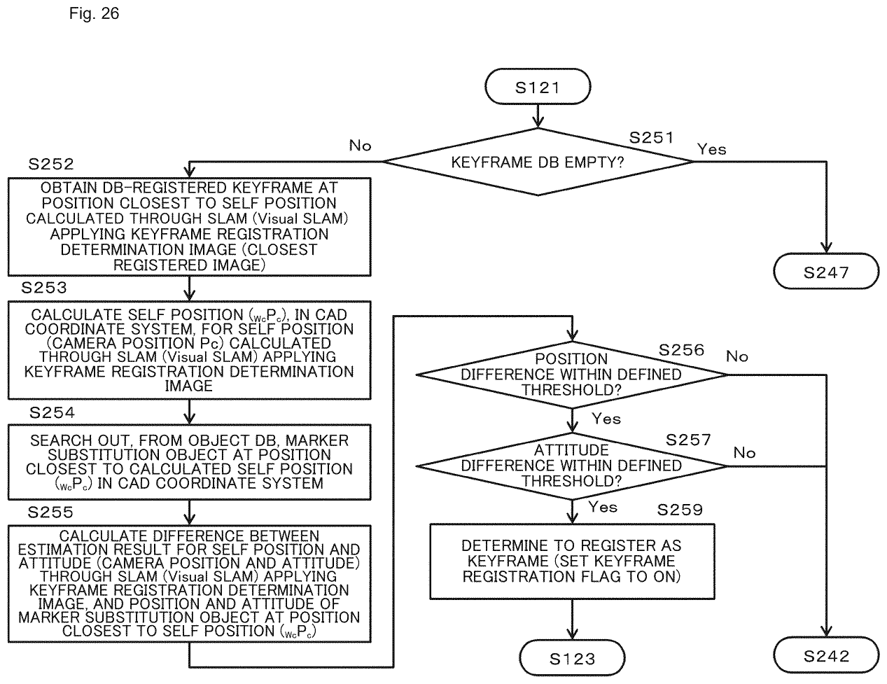

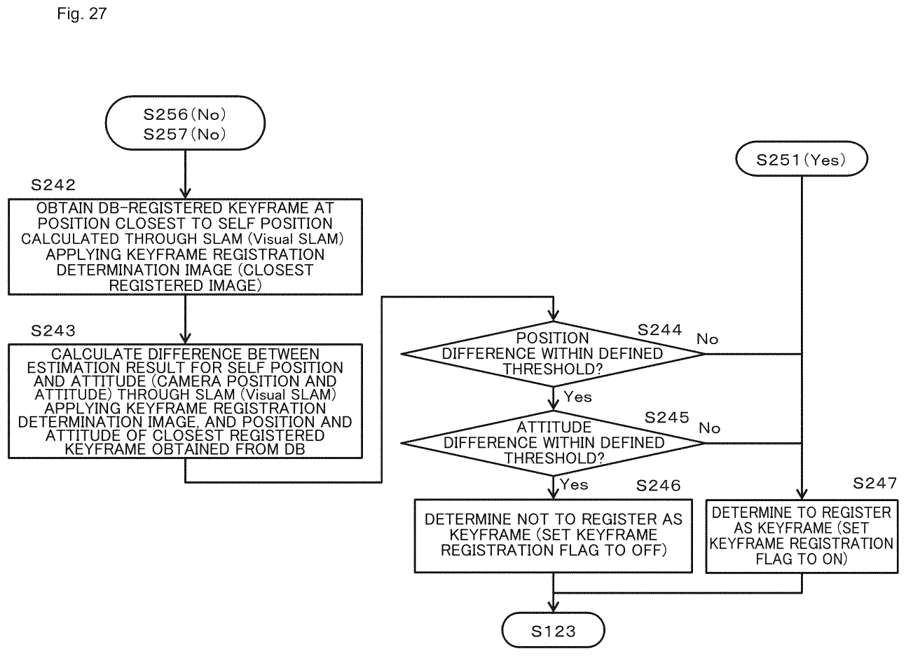

As an example, FIGS. 26 and 27 illustrate a flowchart of a processing sequence in which the determinations for the registration conditions c and d are made sequentially.

The flowcharts in FIGS. 26 and 27 are flowcharts of a processing sequence in which the determinations for the following registration conditions c and d are made sequentially.

(Registration condition c) When a difference between the position and attitude at which the camera captured the keyframe registration determination target image (=the new image captured by the drone 20) and the position and attitude at which the camera captured an image (keyframe), registered in the keyframe DB 73, that is at a position closest to the position at which the keyframe registration determination target image was captured, is confirmed to be at least a defined threshold, the image is registered in the keyframe DB 73.

(Registration condition d) When a difference between the position and attitude at which the camera captured the keyframe registration determination target image (=the new image captured by the drone 20) and the position and attitude of the “marker substitution object” at a position closest to the position at which the keyframe registration determination target image was captured is confirmed to be no greater than a defined threshold, the image is registered in the keyframe DB 73.

Steps S251 to S259 of the flow illustrated in FIG. 26 are the same sequence as the determination sequence (registration condition d) described with reference to FIG. 25.

If a determination of No is made in step S256 or step S257 of the flow indicated in FIG. 26, i.e., at least one of the differences between the positions or attitudes of the image captured by the drone camera 23 (the keyframe registration determination image) and the closest marker substitution object obtained from the object DB 72 is determined to be at least the predefined threshold, the processing of step S242 and on, illustrated in FIG. 27, is performed.

Steps S242 to S247 of the flow illustrated in FIG. 27 are the same sequence as the determination sequence (registration condition c) described with reference to FIG. 24.

By executing the processing according to the flow illustrated in FIGS. 26 and 27, the keyframe registration determination target image (=the new image captured by the drone 20) is registered in the keyframe DB 73 when either of the following registration conditions c and d are met.

That is,

(Registration condition c) when a difference between the position and attitude at which the camera captured the keyframe registration determination target image (=the new image captured by the drone 20) and the position and attitude at which the camera captured an image (keyframe), registered in the keyframe DB 73, that is at a position closest to the position at which the keyframe registration determination target image was captured, is confirmed to be at least a defined threshold, or (Registration condition d) when a difference between the position and attitude at which the camera captured the keyframe registration determination target image (=the new image captured by the drone 20) and the position and attitude of the “marker substitution object” at a position closest to the position at which the keyframe registration determination target image was captured is confirmed to be no greater than a defined threshold, the image is registered in the keyframe DB 73.

The detailed sequence of the processing of step S202 in the flow illustrated in FIG. 19 (Processing 2), i.e., the processing of determining whether to register the image captured by the drone camera 23 as a keyframe in the keyframe DB 73, has been described thus far with reference to FIGS. 22 to 27.

By performing the flow illustrated in FIG. 19 (Processing 2), information related to various keyframes is registered in the keyframe DB 73.

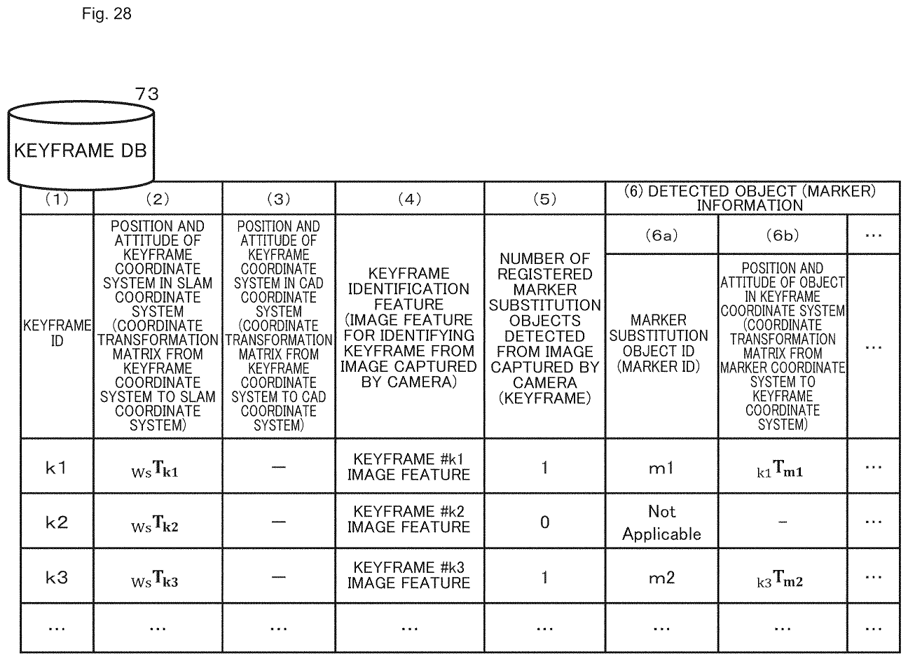

The registration data in the keyframe DB 73 illustrated in FIG. 28 is an example of data registered by executing the flow illustrated in FIG. 19 (Processing 2).

As illustrated in FIG. 28, even if the flow illustrated in FIG. 19 (Processing 2) is executed, the data of (3) in the keyframe DB 73, i.e.,
(3) position and attitude of the keyframe coordinate system in the CAD coordinate system (a coordinate transformation matrix from the keyframe coordinate system to the CAD coordinate system),
is not recorded.

This data (3) is generated in (Processing 3) of step S13 of the overall processing flow described with reference to FIG. 15, and is registered in the keyframe DB 73.

### (4-B3. (Processing 3) Optimization Processing for Minimizing Absolute Position Error of Keyframes Registered in Keyframe DB 73)

Next, (Processing 3) described in step S13 of the flow in FIG. 15 is performed, i.e., (Processing 3) optimization processing for minimizing absolute position error of the keyframes registered in the keyframe DB 73 is performed,
(a) the position and attitude of the keyframe coordinates in the CAD coordinate system are registered in the keyframe DB 73, and
(b) excess keyframes are removed from the registered keyframes in the keyframe DB 73.

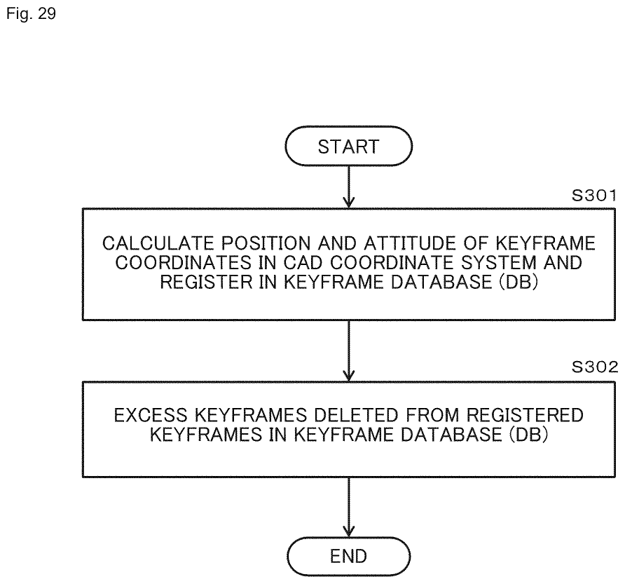

The detailed sequence of this (Processing 3) will be described with reference to the flowchart illustrated in FIG. 29.

The processing of each step in the flow illustrated in FIG. 29 will be described hereinafter in order.

### (Step S301)

First, in step S301, the following processing is performed.

(a) The position and attitude of the keyframe coordinates in the CAD coordinate system are calculated and registered in the keyframe DB 73.

### (Step S302)

Next, in step S302, the following processing is performed.

(b) Excess keyframes are removed from the registered keyframes in the keyframe DB 73.

(Processing 3) described in step S13 of the flow in FIG. 15 is constituted by these two processes.

The two processes will be described in detail hereinafter.

The processing of step S301, i.e., the processing of calculating the position and attitude of the keyframe coordinates in the CAD coordinate system and registering the position and attitude in the keyframe DB 73, will be described first.

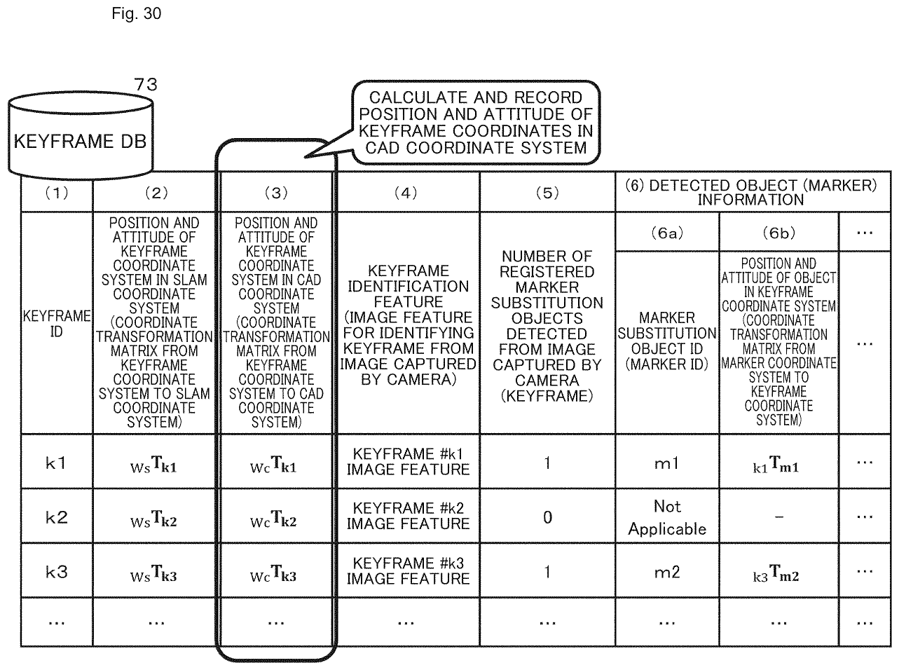

As illustrated in FIG. 30, this processing is processing for the following data registered in the keyframe DB 73, i.e.,
(3) the position and attitude of the keyframe coordinate system in the CAD coordinate system (a coordinate transformation matrix from the keyframe coordinate system to the CAD coordinate system),
and is performed to generate and register this coordinate transformation matrix.

For example, as described earlier with reference to FIG. 8, the coordinate transformation matrix (w_{c}Tₖ₁) illustrated in FIG. 8 is a coordinate transformation matrix for transforming the keyframe #k1 coordinate system (k1) of the “keyframe #k1”, which is an image in which the drone 20 has captured the “marker substitution object #m1=desk”, into the CAD coordinate system (Wc).

By applying this coordinate transformation matrix (w_{c}Tₖ₁) to perform coordinate transformation on coordinates (x, y, z) of a given point P in the keyframe #k1, which is the image captured by the drone camera 23 (=the keyframe #k1 coordinate system), coordinates (x, y, z) of the point P in the CAD coordinate system (Wc) can be calculated.

Processing for generating a coordinate transformation matrix (w_{c}Tₖₓ) corresponding to the keyframe kx differs depending on whether the keyframe is a keyframe in which a marker substitution object has been captured or a keyframe in which a marker substitution object has not been captured.

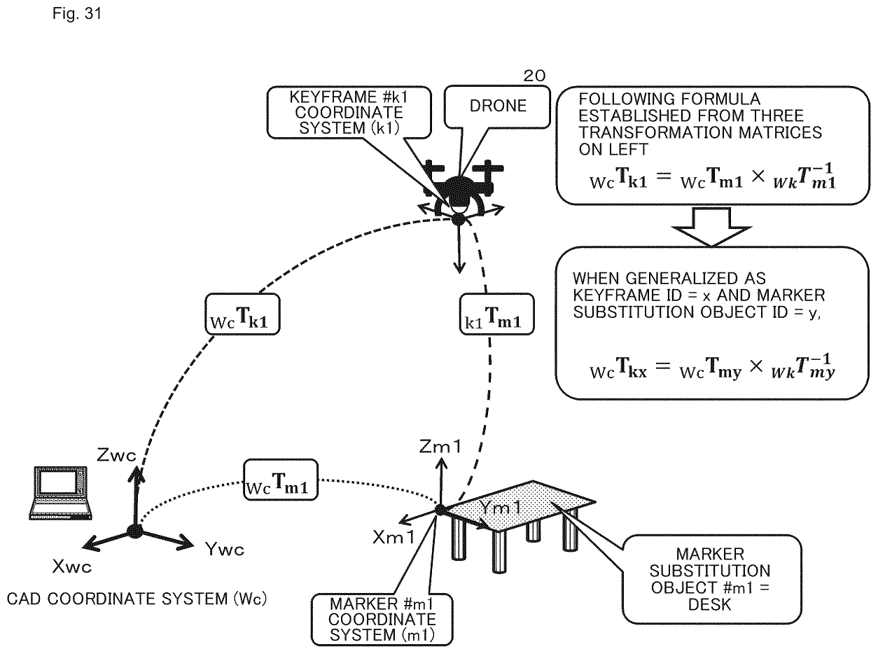

Processing for generating the coordinate transformation matrix (w_{c}Tₖₓ) corresponding to the keyframe kx in which a marker substitution object has been captured will be described first with reference to FIG. 31.

FIG. 31 illustrates a state in which the “keyframe #k1” is captured by the drone 20. The “marker substitution object #m1=desk” is captured in the “keyframe #k1”.

FIG. 31 illustrates the following three coordinate systems.
the CAD coordinate system (Wc);
the keyframe #k1 coordinate system (k1); and
the marker #m1 coordinate system (m1).

FIG. 31 also illustrates three coordinate transformation matrices (w_{c}Tₖ₁), (w_{c}Tₘ₁), and (ₖ₁Tₘ₁).

The coordinate transformation matrix (w_{c}Tₖ₁) is a coordinate transformation matrix for transforming the keyframe #k1 coordinate system (k1) of the “keyframe #k1” into the CAD coordinate system (Wc).

The coordinate transformation matrix (w_{c}Tₘ₁) is a coordinate transformation matrix for transforming the marker #m1 coordinate system (m1) of the “marker substitution object #m1=desk” into the CAD coordinate system (Wc).

The coordinate transformation matrix (ₖ₁Tₘ₁) is a coordinate transformation matrix for transforming the marker #m1 coordinate system (m1) of the “marker substitution object #m1=desk” into the keyframe #k1 coordinate system (k1) of the “keyframe #k1”.

The following relational expression is established for these three coordinate transformation matrices.

$${}_{Wc} {T}_{K 1} = {}_{Wc} {T}_{m 1} \times {}_{k 1} {T}_{m 1}^{- 1}$$

Note that ₖ₁Tₘ₁⁻¹ is the inverse matrix of ₖ₁Tₘ₁.

By taking the above relational expression, and using the following, i.e., the keyframe #kx coordinate system (kx) of the “keyframe #kx”, and a marker #my coordinate system (my) of a “marker substitution object #my”, to create a generalized relational expression, the following (Relational expression a) can be obtained:

$${}_{Wc} {T}_{kx} = {}_{Wc} {T}_{my} \times {}_{kx} {T}_{my}^{- 1} \qquad ( Relational expression a )$$

In this manner, the coordinate transformation matrix (w_{c}Tₖₓ), i.e., the coordinate transformation matrix (w_{c}Tₖₓ) for transforming the keyframe #kx coordinate system (kx) of the “keyframe #kx” into the CAD coordinate system (Wc), can be calculated using the coordinate transformation matrix (w_{c}T_{my}) for transforming the marker #my coordinate system (my) into the CAD coordinate system (Wc) and the coordinate transformation matrix (ₖₓT_{my}) for transforming the marker #my coordinate system (my) into the keyframe #kx coordinate system (kx).

The processing for generating the coordinate transformation matrix (w_{c}Tₖₓ) corresponding to the keyframe kx in which a marker substitution object has been captured is a calculation performed using the foregoing (Relational expression a).

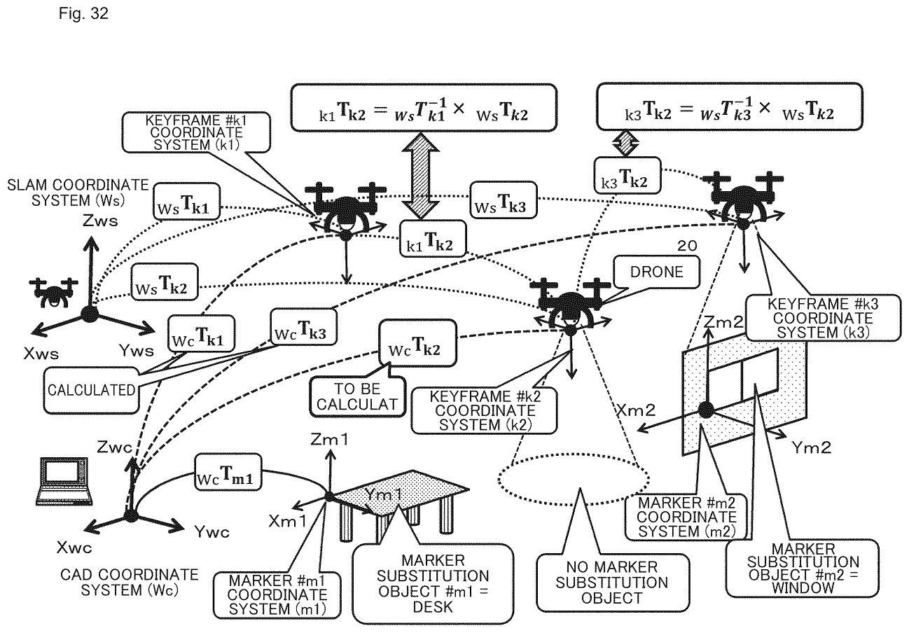

However, as described above, the keyframes registered in the keyframe DB 73 also include keyframes in which a marker substitution object has not been captured. Processing for generating the coordinate transformation matrix (w_{c}Tₖₓ) corresponding to a keyframe in which a marker substitution object has not been captured will be described next with reference to FIG. 32.

FIG. 32 illustrates a state in which the “keyframes #k1 to #k3” are captured by the drone 20.

The “marker substitution object #m1=desk” is captured in the “keyframe #k1”.

No “marker substitution object” is captured in the “keyframe #k2”.

The “marker substitution object #m3=window” is captured in the “keyframe #k3”.

The coordinate transformation matrices among the keyframes will be considered next.

The coordinate transformation matrix (ₖ₁Tₖ₂) for transforming the keyframe #k2 coordinate system (k2) of the “keyframe #k2” into the keyframe #k1 coordinate system (k1) of the “keyframe #k1” can be calculated by the following (Relational expression b1).

$${}_{k 1} {T}_{k 2} = {}_{Ws} {T}_{k 1}^{- 1} \times {}_{ws} {T}_{k 2} \qquad ( Relational expression b 1 )$$

Note that _{ws}Tₖ₁⁻¹ is an inverse matrix of _{ws}Tₖ₁.

The coordinate transformation matrix (_{ws}Tₖ₁) is a coordinate transformation matrix for transforming the keyframe #k1 coordinate system (k1) of the “keyframe #k1” into the SLAM coordinate system (Ws).

The coordinate transformation matrix (_{ws}Tₖ₂) is a coordinate transformation matrix for transforming the “keyframe #k2 coordinate system (k2)” of the “keyframe #k2” into the SLAM coordinate system (Ws).

Additionally, the coordinate transformation matrix (ₖ₃Tₖ₂) for transforming the keyframe #k2 coordinate system (k2) of the “keyframe #k2” into the keyframe #k3 coordinate system (k3) of the “keyframe #k3” can be calculated by the following (Relational expression b2).

$${}_{k 3} {T}_{k 2} = {}_{Ws} {T}_{k 3}^{- 1} \times {}_{ws} {T}_{k 2} \qquad ( Relational expression b 2 )$$

Note that _{ws}Tₖ₃⁻¹ is an inverse matrix of _{ws}Tₖ₃.

The coordinate transformation matrix (_{ws}Tₖ₃) is a coordinate transformation matrix for transforming the “keyframe #k3 coordinate system (k3)” of the “keyframe #k3” into the SLAM coordinate system (Ws).

The coordinate transformation matrix (_{ws}Tₖ₂) is a coordinate transformation matrix for transforming the “keyframe #k2 coordinate system (k2)” of the “keyframe #k2” into the SLAM coordinate system (Ws).

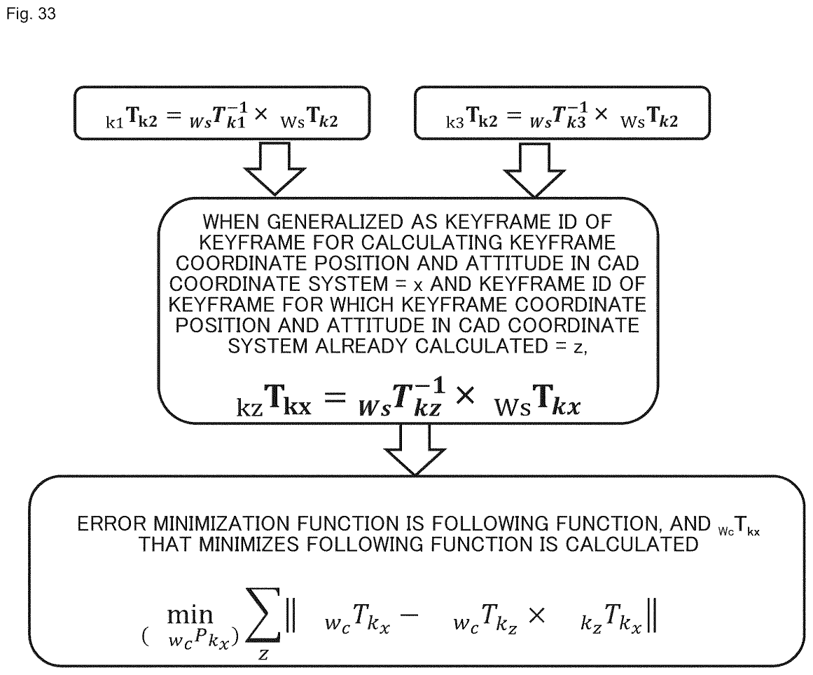

As illustrated in FIG. 33, taking the above relational expressions b1 and b2, and using
the keyframe #kx coordinate system (kx) of the “keyframe #kx”, and
a keyframe #kz coordinate system (kz) of the “keyframe #kz”,
to create a generalized relational expression, the following (Relational expression b) can be obtained:

$${}_{k z} {T}_{k x} = {}_{Ws} {T}_{k z}^{- 1} \times {}_{ws} {T}_{k x} \qquad ( Relational expression b )$$

The error minimization function indicated the following (Formula 3) is solved for this (Relational expression b).

$$\begin{matrix}[ Math . 2 ] & \\ {min}_{( {}_{{w}_{c}} {P}_{{k}_{x}} )} {\sum }_{z} ‖ {}_{{w}_{c}} {T}_{{k}_{x}} - {}_{{w}_{c}} {T}_{{k}_{z}} \times {}_{{k}_{z}} {T}_{{k}_{x}} ‖ & ( Formula 3 )\end{matrix}$$

By solving the error minimization function indicated in the above (Formula 3), the coordinate transformation matrix (w_{c}Tₖₓ) of the keyframe in which the marker substitution object has not been captured, i.e., the coordinate transformation matrix (w_{c}Tₖₓ) for transforming the keyframe #kx coordinate system (kx) of the “keyframe #kx” into the CAD coordinate system (Wc), is calculated.

In this manner, the processing for generating the coordinate transformation matrix (w_{c}Tₖₓ) corresponding to the keyframe kx in which a marker substitution object has not been captured is a calculation performed using the foregoing (Relational expression b) and (Formula 3).

In this manner, in step S301 of the flow illustrated in FIG. 29, the coordinate transformation matrix (w_{c}Tₖₓ) corresponding to the keyframe kx in which a marker substitution object has been captured, and the coordinate transformation matrix (w_{c}Tₖₓ) corresponding to the keyframe kx in which a marker substitution object has not been captured, are calculated through different types of processing, and processing is performed to register the calculated coordinate transformation matrix (w_{c}Tₖₓ) in the keyframe DB 73.

A reason for registering a keyframe in which a marker substitution object has not been captured in the keyframe DB 73 will be described here.

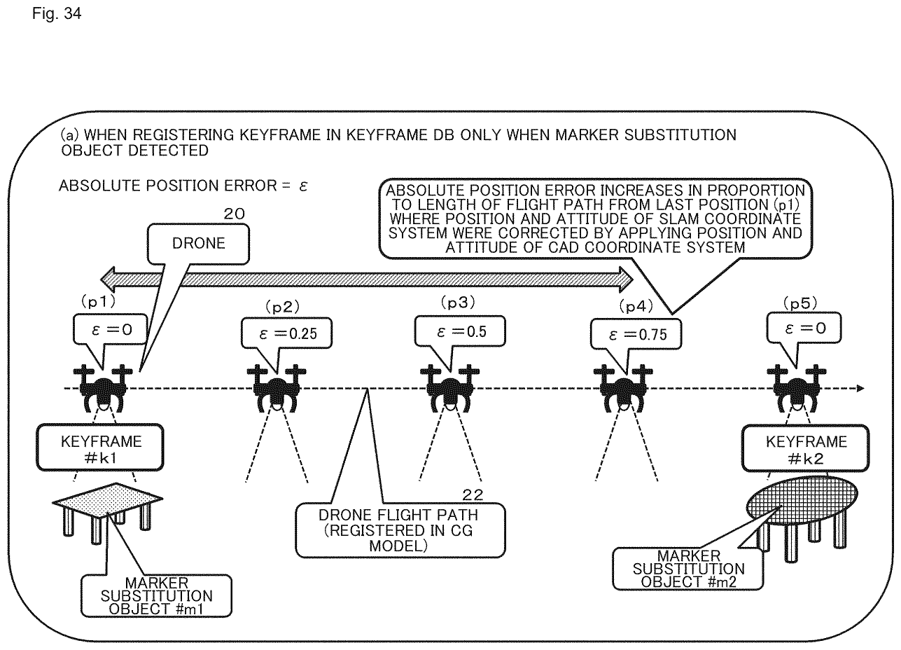

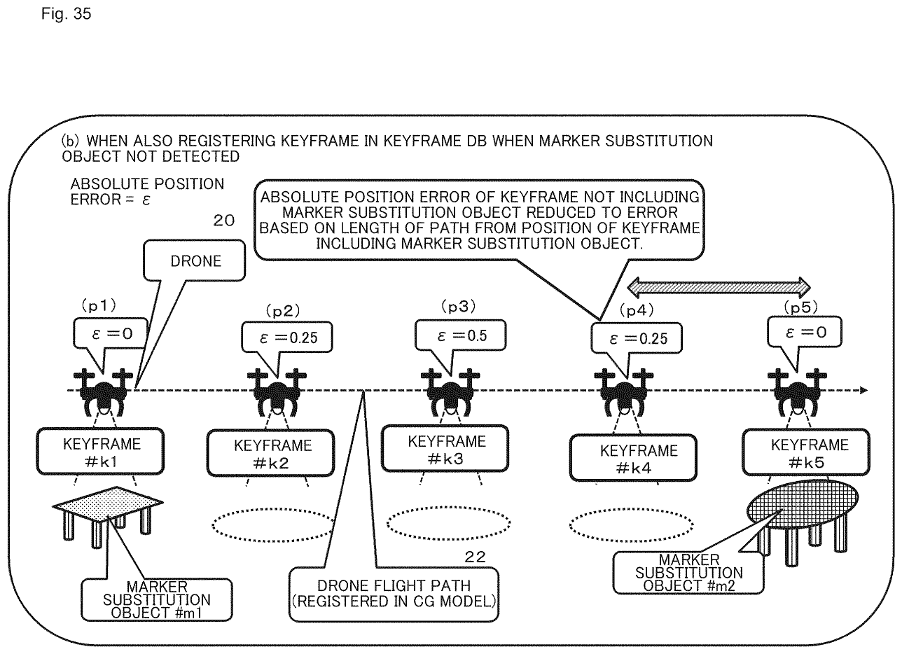

FIGS. 34 and 35 are diagrams illustrating an example of a reason for registering a keyframe in which a marker substitution object has not been captured in the keyframe DB 73.

In FIG. 34, the drone 20 flies in order from positions (p1) to (p5) according to the predefined drone flight path 22. However, because the drone 20 files while estimating its self position and attitude through SLAM processing, there are situations where the drone 20 deviates from the drone flight path 22.

The example illustrated in FIG. 34 is a diagram illustrating an example of flight control performed when registering only keyframes in which a marker substitution object has been captured in the keyframe DB 73.

The positions (p1) and (p5) of the drone 20 are positions at which a marker substitution object can be captured, and at these positions (p1) and (p5), the self position calculated through SLAM processing with reference to the keyframe information registered in the keyframe DB 73 can be corrected on the basis of the keyframe position registered in the CAD coordinates.

However, at positions (p2), (p3), and (p4), the keyframes at those positions are not registered in the keyframe DB 73, and thus the self position calculated through SLAM processing cannot be corrected on the basis of the keyframe position registered in the CAD coordinates.

As a result, at positions (p2), (p3), and (p4), absolute position error increases in proportion to the length of the flight path from the position (p1) at which the position and attitude of the SLAM coordinate system were corrected by applying the position and attitude of the CAD coordinate system last registered in the keyframe DB 73.

For example, as illustrated in the figure, when absolute position error & at the position (p1) at which the position and attitude of the SLAM coordinate system registered in the keyframe DB 73 were corrected is set to ε=0,
the absolute position error & increases as follows at the positions (p2) to (p4) where the position and attitude cannot be corrected with reference to the keyframes registered in the keyframe DB 73.
Absolute position error ε at position (p2)=0.25,
Absolute position error ε at position (p3)=0.5, and
Absolute position error ε at position (p4)=0.75.

In this manner, at positions (p2), (p3), and (p4), absolute position error increases in proportion to the length of the flight path from the position (p1) at which the position and attitude of the SLAM coordinate system were corrected by applying the position and attitude of the CAD coordinate system last registered in the keyframe DB 73.

An example of flight control performed when registering a keyframe in which a marker substitution object has not been captured in the keyframe DB 73 will be described next with reference to FIG. 35.

The positions (p1) and (p5) of the drone 20 are positions at which a marker substitution object can be captured, and the positions (p2), (p3), and (p4) are positions at which a marker substitution object cannot be captured.

In this example, keyframe information is registered in the keyframe DB 73 at all of these positions (p1) to (p5).

However, the keyframe information corresponding to the positions (p2), (p3), and (p4) registered in the keyframe DB 73 does not include the marker substitution objects captured in the keyframes.

The keyframe information registered in correspondence with the positions (p2), (p3), and (p4) is only the following data:
(1) Keyframe ID;
(2) Position and attitude of the keyframe coordinate system in the SLAM coordinate system (a coordinate transformation matrix from the keyframe coordinate system to the SLAM coordinate system);
(3) Position and attitude of the keyframe coordinate system in the CAD coordinate system (a coordinate transformation matrix from the keyframe coordinate system to the CAD coordinate system); and
(4) Keyframe identification feature (an image feature for identifying the keyframe from the image captured by the camera).

However, referring to this information and further obtaining the keyframe information of an adjacent position from the keyframe DB 73 and referring to that information, the self position calculated through SLAM processing can be corrected on the basis of the keyframe position registered in the CAD coordinates.

For example, at the position (p4) indicated in FIG. 35, the keyframe corresponding to the closest (p5) from (p4) can be obtained from the keyframe DB 73, and based on this information, the self position calculated through SLAM processing can be corrected using the keyframe position of the CAD coordinates recorded in the keyframe DB 73.

In this manner, absolute position error of a keyframe that does not include a marker substitution object can be reduced to error based on the length of the path from the position of a keyframe that includes a marker substitution object.

Position information (a CAD coordinate system position) of the DB-registered keyframe corresponding to the current position of the drone 20 is required to search the keyframe DB 73 and obtain the keyframe at the position closest to the current position of the drone 20.

For keyframes that do not include a marker substitution object too, the keyframe position of the CAD coordinate system is registered in the keyframe DB 73, and this registered information can be used to search the keyframe DB 73 and obtain keyframe information at the position closest to the current position of the drone 20 (marker substitution object-registered keyframe information).

As a result, the self position calculated through SLAM processing can be corrected using the marker substitution object-registered keyframe information at the position closest to the current position of the drone 20, and the drone 20 can be flown with a reduced amount of deviation from the prescribed drone flight path 22.

The processing of step S302 in the flow illustrated in FIG. 29, i.e., processing for removing excess keyframes from the registered keyframes in the keyframe DB 73, will be described next.

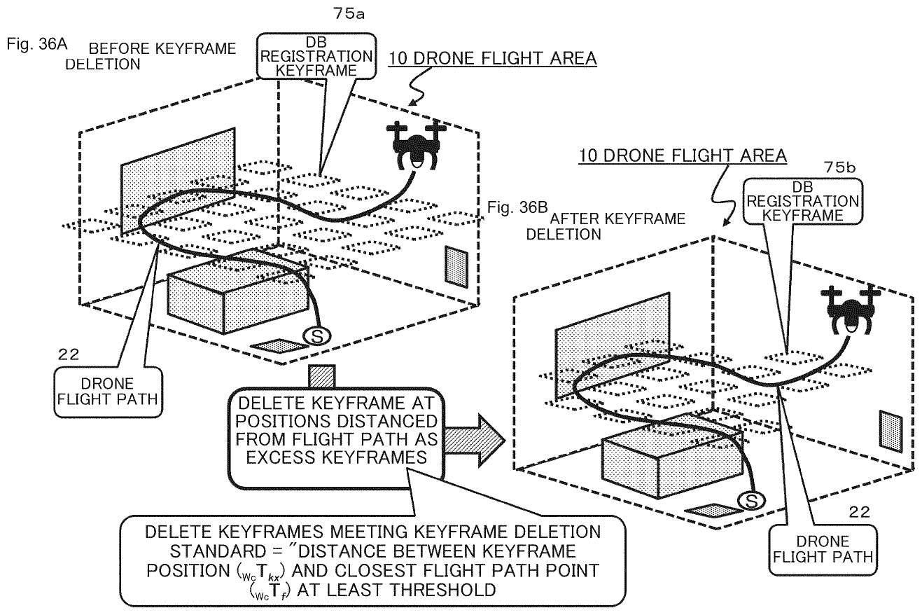

A specific example of the processing for removing excess keyframes from the registered keyframes in the keyframe DB 73 will be described with reference to FIG. 36.

FIG. 36 illustrates the following two diagrams.
(a) Before keyframe deletion
(b) After keyframe deletion

DB-registered keyframes 75a, represented as a plurality of dotted line rectangles in the figure “(a) before keyframe deletion”, are keyframes registered in the keyframe DB 73.

These are keyframes registered in the keyframe DB 73 according to (Processing 2) of step S12 of the flow in FIG. 15, i.e., the flowchart illustrated in FIG. 19 described earlier.

The drone flight path 22 illustrated in the figure “(a) before keyframe deletion” is a flight path registered in the drone flight path registration CG model 71 according to (Processing 1) of step S11 of the flow in FIG. 15, i.e., the flowchart illustrated in FIG. 16 described earlier.

The drone 20 ultimately flies autonomously according to this drone flight path 22 in (Processing 4) of step S14 of the flow in FIG. 15.

As can be seen from the figure “(a) before keyframe deletion”, the DB-registered keyframes 75a, represented as a plurality of dotted line rectangles, are arranged without gaps so as to completely cover the interior of the drone flight area 10. This is the result of registering an image captured by the drone camera 23 in the keyframe DB 73 while flying the drone 20 according to the keyframe registration flight path 25 as illustrated in FIG. 20, in the processing of step S201 of the flow illustrated in FIG. 19 described earlier.

However, as illustrated in FIG. 36(a), many of the DB-registered keyframes 75a are distanced from the drone flight path 22, and are therefore unnecessary data not used when the drone 20 is caused to fly autonomously according to the drone flight path 22.

Step S302 of the flow illustrated in FIG. 29 is processing for deleting such unnecessary data (=excess keyframes) from the keyframe DB 73.

The processing for deleting excess keyframes is performed as deletion processing in which the following determination standard is applied, for example.

“When the distance between the position of the keyframe #kx in the CAD coordinate system (w_{c}Tₖₓ) and the position closest to the drone flight path (f) 22 (w_{c}T_{f}) is at least a predefined threshold, that keyframe is taken as an excess keyframe and deleted.”

The result of deleting excess keyframes according to such an excess keyframe determination standard is, for example, the result in (b) after keyframe deletion, indicated in FIG. 36.

In “(b) after keyframe deletion” in FIG. 36, the keyframes at positions distanced from the drone flight path 22 are deleted.

Performing the excess keyframe deletion processing in this manner makes it possible to reduce the record data in the keyframe DB 73.

A further effect of reducing the load of computations performed by the drone 20 when flying autonomously according to the drone flight path 22 in (Processing 4) of step S14 of the flow illustrated in FIG. 15 is also achieved.

Note that the excess keyframe deletion processing optional processing as opposed to required processing, and may therefore be omitted.

(4-B4. (Processing 4) Processing for Performing Autonomous Flight in Accordance with Prescribed Flight Path (Referring to Post-Optimization Processing Keyframe DB, and Performing Autonomous Flight While Correcting Self Position Estimated in SLAM Coordinate System Based on Self Position in CAD Coordinate System))

Next, (Processing 4) described in step S13 of the flow in FIG. 15 is performed, i.e., (Processing 4) processing for performing autonomous flight in accordance with the prescribed flight path (referring to a post-optimization processing keyframe DB, and performing autonomous flight while correcting the self position estimated in the SLAM coordinate system based on the self position in the CAD coordinate system), will be described.

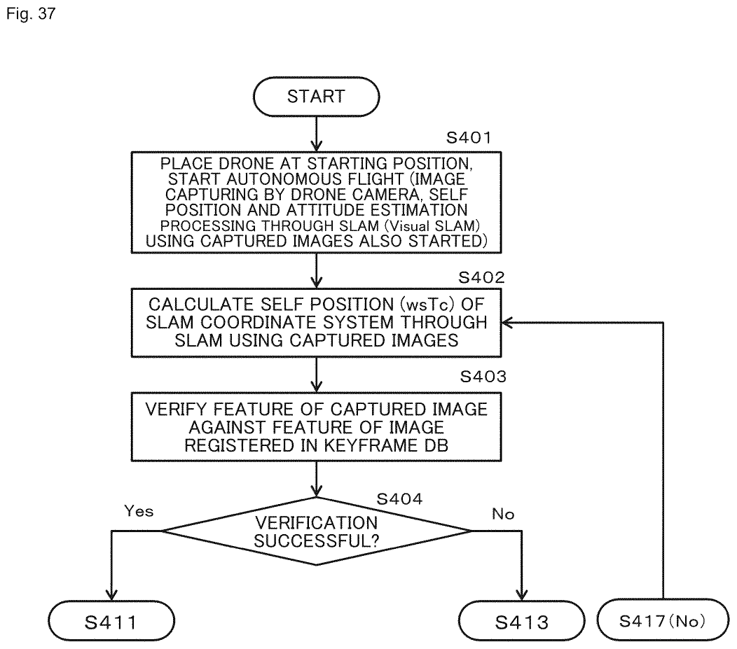

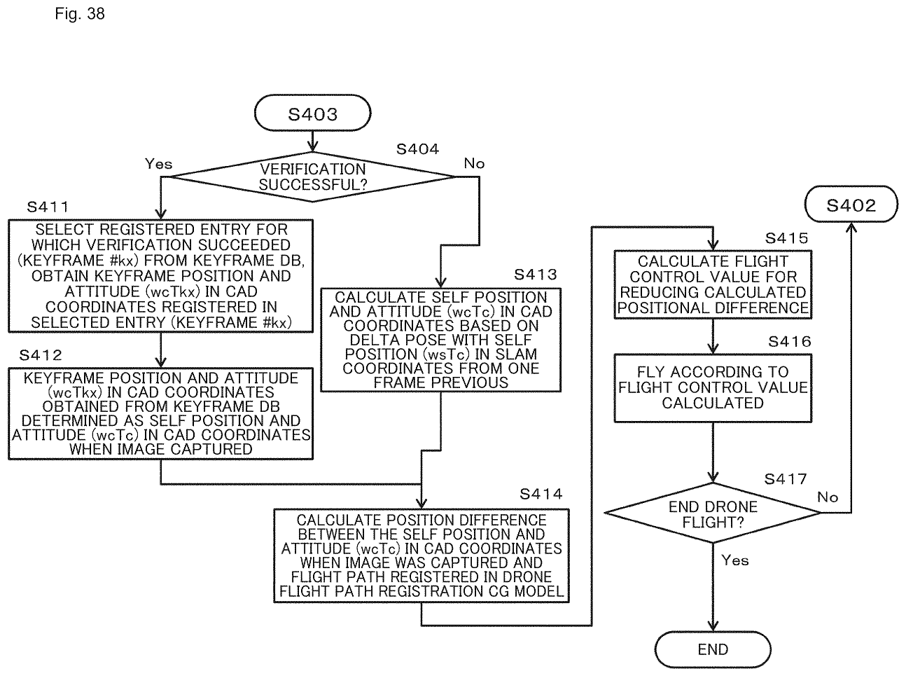

The detailed sequence of this (Processing 4) will be described with reference to the flowcharts illustrated in FIGS. 37 and 38.

The processing of each step in the flow illustrated in FIGS. 37 and 38 will be described hereinafter in order.

Note that the processing of each step in the flow illustrated in FIGS. 37 and 38 is performed by the data processing unit (=mobile body control device) in the drone 20.

### (Step S401)

First, in step S401, the following processing is performed.

The drone 20 is placed at a starting position, and autonomous flight is started. Image capturing by the drone camera 23, and the self position and attitude estimation processing through SLAM (Visual SLAM) using the captured images, is also started.

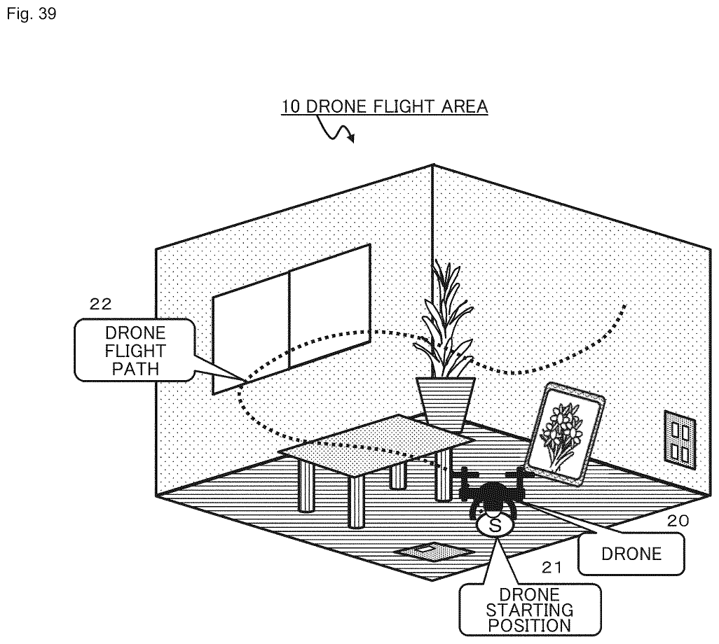

A specific example of the processing of step S401 will be described with reference to FIG. 39.

As illustrated in FIG. 39, the drone 20 is placed at the starting position 21, and is caused to start flying autonomously according to the prescribed drone flight path 22.

This starting position 21, and the drone flight path 22, are a starting position and a flight path registered in the drone flight path registration CG model 71 according to (Processing 1) of step S11 of the flow in FIG. 15, i.e., the flowchart illustrated in FIG. 16 described earlier.

### (Step S402)

Next, in step S402, the following processing is performed.

A self position (wsTc) of the SLAM coordinate system is calculated through SLAM (Visual SLAM) using the images captured by the drone camera 23.

### (Step S403)

Next, in step S403, the following processing is performed.

Processing of verifying a feature of the image captured by the drone camera 23 against the features of the images registered in the keyframe DB 73 is performed.

The feature of the image in the keyframe DB 73 to be compared here the registration data (4) described earlier with reference to FIG. 12, i.e., the keyframe identification feature, namely:
(4) Keyframe identification feature (an image feature for identifying the keyframe from the image captured by the camera).

### (Step S404)

Step S404 is a branching step based on the result of verifying the image features in step S403.

If the verification between the feature of the image captured by the drone camera 23 and the features of the images registered in the keyframe DB 73 is successful, i.e., if a keyframe for which a keyframe identification feature identical or similar to the feature of the image captured by the drone camera 23 is registered has been detected from the keyframe DB 73, the sequence moves to step S411.

If not detected, however, the sequence moves to step S413.

### (Step S411)

If, in steps S402 to S403, the verification between the feature of the image captured by the drone camera 23 and the features of the images registered in the keyframe DB 73 is successful, i.e., if a keyframe for which a keyframe identification feature identical or similar to the feature of the image captured by the drone camera 23 is registered is detected from the keyframe DB 73, the following processing is performed in step S411.

In step S411, a DB registration entry determined to be identical or similar to the feature of the image captured by the drone camera 23 and verified as a match (the keyframe #kx) is obtained from the keyframe DB 73, and the position and attitude (wcTkx) of the keyframe #kx in the CAD coordinates recorded in the obtained entry (the keyframe #kx) are obtained.

### (Step S412)

Next, in step S412, the following processing is performed.

The keyframe position and attitude (wcTkx) in the CAD coordinates obtained from the keyframe DB 73 are determined as the self position and attitude (wcTc) of the drone 20 (the drone camera 23) in the CAD coordinates when the image was captured by the drone camera 23 of the drone 20.

### (Step S413)

On the other hand, if, in steps S402 to S403, the verification between the feature of the image captured by the drone camera 23 and the features of the images registered in the keyframe DB 73 is not successful, i.e., if a keyframe for which a keyframe identification feature identical or similar to the feature of the image captured by the drone camera 23 is registered is not detected from the keyframe DB 73, the following processing is performed in step S413.

On the basis of the self position (wsTc) in the SLAM coordinates calculated through the SLAM processing based on the captured image one frame before the captured image for which the verification determination was made in step S402, the self position and attitude (wcTc) in the CAD coordinates of the drone 20 (the drone camera 23) when the captured image, for which the verification determination was made, was captured, is estimated. For example, position estimation processing using an existing delta pose estimation algorithm is performed to estimate the current self position and attitude (wcTc) in the CAD coordinates of the drone 20.

### (Step S414)

After the processing of step S412 or step S413 is completed, the following processing is performed in step S414.

A difference between the self position and attitude (wcTc) in the CAD coordinates, calculated in step S412 or step S413, i.e., the self position and attitude (wcTc) in the CAD coordinates when the image was captured by the drone camera 23 of the drone 20, and the position of the flight path (the drone flight path 22) registered in the drone flight path registration CG model 71, is calculated.

### (Step S415)

Next, in step S415, the following processing is performed.

A flight control value for reducing the positional difference calculated in step S414 is calculated.

### (Step S416)

Next, in step S416, the following processing is performed.

The flight is controlled according to the flight control value calculated in step S415.

This flight control is flight control for reducing the positional difference calculated in step S414, and is flight control for reducing the positional difference between the self position and attitude (wcTc) in the CAD coordinates when the image was captured by the drone camera 23 of the drone 20 and the flight path (the drone flight path 22) registered in the drone flight path registration CG model 71.

In other words, this is flight control for returning the drone 20 to the flight path (the drone flight path 22) registered in the drone flight path registration CG model 71.

### (Step S417)

Finally, in step S417, whether the flight processing according to the drone flight path 22 of the drone 20 has ended is determined, and if not, the sequence returns to step S402, and the flight processing according to the drone flight path 22 is continued.

If the flight processing according to the drone flight path 22 of the drone 20 is determined to have ended, the sequence ends.

By performing the processing according to the flow illustrated in FIGS. 37 to 38, the drone 20 can fly autonomously according to the predefined drone flight path 22. In other words, using the registration information in the keyframe DB 73 makes it possible to fly autonomously according to the predefined drone flight path 22.

Specifically, the processing of steps S411 to S412 is processing of calculating the self position and attitude (wcTc) of the drone 20 (the drone camera 23) using the registration information in the keyframe DB 73.

In step S411, a DB registration entry determined to be identical or similar to the feature of the image captured by the drone camera 23 and verified as a match (the keyframe #kx) is obtained from the keyframe DB 73, and the position and attitude (wcTkx) of the keyframe #kx in the CAD coordinates recorded in the obtained entry (the keyframe #kx) are obtained.

Furthermore, in step S412, the keyframe position and attitude (wcTkx) in the CAD coordinates obtained from the keyframe DB 73 are taken as the self position and attitude (wcTc) of the drone 20 (the drone camera 23) in the CAD coordinates when the image was captured by the drone camera 23 of the drone 20.

Through these processes, the self position and attitude (wcTc) of the drone 20 (the drone camera 23) in the CAD coordinates at the timing when the drone 20 captured the image using the drone camera 23 can be obtained.

In step S414 and on, by calculating the difference (deviation) between the obtained self position and attitude (wcTc) of the drone 20 (the drone camera 23) and the drone flight path 22 registered in the drone flight path registration CG model 71, and controlling the flight to eliminate that difference (deviation), the drone 20 can fly along the drone flight path 22.

### 5. Embodiment Using Real Markers (Second Embodiment)

An embodiment in which real markers (image identification markers) are used will be described next as a second embodiment.

In the foregoing embodiment (Embodiment 1), objects such as desks, windows, or outlets in the drone flight area 10 are used as markers (image identification markers). In other words, desks, windows, and the like in the drone flight area 10 were used as marker substitution objects.

Instead of such marker substitution objects, real markers (image identification markers) can be set in the drone flight area 10, and processing similar to that of the first embodiment can be performed using those real markers.

An embodiment in which real markers are used will be described next as the second embodiment.

FIG. 39 is a diagram illustrating the drone flight area 10 similar to that of the first embodiment described earlier. For example, the drone flight area 10 is a room in a building, and is an area where GPS position information cannot be received.

The drone starting position 21 and the drone flight path 22 indicated in FIG. 39 are defined in advance, in the same manner as in the first embodiment described earlier.

In the present second embodiment, a drone flight area CG model including the drone starting position 21, the drone flight path 22, and the like is first generated, and markers are also recorded in this model.

The same markers as the markers recorded in the CG model are then affixed to the floor or the like in the actual drone flight area 10.

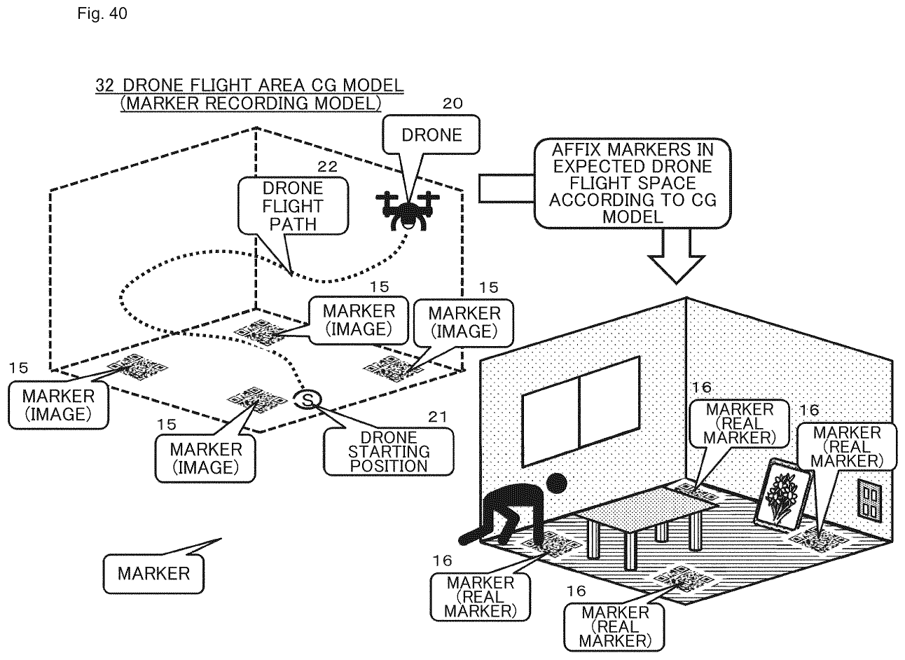

A specific example of this processing will be described with reference to FIG. 40. The drone flight area CG model (marker recording model) 32 is illustrated in the upper-left part of FIG. 40.

This CG model is generated using an information processing device such as a PC, for example.

The drone flight area CG model (marker recording model) 32 is a three-dimensional model representing a three-dimensional space of the drone flight area 10 illustrated in FIG. 39.

Like the first embodiment described earlier, the drone starting position 21, the drone flight path 22, and the like are also recorded in the drone flight area CG model (marker recording model) 32.

Furthermore, in the present embodiment, image identification markers (images) 15 are recorded in the CG model.

For example, a plurality of markers (images) 15 are distributed throughout the floor or the like in the drone flight area 10, and are recorded.

After the drone flight area CG model (marker recording model) 32 is generated, as indicated in the lower-right part of FIG. 40, actual image identification markers (real markers) 16 are affixed at positions corresponding to the marker recording positions in the CG model, such as on the floor in the drone flight area 10.

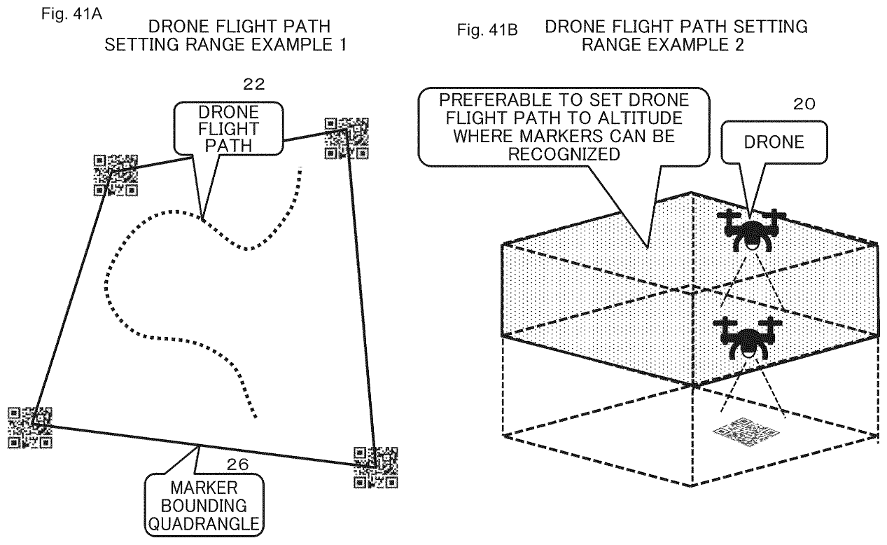

Note that the positions where the image identification markers (real markers) 16 are set are preferably positions at which the drone flight path 22 of the drone 20 fits within the markers, as illustrated in FIG. 41 (A), for example.

In other words, a configuration is preferable in which the markers are set at positions at which the drone flight path 22 falls within a marker bounding quadrangle 26 formed by connecting the plurality of markers.

As illustrated in FIG. 41 (b), the drone flight path 22 is preferably set to an altitude range at which the markers affixed to the floor or the like can be identified, for example.

The processing in the present second embodiment is almost the same as that of the first embodiment described earlier, which uses marker substitution objects. In the present second embodiment, real markers are used instead of the marker substitution objects of the first embodiment.

In the present second embodiment, the following five coordinate systems are used.
(1) the SLAM coordinate system (Ws)
(2) the camera coordinate system (C)
(3) the CAD coordinate system (Wc)
(4) the keyframe coordinate system (kx)
(5) the marker coordinate system (mx)

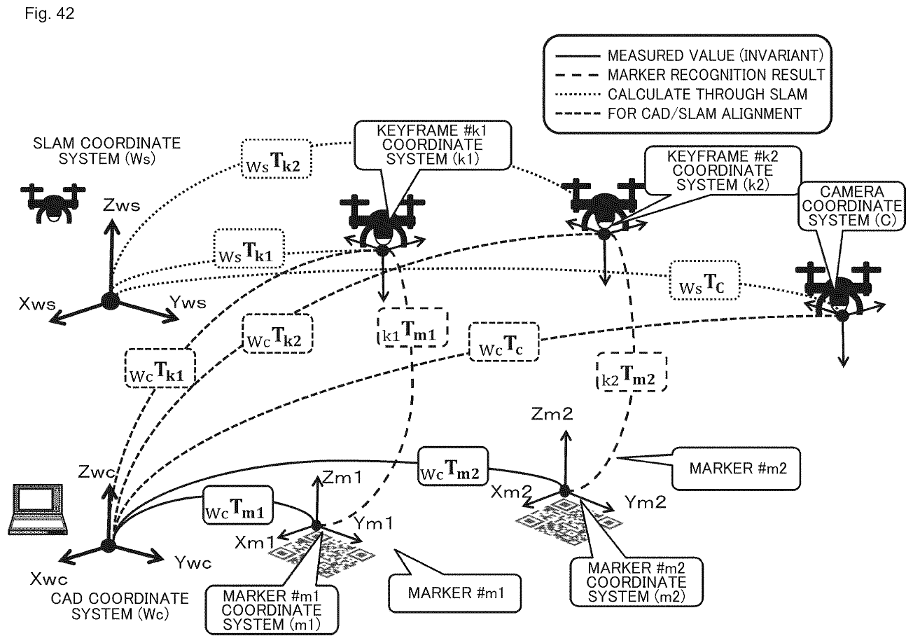

The relationships between these coordinate systems, and specific examples of coordinate transformation matrices, will be described with reference to FIG. 42.

FIG. 42 illustrates the five types of coordinate systems described above, and coordinate transformation matrices between the coordinate systems.

For example,
the coordinate transformation matrix (w_{c}Tₘ₁) is a coordinate transformation matrix for transforming the marker #m1 coordinate system (m1) of the “marker #m1” into the CAD coordinate system (Wc), and
the coordinate transformation matrix (w_{c}Tₘ₂) is a coordinate transformation matrix for transforming the marker #m2 coordinate system (m2) of the “marker #m2” into the CAD coordinate system (Wc).

The markers are affixed within the drone flight area, and these coordinate transformation matrices (w_{c}Tₘ₁) and (w_{c}Tₘ₂) are invariant transformation matrices determined when the CG model is generated through CAD.

The coordinate transformation matrix (w_{c}Tₖ₁) is a coordinate transformation matrix for transforming the “keyframe #k1 coordinate system (k1)” into the CAD coordinate system (Wc).

The coordinate transformation matrix (w_{c}Tₖ₂) is a coordinate transformation matrix for transforming the “keyframe #k2 coordinate system (k2)” into the CAD coordinate system (Wc).

The coordinate transformation matrix (w_{c}T_{C}) is a coordinate transformation matrix for transforming the camera coordinate system (C) at the current drone position into the CAD coordinate system (Wc).

Additionally, the coordinate transformation matrix (wₛTₖ₁) is a coordinate transformation matrix for transforming the “keyframe #k1 coordinate system (k1)” into the SLAM coordinate system (Ws).

The coordinate transformation matrix (wₛTₖ₂) is a coordinate transformation matrix for transforming the “keyframe #k2 coordinate system (k2)” into the SLAM coordinate system (Ws).

The coordinate transformation matrix (wₛT_{C}) is a coordinate transformation matrix for transforming the camera coordinate system (C) at the current drone position into the SLAM coordinate system (Ws).

Furthermore, the coordinate transformation matrix (ₖ₁Tₘ₁) is a coordinate transformation matrix for transforming the marker #m1 coordinate system (m1) of the “marker #m1” into the “keyframe #k1 coordinate system (k1)”.

The coordinate transformation matrix (ₖ₂Tₘ₂) is a coordinate transformation matrix for transforming the marker #m2 coordinate system (m2) of the “marker #m2” into the “keyframe #k2 coordinate system (k2)”.

As described above in the first embodiment with reference to FIG. 9, the coordinate transformation matrices between the plurality of different keyframe coordinate systems are defined as follows in the present second embodiment as well.

The coordinate transformation matrix (ₖ₁Tₖ₂) is a coordinate transformation matrix for transforming the “keyframe #k2 coordinate system (k2)” into the “keyframe #k1 coordinate system (k1)”.

Additionally, the coordinate transformation matrix (ₖ₂T_{C}) is a coordinate transformation matrix for transforming the camera coordinate system (C) at the current drone position into the “keyframe #k2 coordinate system (k2)”.

Additionally, as in the first embodiment, the following three types of data are generated and used in the present second embodiment:
(A) the drone flight path registration CG model;
(B) the object DB (database); and
(C) the keyframe DB.

The above three types of data generated and used in the processing of the present second embodiment are slightly different from the data generated and used in the first embodiment.

The above three types of data generated and used in the present second embodiment will be described hereinafter.

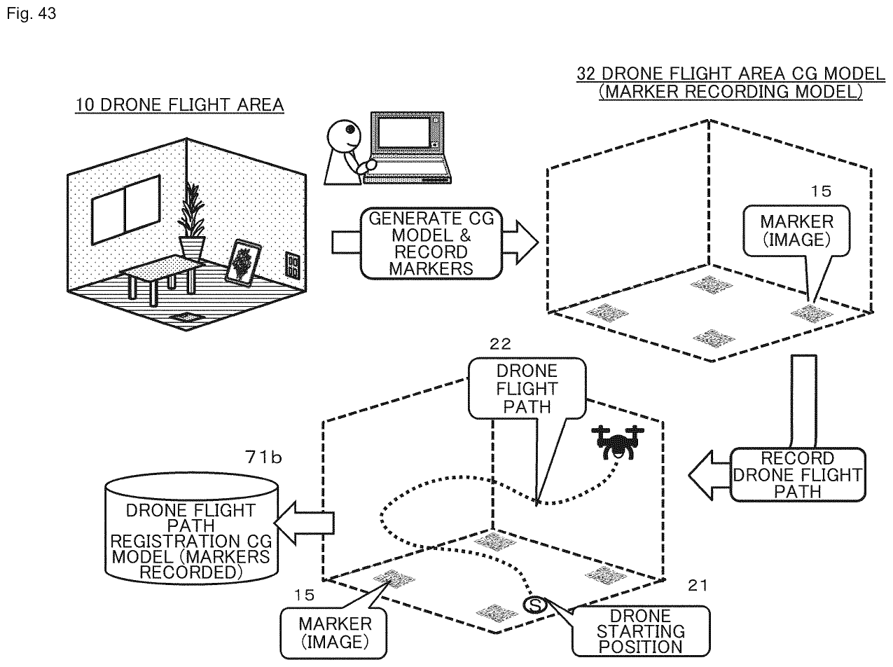

First, “drone flight path registration CG model (marker records) 71b” will be described with reference to FIG. 43.

As described earlier with reference to FIG. 40, in the present second embodiment, markers are recorded in the CG model of the drone flight area (indoors) 10 (a three-dimensional CG model), and the model is then used.

As illustrated in FIG. 43, the user (operator) generates the drone flight area CG model, which represents a three-dimensional space of the drone flight area 10, and further records a plurality of markers distributed throughout the CG model, using an information processing device such as a PC. In other words, the drone flight area CG model (marker recording model) 32 indicated in the upper-right part of FIG. 43 is generated.

The drone flight area CG model (marker recording model) 32 is a three-dimensional CG model in which a plurality of markers is recorded in the three-dimensional model of the drone flight area 10.

Furthermore, the drone starting position 21, the drone flight path 22, and the like are also recorded, as indicated in the bottom part of FIG. 43.

The drone flight path registration CG model (marker records) 71b illustrated in FIG. 43 is generated in this manner. The CG model is a three-dimensional CG model of the drone flight area in which the drone starting position, the drone flight path, and the plurality of markers are recorded.

The processing of the present second embodiment is performed using the drone flight path registration CG model (marker records) 71b.

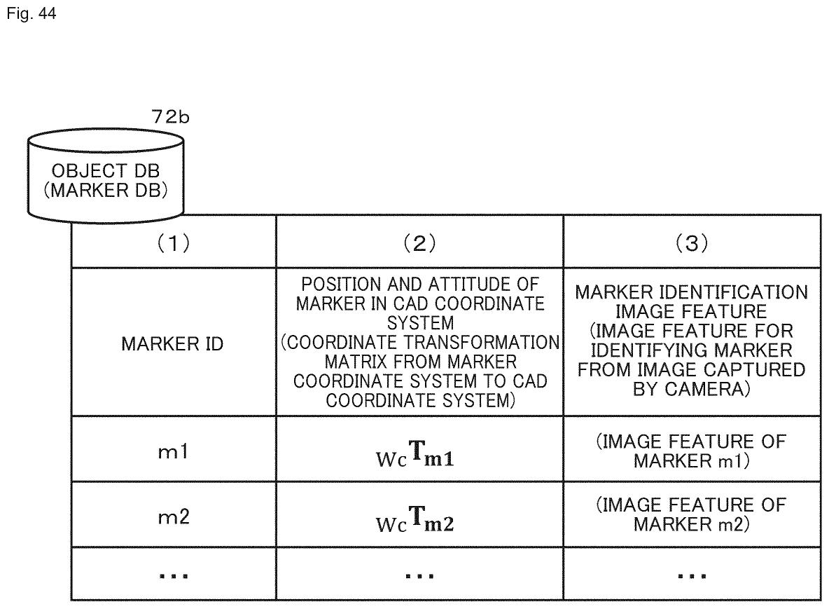

Next, an “object DB (marker DB) 72b” generated and used in the second embodiment will be described with reference to FIG. 44.

The object DB (marker DB) 72b is a database in which data corresponding to each of the markers is recorded, and is a database in which each of the following pieces of data are recorded in association with each other.
(1) Marker ID
(2) Position and attitude of the marker in the CAD coordinate system (a coordinate transformation matrix from the marker coordinate system to the CAD coordinate system)
(3) Marker identification image feature (an image feature for identifying the object from an image captured by the camera)

The markers are used when the drone 20 flies according to the predefined drone flight path 22.

For example, information of each of (1) to (3) above is recorded in association with each other for each of the markers (real markers) 16 indicated in FIG. 40.

A first entry (ID=m1) in the object DB (marker DB) 72b illustrated in FIG. 44 is data corresponding to one marker among the plurality of markers (real markers) 16 indicated in FIG. 40, and each of the following pieces of data is recorded in the entry. Data=m1 is recorded as (1) marker ID.

The coordinate transformation matrix (w_{c}Tₘ₁) is recorded as (2) position and attitude of the object (marker) in the CAD coordinate system (the coordinate transformation matrix from the marker coordinate system to the CAD coordinate system).

The coordinate transformation matrix (w_{c}Tₘ₁) is a coordinate transformation matrix for transforming the marker #m1 coordinate system (m1) corresponding to the marker #m1 into the CAD coordinate system (Wc).

Furthermore, an image feature of “marker #m1” is recorded as (3) marker identification image feature (the image feature for identifying the object from the image captured by the camera).

This image feature is image feature data for identifying the “marker #m1” from an image captured by the drone camera 23.

A second entry (ID=m2) in the object DB (marker DB) 72b illustrated in FIG. 44 is data corresponding to another one of the markers (real markers) 16 indicated in FIG. 40, and each of the following pieces of data is recorded in the entry.

Data=m2 is recorded as (1) marker ID.

The coordinate transformation matrix (w_{c}Tₘ₂) is recorded as (2) position and attitude of the object (marker) in the CAD coordinate system (the coordinate transformation matrix from the marker coordinate system to the CAD coordinate system).

The coordinate transformation matrix (w_{c}Tₘ₂) is a coordinate transformation matrix for transforming the marker #m2 coordinate system (m2), which is the coordinate system of the “marker #m2”, into the CAD coordinate system (Wc).

Furthermore, an image feature of “marker #m2” is recorded as (3) marker identification image feature (the image feature for identifying the object from the image captured by the camera).

This image feature is image feature data for identifying the “marker #m2” from an image captured by the drone camera 23.

Thereafter, object information for all the markers registered in the drone flight path registration CG model 71 is recorded in the object DB (marker DB) 72b illustrated in FIG. 44.

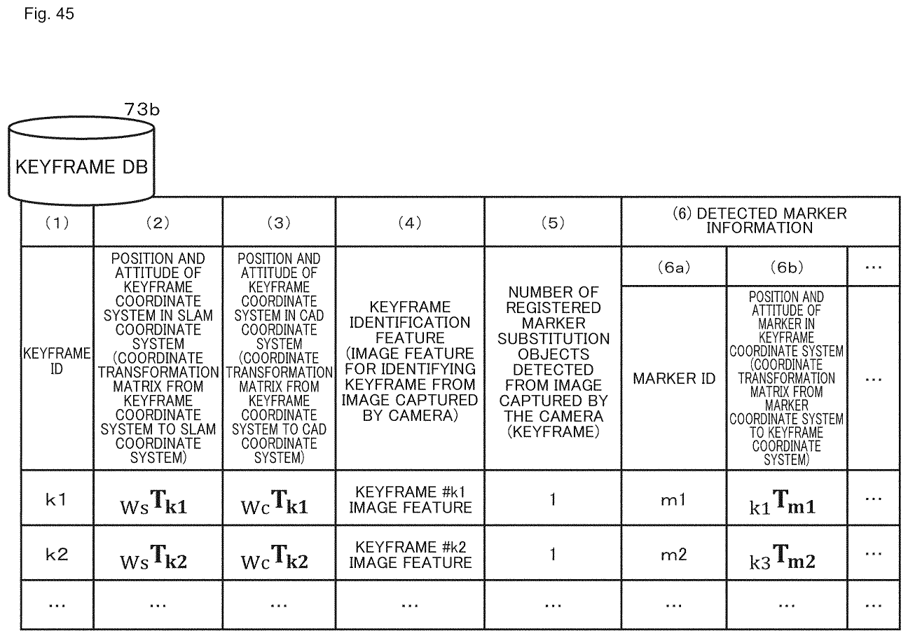

Next, a “keyframe DB 73b” generated and used in the present second embodiment will be described with reference to FIG. 45.

The keyframe DB 73b is a database in which data corresponding to each of the keyframes is recorded, and is a database in which each of the following pieces of data are recorded in association with each other.
(1) Keyframe ID
(2) Position and attitude of the keyframe coordinate system in the SLAM coordinate system (a coordinate transformation matrix from the keyframe coordinate system to the SLAM coordinate system)
(3) Position and attitude of the keyframe coordinate system in the CAD coordinate system (a coordinate transformation matrix from the keyframe coordinate system to the CAD coordinate system)
(4) Keyframe identification feature (an image feature for identifying the keyframe from the image captured by the camera)
(5) Number of registered marker substitution objects detected from the image captured by the camera (keyframe)
(6) Detected marker information
(6a) Marker ID
(6b) Position and attitude of the marker in the keyframe coordinate system (a coordinate transformation matrix from the marker coordinate system to the keyframe coordinate system)

Note that a “keyframe” is a captured image corresponding to the data registered in the keyframe DB 73b, and information registration processing related to the keyframe for the keyframe DB 73 is performed at the stage of preliminary preparation processing. In other words, the drone 20 is manually flown in the drone flight area 10, images that meet specific conditions among the images captured at each of points in the drone flight path 22 are selected as keyframes, and information corresponding to the selected images (keyframes) is registered in the keyframe DB.

The keyframes registered in the keyframe DB 73 are not limited to images captured of markers. In other words, even images in which a marker has not been captured are also selected as keyframes, if predefined conditions are met.

These conditions are the same as in the first embodiment described earlier.

A specific example of the data registered in the keyframe DB 73b illustrated in FIG. 45 will be described here.

A first entry (keyframe ID=k1) in the keyframe DB 73b illustrated in FIG. 45 is, for example, an entry in which an image of the “marker #m1” captured by the drone 20 at the position (P1) indicated in FIG. 7 is registered as a keyframe, and the following data is recorded.

The keyframe ID=k1 is recorded as (1) keyframe ID.

The coordinate transformation matrix (wₛTₖ₁) is recorded as (2) position and attitude of the keyframe coordinate system in the SLAM coordinate system (a coordinate transformation matrix from the keyframe coordinate system to the SLAM coordinate system).

As described earlier with reference to FIG. 8, the coordinate transformation matrix (wₛTₖ₁) is a coordinate transformation matrix for transforming the keyframe #k1 coordinate system (k1) of the “keyframe #k1”, which is an image in which the drone 20 has captured the “marker #m1”, into the SLAM coordinate system (Ws).

By applying this coordinate transformation matrix (wₛTₖ₁) to perform coordinate transformation on coordinates (x, y, z) of a given point P in the keyframe #k1, which is the image captured by the drone camera 23 (=the keyframe #k1 coordinate system), coordinates (x, y, z) of the point P in the SLAM coordinate system (Ws) can be calculated.

For example, when the drone 20 flies autonomously according to a prescribed drone flight path 22, a data processing unit in the drone 20 (a drone flight control device) performs the coordinate transformation described above, and calculates the coordinates (x, y, z), in the SLAM coordinate system (Ws), of various points in the captured image.

The coordinate transformation matrix (w_{c}Tₖ₁) is recorded as (3) the position and attitude of the keyframe coordinate system in the CAD coordinate system (a coordinate transformation matrix from the keyframe coordinate system to the CAD coordinate system).

As described earlier with reference to FIG. 8, the coordinate transformation matrix (w_{c}Tₖ₁) is a coordinate transformation matrix for transforming the keyframe #k1 coordinate system (k1) of the “keyframe #k1”, which is an image in which the drone 20 has captured the “marker #m1”, into the CAD coordinate system (Wc).

By applying this coordinate transformation matrix (w_{c}Tₖ₁) to perform coordinate transformation on coordinates (x, y, z) of a given point P in the keyframe #k1, which is the image captured by the drone camera 23 (=the keyframe #k1 coordinate system), coordinates (x, y, z) of the point P in the CAD coordinate system (Wc) can be calculated.

For example, when the drone 20 flies autonomously according to a prescribed drone flight path 22, a data processing unit in the drone 20 (a drone flight control device) performs the coordinate transformation described above, and calculates the coordinates (x, y, z), in the CAD coordinate system (Wc), of various points in the captured image.

An image feature of the “keyframe #k1” is recorded in (4) keyframe identification feature (the image feature for identifying the keyframe from the image captured by the camera).

Specifically, an image in which the “marker #m1” is captured by the drone 20 at the position (P1) indicated in FIG. 7 is the “keyframe #k1”, and an image feature enabling the three-dimensional shape of the “marker #m1” to be identified is recorded.

The number of registered markers included in the “keyframe #k1” is recorded as (5) number of registered markers detected from the image captured by the camera (the keyframe).

In this example, the “keyframe #k1” captured by the drone 20 at the position (P1) indicated in FIG. 7 includes only the “marker #m1” as a registered marker, and thus a number=“1” is recorded.

Information related to the “marker #m1” included in the “keyframe #k1” is recorded as (6) detected marker information.

### (6a) Marker ID=#m1

The coordinate transformation matrix (ₖ₁Tₘ₁) is recorded as (6b) position and attitude of the marker in the keyframe coordinate system (a coordinate transformation matrix from the marker coordinate system to the keyframe coordinate system).

As described earlier with reference to FIG. 8, the coordinate transformation matrix (ₖ₁Tₘ₁) is a coordinate transformation matrix for transforming the marker #m1 coordinate system (m1) of the “marker #m1” into the “keyframe #k1 coordinate system (k1)”.

Thereafter, the drone 20 is manually flown in the drone flight area 10, and information related to each of the keyframes, which are images that meet specific conditions among the images captured at each of points in the drone flight path 22, is recorded in the keyframe DB 73b illustrated in FIG. 45.

Note that as mentioned earlier, the keyframes registered in the keyframe DB 73b are not limited to images captured of markers. In other words, even images in which a marker has not been captured are also selected and registered as keyframes, if predefined conditions are met.

The overall sequence of processing using the real markers in the present second embodiment is similar to the overall processing flow of FIG. 15 described in the first embodiment above.

In other words,
(Processing 1) Processing for generating drone flight path registration CG model and object DB,
(Processing 2) Processing for obtaining data for enabling transformation processing from keyframe coordinate system to SLAM coordinate system, and constructing keyframe DB,
(Processing 3) Optimization processing for minimizing absolute position error of keyframes registered in keyframe DB, and
(Processing 4) Processing for performing autonomous flight in accordance with prescribed flight path (referring to post-optimization processing keyframe DB, and performing autonomous flight while correcting self position estimated in SLAM coordinate system based on self position in CAD coordinate system)
(Processing 1) to (Processing 4) are performed in that order in succession.

The detailed sequence of (Processing 1) described in the first embodiment with reference to the flow illustrated in FIG. 16,
the detailed sequence of (Processing 2) described in the first embodiment with reference to the flow illustrated in FIG. 19,
the detailed sequence of (Processing 3) described in the first embodiment with reference to the flow illustrated in FIG. 29, and
the detailed sequence of (Processing 4) described in the first embodiment with reference to the flow illustrated in FIGS. 37 and 38,
are the corresponding instances of processing, but with “marker substitution object” replaced with “marker”.

Like the first embodiment, in the second embodiment as well, the drone 20 can fly autonomously according to the predefined drone flight path 22 by using the registration information in the keyframe DB 73b.

Although the foregoing embodiments have described examples of flight control processing for a drone, the processing of the present disclosure is not limited to flight control for a drone, and can also be applied to movement control processing for other mobile bodies, such as robots and automatically-traveling vehicles.

The same processing can be performed by replacing “drone” in the above-described embodiments with “robot” or “automatically-traveling vehicle”.

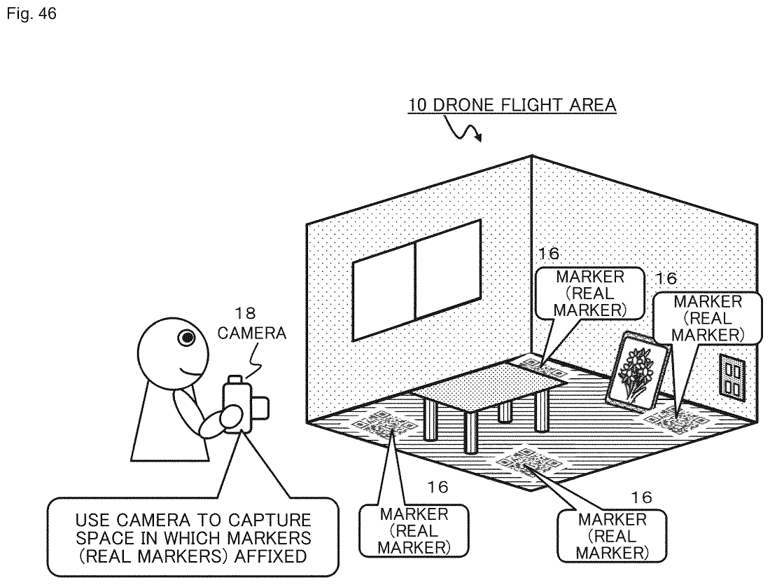

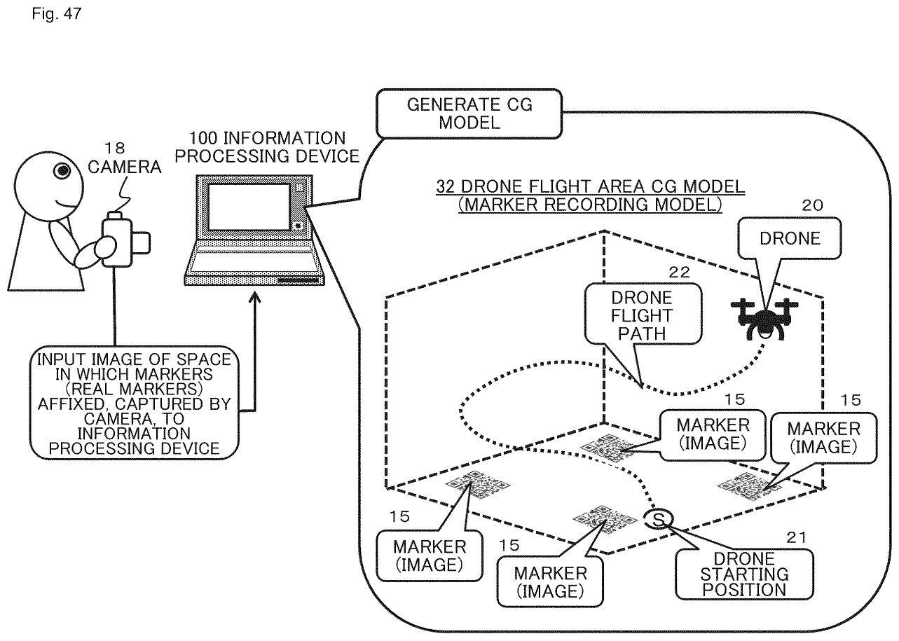

When generating the three-dimensional CG model including the image data of the markers, processing may be performed in which, for example, an image of the drone flight area 10 where the markers (real markers) 16 are affixed is captured by a camera 18 as illustrated in FIG. 46, and the captured image is input to a PC or the like to generate the drone flight area CG model (marker recording model) 32 as illustrated in FIG. 47.

### 6. Examples of Configurations of Information Processing Device and Mobile Body Control Device of Present Disclosure

Examples of the configurations of the information processing device and the mobile body control device of the present disclosure will be described next.

As described above, each of the following instances of processing is performed in the present disclosure.
(Processing 1) Processing for generating drone flight path registration CG model and object DB
(Processing 2) Processing for obtaining data for enabling transformation processing from keyframe coordinate system to SLAM coordinate system, and constructing keyframe DB
(Processing 3) Optimization processing for minimizing absolute position error of keyframes registered in keyframe DB
(Processing 4) Processing for performing autonomous flight in accordance with prescribed flight path (referring to post-optimization processing keyframe DB, and performing autonomous flight while correcting self position estimated in SLAM coordinate system based on self position in CAD coordinate system)
(Processing 1) to (Processing 4) are performed in that order in succession.

During (Processing 1) to (Processing 4) described above, for example, (Processing 1) can be performed in an information processing device such as a PC, as described earlier with reference to FIGS. 16 to 18.

(Processing 2) can be performed in the drone 20, or in the drone 20 and an information processing device such as a PC, as described earlier with reference to FIGS. 19 to 21.

(Processing 3) is the processing described with reference to FIGS. 29 to 36, and can be performed in the drone 20, or in the drone 20 and an information processing device such as a PC.

(Processing 4) is the processing described with reference to FIGS. 37 to 39, and is processing performed by the drone 20.

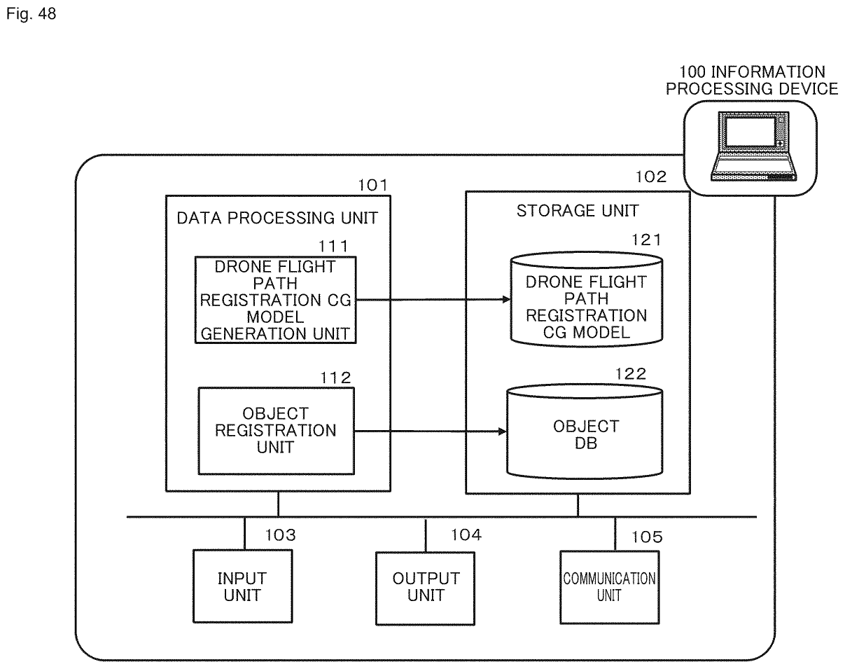

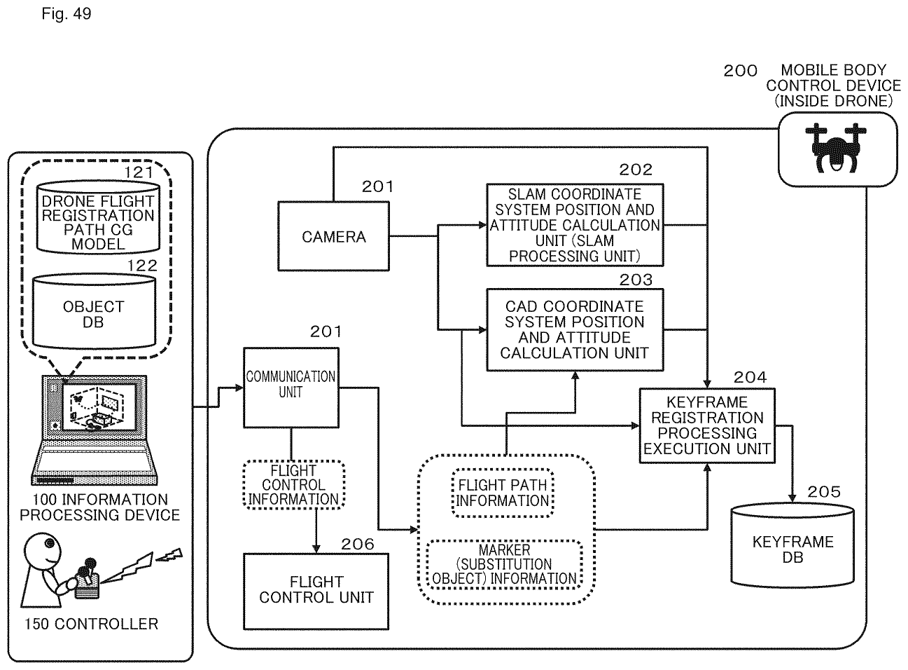

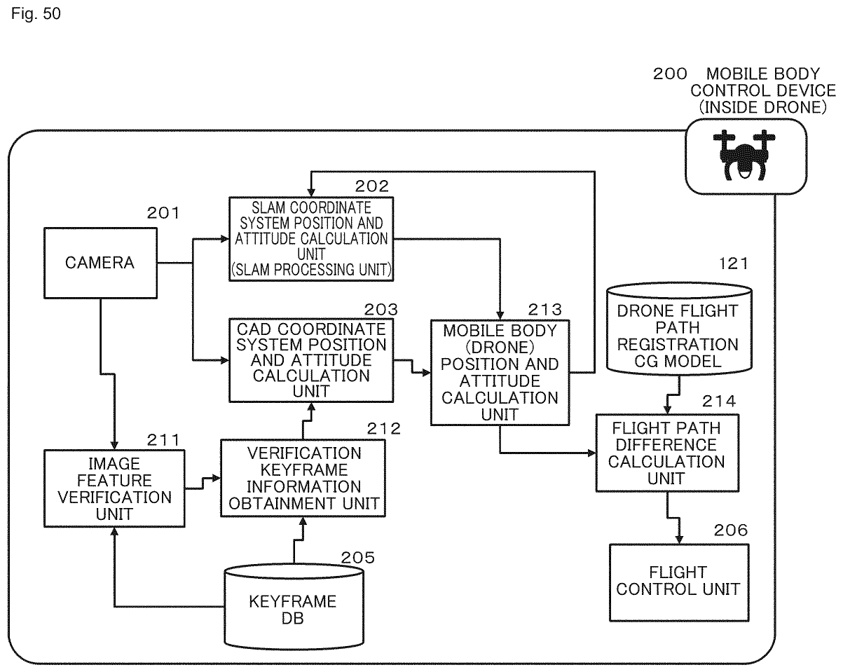

Hereinafter, referring to FIG. 48 and on, specific configurations of an information processing device such as a PC, serving as an example of a device that performs (Processing 1) (FIG. 48),
a mobile body control device in the drone, serving as an example of a device for performing (Processing 2) and (Processing 3) (FIG. 49), and
a mobile body control device in the drone, serving as an example of a device for performing (Processing 4) (FIG. 50),
will be described.

The configuration of the mobile body control device in the drone that performs (Processing 2) and (Processing 3), illustrated in FIG. 49, and the configuration of the mobile body control device in the drone that performs (Processing 3), illustrated in FIG. 50, will be described separately. However, when a mobile body control device in a single drone performs all (Processing 2), (Processing 3), and (Processing 4), the mobile body control device has both the configuration illustrated in FIG. 49 and the configuration illustrated in FIG. 50.

The configuration may also be such that (Processing 1) is performed by the mobile body control device in the drone. In this case, the configuration described with reference to FIG. 48 is also provided in the mobile body control device in the drone.

An example of the configuration of an information processing device 100 such as a PC will be described first as an example of a device for performing (Processing 1), with reference to FIG. 48.

(Processing 1) is processing for generating the drone flight path registration CG model and the object DB, and is the processing described earlier with reference to FIGS. 16 to 18.

As illustrated in FIG. 48, the information processing device 100 that generates the drone flight path registration CG model, the object DB, and the like includes a data processing unit 101, a storage unit 102, an input unit 103, an output unit 104, and a communication unit 105.

The data processing unit 101 includes a drone flight path registration CG model generation unit 111 and an object (marker) registration unit 112.

The storage unit 102 has a drone flight path registration CG model 121 and an object DB 122.

The drone flight path registration CG model generation unit 111 of the data processing unit 101 generates the drone flight path registration CG model 121 and stores that model in the storage unit 102 by performing the processing described earlier with reference to FIGS. 16 to 18, or with reference to FIG. 43, for example.

The drone flight path registration CG model 121 is a three-dimensional CG model in which each of the following types of data is recorded:
(a) the three-dimensional CG model of the drone flight area
(b) three-dimensional images of the marker substitution objects or the markers
(c) the drone flight path

The object (marker) registration unit 112 of the data processing unit 101 generates the object DB 122 and stores that DB in the storage unit 102 by performing the processing described earlier with reference to FIGS. 16 to 17, for example.

The object DB 122 has the data configuration illustrated in FIG. 11, FIG. 44, or the like, for example.

In other words, each of the following pieces of data are recorded in association with each other in the database.
(1) Marker substitution object ID (marker ID)
(2) Position and attitude of the object (marker) in the CAD coordinate system (a coordinate transformation matrix from the marker coordinate system to the CAD coordinate system)
(3) Object (marker) identification image feature (an image feature for identifying the object from an image captured by the camera)

The input unit 103 is constituted by a user-operable keyboard, a mouse, a touch panel, and the like. The output unit 104 is constituted by a display unit, an audio output unit, and the like. The communication unit 105 is used for communication with, for example, the drone, other external devices, or the like.

An example of the configuration of the mobile body control device in the drone serving as an example of a device for performing (Processing 2) and (Processing 3) will be described next with reference to FIG. 49.

(Processing 2) is processing for obtaining data for enabling transformation processing from the keyframe coordinate system to the SLAM coordinate system, and constructing the keyframe DB.

(Processing 3) is optimization processing for minimizing absolute position error of the keyframes registered in the keyframe DB.

Note that (Processing 2) is the processing described earlier with reference to FIGS. 19 to 21, and (Processing 3) is the processing described with reference to FIGS. 29 to 36.

The configuration illustrated in FIG. 49 is an example of the configuration of a mobile body control device 200 that performs these instances of processing, and is an example of the configuration of a mobile body control device 200 provided in the drone.

As illustrated in FIG. 49, the mobile body control device 200 includes a camera 201, a SLAM coordinate system position and attitude calculation unit (SLAM processing unit) 202, a CAD coordinate system position calculation unit 203, a keyframe registration processing execution unit 204, a keyframe DB 205, and a flight control unit 206.

The camera 201 corresponds to the drone camera 23 described in the foregoing embodiments. The camera 201 is constituted by, for example, a stereo camera or a monocular camera. Alternatively, a camera and a range sensor may be combined. LiDAR, a ToF sensor, or the like can be used as the range sensor.

The SLAM coordinate system position and attitude calculation unit (SLAM processing unit) 202 inputs a captured image from the camera 201 and performs self position and attitude calculation processing through SLAM processing based on the input image.

Specifically, the position and attitude of a keyframe registration scheduled image, which is the image captured by the camera 201, for example, are calculated in the SLAM coordinate system.

The processing for calculating the position and attitude in the SLAM coordinate system corresponds to the processing of step S201, step S209, and the like in the flowchart illustrated in FIG. 19 and described earlier.

The CAD coordinate system position calculation unit 203 takes the captured image from the camera 201 as an input, and further calculates the position and attitude of the keyframe registration scheduled image, which is the image captured by the camera 201, in the CAD coordinate system.

This processing corresponds to the processing described earlier with reference to FIGS. 29 to 33.

Note that when performing the processing for calculating the position and attitude of the keyframe registration scheduled image, which is the image captured by the camera 201, in the CAD coordinate system, information related to the marker substitution objects, i.e., information recorded in the object DB 122 and CG model information, or to rephrase, the drone flight path registration CG model 121, is necessary, as described with reference to FIGS. 31 to 33.

The CAD coordinate system position calculation unit 203 inputs this information from the information processing device 100 such as an external PC through a communication unit 201, for example.

Alternatively, the configuration may be such that the drone flight path registration CG model 121 and the object DB 122 are input to and stored in a storage unit from the information processing device 100 such as a PC in advance, and the data stored in the storage unit is used.

The keyframe registration processing execution unit 204 performs the processing of steps S202 to S210 of the flow illustrated in FIG. 19 and the processing of steps S301 to S302 of the flow illustrated in FIG. 29, and performs the keyframe data registration processing for the keyframe DB 205 and the like.

As described earlier with reference to FIG. 12, the keyframe DB 205 is a database in which data corresponding to each of the keyframes is recorded, and is a database in which each of the following pieces of data are recorded in association with each other.
(1) Keyframe ID
(2) Position and attitude of the keyframe coordinate system in the SLAM coordinate system (a coordinate transformation matrix from the keyframe coordinate system to the SLAM coordinate system)
(3) Position and attitude of the keyframe coordinate system in the CAD coordinate system (a coordinate transformation matrix from the keyframe coordinate system to the CAD coordinate system)
(4) Keyframe identification feature (an image feature for identifying the keyframe from the image captured by the camera)
(5) Number of registered marker substitution objects detected from the image captured by the camera (keyframe)
(6) Detected object (marker) information
(6a) Marker substitution object ID (marker ID)
(6b) Position and attitude of the object in the keyframe coordinate system (a coordinate transformation matrix from the marker coordinate system to the keyframe coordinate system)

The keyframe registration processing execution unit 204 records each of these pieces of data in the keyframe DB 205.

The excess keyframe deletion processing described earlier with reference to FIG. 36 is also performed.

The flight control unit 206 control flight according to a flight control signal received via a controller 150 when (Processing 2) is performed.

In other words, flight is controlled to fly according to the keyframe registration flight path 25 described earlier with reference to FIG. 20, for example.

An example of the configuration of the mobile body control device in the drone serving as an example of a device for performing (Processing 4) will be described next with reference to FIG. 50.

As mentioned earlier, FIG. 49 is an example of the configuration of the mobile body control device in the drone that performs (Processing 2) and (Processing 3), and FIG. 50 is an example of the configuration of the mobile body control device in the drone that performs (Processing 3). However, when the mobile body control device in the drone performs all (Processing 2), (Processing 3), and (Processing 4), the mobile body control device in the drone has both the configuration illustrated in FIG. 49 and the configuration illustrated in FIG. 50.

(Processing 4) is processing for performing autonomous flight in accordance with the prescribed flight path (referring to the post-optimization processing keyframe DB, and performing autonomous flight while correcting the self position estimated in the SLAM coordinate system based on self position in the CAD coordinate system). This (Processing 4) is the processing described with reference to FIGS. 37 to 39.

The configuration illustrated in FIG. 50 is an example of the configuration of a mobile body control device 200 that performs these instances of processing, and is an example of the configuration of a mobile body control device 200 provided in the drone.

As illustrated in FIG. 50, the mobile body control device 200 includes the camera 201, the SLAM coordinate system position and attitude calculation unit (SLAM processing unit) 202, the CAD coordinate system position calculation unit 203, the keyframe DB 205, and the flight control unit 206, as well as the drone flight path registration CG model 121, an image feature verification unit 211, a verification keyframe information obtainment unit 212, a mobile body (drone) position and attitude calculation unit 213, and a flight path difference calculation unit 214.

The camera 201, the SLAM coordinate system position and attitude calculation unit (SLAM processing unit) 202, and the CAD coordinate system position calculation unit 203 perform almost the same processing as the processing described with reference to FIG. 49.

The keyframe DB 205 is a keyframe DB generated through processing according to the flow illustrated in FIG. 19, described earlier, applying the configuration described with reference to FIG. 49. The data described earlier with reference to FIG. 12 is stored therein.

The camera 201 corresponds to the drone camera 23 described in the foregoing embodiments and is constituted by, for example, a stereo camera or a monocular camera. Alternatively, a camera and a range sensor may be combined.

The SLAM coordinate system position and attitude calculation unit (SLAM processing unit) 202 inputs a captured image from the camera 201 and performs self position and attitude calculation processing through SLAM processing based on the input image.

Specifically, the position and attitude of the image captured by the camera 201, for example, are calculated in the SLAM coordinate system.

The processing for calculating the position and attitude in the SLAM coordinate system corresponds to the processing of step S402 in the flowchart illustrated in FIG. 37, described earlier.

The image feature verification unit 211 performs the processing of step S402 in the flowchart illustrated in FIG. 37, described earlier.

In other words, processing of verifying a feature of the image captured by the camera 201 (the drone camera 23, in the foregoing embodiments) against the features of the images registered in the keyframe DB 205 is performed.

The feature of the image in the keyframe DB 205 to be compared here is the registration data (4) described earlier with reference to FIG. 12, i.e., the keyframe identification feature, namely:
(4) Keyframe identification feature (an image feature for identifying the keyframe from the image captured by the camera)

If a registered keyframe for which the verification is successful is detected, the detected information is input to the verification keyframe information obtainment unit 212.

The verification keyframe information obtainment unit 212 obtains the registration information of the matching keyframe from the keyframe DB 205 and outputs that information to the CAD coordinate system position calculation unit 203.

The CAD coordinate system position calculation unit 203 performs the processing of step S411 in the flow illustrated in FIG. 38.

In other words, as the processing of step S411, the position and attitude (wcTkx) of the keyframe #kx in the CAD coordinates are obtained from the DB registration information of the keyframe for which the verification is successful.

The mobile body (drone) position and attitude calculation unit 213 takes as an input at least one of the SLAM coordinate system position and attitude calculated by the SLAM coordinate system position and attitude calculation unit 202 and the CAD coordinate system position and attitude calculated by the CAD coordinate system position and attitude calculation unit 203, and if the CAD coordinate system position and attitude calculated by the CAD coordinate system position and attitude calculation unit 203 is input, the input CAD coordinate system position and attitude are taken as the position and attitude of the drone.

The mobile body (drone) position and attitude calculation unit 213 specifically performs the processing of step S412 and the processing of step S413 in the flow illustrated in FIG. 38.

If the keyframe for which the verification is successful is detected from the keyframe DB 205, as the processing of step S412, the keyframe position and attitude (wcTkx) in the CAD coordinates obtained from the keyframe DB 205 by the CAD coordinate system position calculation unit 203 are taken as the self position and attitude (wcTc) of the drone in the CAD coordinates.

However, if a keyframe for which the verification is successful has not been detected, as the processing of step S413, based on the self position (wsTc) in the SLAM coordinates calculated through the SLAM processing based on the captured image one frame before the captured image for which the verification determination was made, the self position and attitude (wcTc) in the CAD coordinates of the drone when the captured image, for which the verification determination was made, was captured, is estimated. For example, position estimation processing using an existing delta pose estimation algorithm is performed to estimate the current self position and attitude (wcTc) in the CAD coordinates of the drone.

The self position and attitude (wcTc) of the drone in the CAD coordinates, calculated by the mobile body (drone) position and attitude calculation unit 213, are output to the flight path difference calculation unit 214.

Additionally, the self position and attitude (wcTc) of the drone, in the CAD coordinates, calculated by the mobile body (drone) position and attitude calculation unit 213 may be output to the SLAM coordinate system position and attitude calculation unit (SLAM processing unit) 202, and the SLAM coordinate system position and attitude calculation unit (SLAM processing unit) 202 may use those values to perform correction processing to eliminate accumulated error in the position and attitude resulting from the SLAM processing.

The flight path difference calculation unit 214 takes the self position and attitude (wcTc) of the drone in the CAD coordinates, calculated by the mobile body (drone) position and attitude calculation unit 213, as an input, and performs the processing of step S414 of the flow illustrated in FIG. 38.

In other words, the position difference between the self position and attitude (wcTc) of the drone in the CAD coordinates, calculated by the CAD coordinate system position calculation unit 203, and the flight path (the drone flight path 22) registered in the drone flight path registration CG model 121, is calculated. The position difference information calculated by the flight path difference calculation unit 214 is output to the flight control unit 206.

The flight control unit 206 performs the processing of steps S415 to S416 in the flow illustrated in FIG. 38.

In other words, a flight control value for reducing the position difference calculated by the flight path difference calculation unit 214 is calculated, and the flight is controlled according to the calculated flight control value.

This flight control is flight control for reducing the positional difference, and is flight control for reducing the positional difference between the self position and attitude (wcTc) of the drone in the CAD coordinates and the flight path (the drone flight path 22) registered in the drone flight path registration CG model 121.

In other words, the flight is controlled to return the drone to the flight path (the drone flight path 22) registered in the drone flight path registration CG model 121. As a result, the drone can fly autonomously according to the predefined drone flight path 22. In other words, using the registration information in the keyframe DB 205 makes it possible to fly autonomously according to the predefined drone flight path 22.

### 7. Example of Hardware Configurations of Information Processing Device and Mobile Body Control Device of Present Disclosure

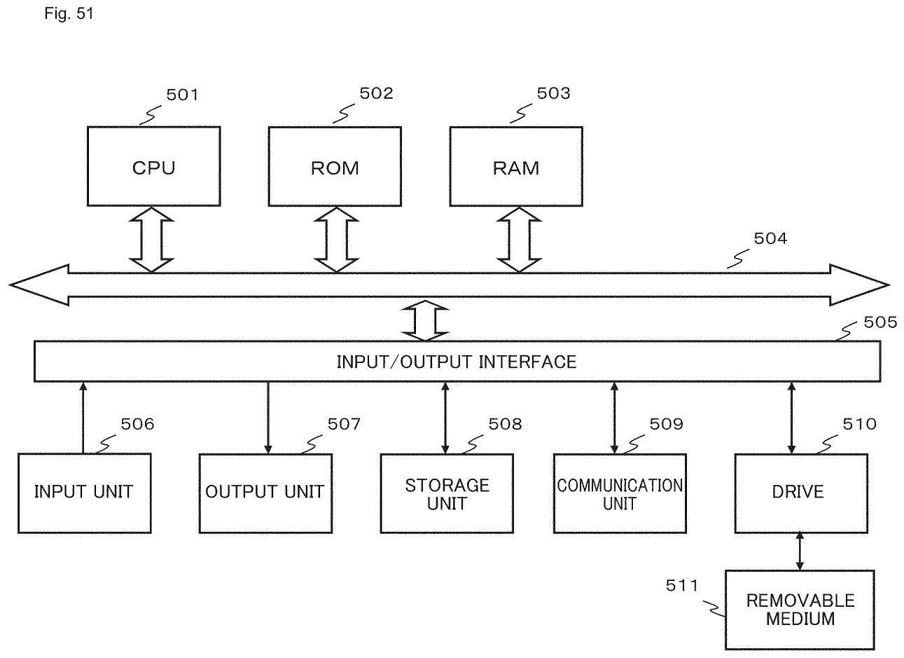

An example of the hardware configurations of an information processing device, a mobile body control device, and the like of the present disclosure will be described next with reference to FIG. 51.

The elements of the hardware configuration illustrated in FIG. 51 will be described next.

A Central Processing Unit (CPU) 501 functions as a data processing unit that performs various types of processing according to a program stored in a Read Only Memory (ROM) 502 or a storage unit 508. For example, the processing according to the sequences described in the foregoing embodiments is performed. Programs executed by the CPU 501, data, and the like are stored in a Random Access Memory (RAM) 503. The CPU 501, the ROM 502, and the RAM 503 are connected to each other by a bus 504.

The CPU 501 is connected to an input/output interface 505 by the bus 504, and an input unit 506 constituted by various sensors, a camera, switches, a keyboard, a mouse, a microphone, and the like, and an output unit 507 constituted by a display, a speaker, and the like, are connected to the input/output interface 505.

The storage unit 508 connected to the input/output interface 505 is constituted by, for example, USB memory, an SD card, a hard disk, or the like, and stores programs executed by the CPU 501, various types of data, and the like. A communication unit 509 functions as a transmission/reception unit for data communication over a network such as the Internet or a local area network, and communicates with external devices.

A drive 510 connected to the input/output interface 505 drives a removable medium 511 such as a magnetic disk, an optical disk, a magneto optical disk, or a semiconductor memory such as a memory card, and records or reads data.

### 8. Summary of Configuration of Present Disclosure

Embodiments of the present disclosure have been described above in detail with reference to specific embodiments. However, it will be apparent to those skilled in the art that modifications, substitutions, and the like can be made in the embodiments without departing from the essential spirit of the present disclosure. That is, the present invention has been disclosed in an illustrative form, and is not intended to be interpreted as being limited to the examples given here. The essential spirit of the present disclosure should be determined in consideration of the claims.

The technique disclosed in the present specification can have the following configurations.

(1) A mobile body control device including:
a keyframe database that associates, and registers, a feature of a keyframe selected from images of a movement space shot by a camera and a position and attitude of the keyframe in a coordinate system defining the movement space;
an image feature verification unit that verifies a feature of an image captured by a camera of a mobile body against a feature of a keyframe registered in the keyframe database;
a mobile body position and attitude calculation unit that calculates a position and attitude of the mobile body based on the position and attitude of the keyframe in the coordinate system defining the movement space, registered in the keyframe database in association with a keyframe for which the verification is successful; and
a movement control unit that controls movement of the mobile body based on the position and attitude calculated by the mobile body position and attitude calculation unit.

(2) The mobile body control device according to (1),
wherein the coordinate system defining the movement space is a CAD coordinate system defining a three-dimensional CG model of the movement space.

(3) The mobile body control device according to (1) or (2),
wherein the keyframe database is a database that registers, in relation to each keyframe, a position and attitude of the keyframe in a CAD coordinate system defining a three-dimensional CG model of the movement space.

(4) The mobile body control device according to any one of (1) to (3),
wherein the keyframe database is a database that registers, in relation to each keyframe, a coordinate transformation matrix for transformation from a keyframe coordinate system defining the position and attitude of the keyframe into a CAD coordinate system defining a three-dimensional CG model of the movement space.

(5) The mobile body control device according to any one of (1) to (4),
wherein the keyframe database is a database that registers, in relation to each keyframe, information related to a marker or a marker substitution object included as an object in the keyframe.

(6) The mobile body control device according to (5),
wherein the marker substitution object is an object that fixed in the movement space.

(7) The mobile body control device according to (5) or (6),
wherein the keyframe database is a database that registers, as the information related to the marker or the marker substitution object, a position and attitude of the marker or the marker substitution object in a keyframe coordinate system defining the position and attitude of the keyframe.

(8) The mobile body control device according to any one of (5) to (7),
wherein the marker or the marker substitution object is a marker or a marker substitution object that registered in an object database, and
the object database is a database that registers, for each marker or each marker substitution object, a position and attitude in a CAD coordinate system defining a three-dimensional CG model of the movement space.

(9) The mobile body control device according to any one of (1) to (8),
wherein the keyframe database is a database that registers, in relation to each keyframe, a position and attitude of the keyframe in a SLAM coordinate system calculated when generating the keyframe database.

(10) The mobile body control device according to any one of (1) to (9), including:
a SLAM coordinate system position and attitude calculation unit that performs self position and attitude calculation processing through SLAM processing using an image captured by the camera of the mobile body; and
a CAD coordinate system position calculation unit that obtains a position and attitude of the keyframe in a CAD coordinate system defining the movement space, registered in the keyframe database in association with the keyframe for which the verification is successful.

(11) The mobile body control device according to (10),
wherein when at least one of a SLAM coordinate system position and attitude calculated by the SLAM coordinate system position and attitude calculation unit or a CAD coordinate system position and attitude calculated by the CAD coordinate system position and attitude calculation unit is taken as an input, and the CAD coordinate system position and attitude calculated by the CAD coordinate system position and attitude calculation unit is input, the mobile body position and attitude calculation unit calculates the CAD coordinate system position and attitude input as the position and attitude of the mobile body.

(12) The mobile body control device according to any one of (1) to (11), including:
a mobile body path difference calculation unit that calculates a difference between the position of the mobile body calculated by the mobile body position and attitude calculation unit and a predefined movement path,
wherein the movement control unit controls movement of the mobile body to reduce the difference calculated by the mobile body path difference calculation unit.

(13) The mobile body control device according to (12),
wherein the mobile body path difference calculation unit calculates the difference between the position of the mobile body calculated by the mobile body position and attitude calculation unit and the predefined movement path while referring to movement path registration data in which the predefined movement path is registered.

(14) The mobile body control device according to any one of (1) to (13),
wherein the mobile body is a drone, and
the movement control unit controls flight of the drone.

(15) A mobile body control method performed by a mobile body control device,
the mobile body control device including a keyframe database that associates, and registers, a feature of a keyframe selected from images of a movement space shot by a camera and a position and attitude of the keyframe in a coordinate system defining the movement space, and the mobile body control method including:
verifying, by an image feature verification unit, a feature of an image captured by a camera of a mobile body against a feature of a keyframe registered in the keyframe database;
calculating, by a mobile body position and attitude calculation unit, a position and attitude of the mobile body based on the position and attitude of the keyframe in the coordinate system defining the movement space, registered in the keyframe database in association with a keyframe for which the verification is successful; and
controlling, by a movement control unit, movement of the mobile body based on the position and attitude calculated in the calculating.

(16) A program that causes a mobile body control device to execute mobile body control processing,
the mobile body control device including a keyframe database that associates, and registers, a feature of a keyframe selected from images of a movement space shot by a camera and a position and attitude of the keyframe in a coordinate system defining the movement space,
the program causing:
an image feature verification unit to verify a feature of an image captured by a camera of a mobile body against a feature of a keyframe registered in the keyframe database;
a mobile body position and attitude calculation unit to calculate a position and attitude of the mobile body based on the position and attitude of the keyframe in the coordinate system defining the movement space, registered in the keyframe database in association with a keyframe for which the verification is successful; and
a movement control unit to control movement of the mobile body based on the position and attitude calculated by the mobile body position and attitude calculation unit.

The series of processing described in the specification can be executed by hardware, software, or a composite configuration of both. When the processing is executed by software, a program in which a processing sequence has been recorded can be installed in memory in a computer embedded in dedicated hardware and executed, or the program can be installed in a general-purpose computer capable of executing various types of processing and executed. For example, the program can be recorded in advance on a recording medium. In addition to being installed in the computer from the recording medium, the program can be received over a network such as a local area network (LAN) or the Internet and installed in a recording medium such as a built-in hard disk.

The various processing described in this specification can be performed consecutively in the described order or may be performed in parallel or individually depending on the processing capability of the device performing the processing, or as needed. In the present specification, the system is a logical set of configurations of a plurality of devices, and the devices having each configuration are not limited to those in the same housing.

### INDUSTRIAL APPLICABILITY

As described above, according to the configuration of one embodiment of the present disclosure, a device and method are provided which realize movement according to a predefined path even when absolute position information from the exterior, such as a GPS signal, cannot be input.

Specifically, for example, using a keyframe database that associates, and registers, a feature of a keyframe selected from images of a movement space shot by a camera and a position and attitude of the keyframe in a coordinate system defining the movement space, a feature of an image captured by a camera of the mobile body is verified against a keyframe feature. The position and attitude of the mobile body are then calculated on the basis of the position and attitude of the keyframe in the coordinate system defining the movement space, registered in the database in association with the keyframe for which the verification is successful. Then, the movement of the mobile body is controlled on the basis of the position and attitude calculated.

According to this configuration, a device and method are provided which realize movement according to a predefined path even when absolute position information from the exterior, such as a GPS signal, cannot be input.

### REFERENCE SIGNS LIST

10 Drone flight area
15 Marker (image)
16 Marker (real marker)
20 Drone
21 Drone starting position
22 Drone flight path
23 Drone camera
25 Keyframe registration flight path
30 Drone flight area CG model
32 Drone flight area CG model (marker recording model)
70 Information processing device
71 Drone flight path registration CG model
72 Object DB
73 Keyframe DB
75 DB-registered keyframe
80 Controller
100 Information processing device
101 Data processing unit
102 Storage unit
103 Input unit
104 Output unit
105 Communication portion
111 Drone flight path registration CG model generation unit
112 Object (marker) registration unit
121 Drone flight path registration CG model
122 Object DB
200 Mobile body control device
201 Camera
202 SLAM coordinate system position and attitude calculation unit (SLAM processing unit)
203 CAD coordinate system position calculation unit
204 Keyframe registration processing execution unit
205 Keyframe DB
206 Flight control unit
211 Image feature verification unit
212 Verification keyframe information obtainment unit
213 Mobile body (drone) position and attitude calculation unit
214 Flight path difference calculation unit
501 CPU
502 ROM
503 RAM
504 Bus
505 Input/output interface
506 Input unit
507 Output unit
508 Storage unit
509 Communication unit
510 Drive
511 Removable medium

1. A mobile body control device comprising:
a keyframe database that associates, and registers, a feature of a keyframe selected from images of a movement space shot by a camera and a position and attitude of the keyframe in a coordinate system defining the movement space;
an image feature verification unit that verifies a feature of an image captured by a camera of a mobile body against the feature of the keyframe registered in the keyframe database;
a mobile body position and attitude calculation unit that calculates a position and attitude of the mobile body based on the position and attitude of the keyframe in the coordinate system defining the movement space, registered in the keyframe database in association with a keyframe for which the verification is successful; and
a movement control unit that controls movement of the mobile body based on the position and attitude calculated by the mobile body position and attitude calculation unit.

2. The mobile body control device according to claim 1,
wherein the coordinate system defining the movement space is a CAD coordinate system defining a three-dimensional CG model of the movement space.

3. The mobile body control device according to claim 1,
wherein the keyframe database is a database that registers, in relation to each keyframe, a position and attitude of the keyframe in a CAD coordinate system defining a three-dimensional CG model of the movement space.

4. The mobile body control device according to claim 1,
wherein the keyframe database is a database that registers, in relation to each keyframe, a coordinate transformation matrix for transformation from a keyframe coordinate system defining the position and attitude of the keyframe into a CAD coordinate system defining a three-dimensional CG model of the movement space.

5. The mobile body control device according to claim 1,
wherein the keyframe database is a database that registers, in relation to each keyframe, information related to a marker or a marker substitution object included as an object in the keyframe.

6. The mobile body control device according to claim 5,
wherein the marker substitution object is an object that fixed in the movement space.

7. The mobile body control device according to claim 5,
wherein the keyframe database is a database that registers, as the information related to the marker or the marker substitution object, a position and attitude of the marker or the marker substitution object in a keyframe coordinate system defining the position and attitude of the keyframe.

8. The mobile body control device according to claim 5,
wherein the marker or the marker substitution object is a marker or a marker substitution object that registered in an object database, and
the object database is a database that registers, for each marker or each marker substitution object, a position and attitude in a CAD coordinate system defining a three-dimensional CG model of the movement space.

9. The mobile body control device according to claim 1,
wherein the keyframe database is a database that registers, in relation to each keyframe, a position and attitude of the keyframe in a SLAM coordinate system calculated when generating the keyframe database.

10. The mobile body control device according to claim 1, comprising:
a SLAM coordinate system position and attitude calculation unit that performs self position and attitude calculation processing through SLAM processing using an image captured by the camera of the mobile body; and
a CAD coordinate system position calculation unit that obtains a position and attitude of the keyframe in a CAD coordinate system defining the movement space, registered in the keyframe database in association with the keyframe for which the verification is successful.

11. The mobile body control device according to claim 10,
wherein when at least one of a SLAM coordinate system position and attitude calculated by the SLAM coordinate system position and attitude calculation unit or a CAD coordinate system position and attitude calculated by the CAD coordinate system position and attitude calculation unit is taken as an input, and the CAD coordinate system position and attitude calculated by the CAD coordinate system position and attitude calculation unit is input, the mobile body position and attitude calculation unit calculates the CAD coordinate system position and attitude input as the position and attitude of the mobile body.

12. The mobile body control device according to claim 1, comprising:
a mobile body path difference calculation unit that calculates a difference between the position of the mobile body calculated by the mobile body position and attitude calculation unit and a predefined movement path,
wherein the movement control unit controls movement of the mobile body to reduce the difference calculated by the mobile body path difference calculation unit.

13. The mobile body control device according to claim 12,
wherein the mobile body path difference calculation unit calculates the difference between the position of the mobile body calculated by the mobile body position and attitude calculation unit and the predefined movement path while referring to movement path registration data in which the predefined movement path is registered.

14. The mobile body control device according to claim 1,
wherein the mobile body is a drone, and
the movement control unit controls flight of the drone.

15. A mobile body control method performed by a mobile body control device,
the mobile body control device including a keyframe database that associates, and registers, a feature of a keyframe selected from images of a movement space shot by a camera and a position and attitude of the keyframe in a coordinate system defining the movement space, and the mobile body control method including:
verifying, by an image feature verification unit, a feature of an image captured by a camera of a mobile body against a feature of a keyframe registered in the keyframe database;
calculating, by a mobile body position and attitude calculation unit, a position and attitude of the mobile body based on the position and attitude of the keyframe in the coordinate system defining the movement space, registered in the keyframe database in association with a keyframe for which the verification is successful; and
controlling, by a movement control unit, movement of the mobile body based on the position and attitude calculated in the calculating.

16. A program that causes a mobile body control device to perform mobile body control processing,
the mobile body control device including a keyframe database that associates, and registers, a feature of a keyframe selected from images of a movement space shot by a camera and a position and attitude of the keyframe in a coordinate system defining the movement space,
the program causing:
an image feature verification unit to verify a feature of an image captured by a camera of a mobile body against a feature of a keyframe registered in the keyframe database;
a mobile body position and attitude calculation unit to calculate a position and attitude of the mobile body based on the position and attitude of the keyframe in the coordinate system defining the movement space, registered in the keyframe database in association with a keyframe for which the verification is successful; and
a movement control unit to control movement of the mobile body based on the position and attitude calculated by the mobile body position and attitude calculation unit.
